(19) United States
(12) Patent Application Publication
(10) Pub. No.: US 2026/0313662 A1
(43) Pub. Date: Oct. 8, 2026

(54) METHOD AND APPARATUS FOR TIME DOMAIN RESOURCE ALLOCATION INDICATION FOR PSSCHS SCHEDULED BY A SINGLE SCI

(71) Applicant: LENOVO (BEIJING) LIMITED, Beijing (CN)

(72) Inventors: Haipeng LEI, Beijing (CN); Xin GUO, Beijing (CN); Xiaodong YU, Beijing (CN); Zhennian SUN, Beijing (CN)

(21) Appl. No.: 18/998,311

(22) PCT Filed: Jul. 27, 2022
(86) PCT No.: PCT/CN2022/108234

§ 371 Date: Jan. 24, 2025

(51) Int. Cl. H04W 72/25; H04W 72/0446; H04W 88/06

(52) U.S. Cl. CPC H04W 72/25; H04W 72/0446; H04W 88/06

(57) ABSTRACT

Embodiments of the present disclosure relate to methods and apparatuses for time domain resource allocation indication for PSSCHs scheduled by a single SCI. According to some embodiments of the disclosure, a UE may: transmit an SCI for scheduling at least one PSSCH on at least one slot, wherein the SCI comprises a first indicator indicating at least one time domain resource for the at least one PSSCH in the at least one slot, and each of the at least one time domain resource corresponds to one of the at least one PSSCH; and transmit the at least one PSSCH on the at least one time domain resource.

### TECHNICAL FIELD

Embodiments of the present disclosure generally relate to wireless communication technology, and more particularly to time domain resource allocation indication for physical sidelink shared channels (PSSCHs) scheduled by a single sidelink control information (SCI).

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In the above wireless communication systems, a user equipment (UE) may communicate with another UE via a data path supported by an operator's network, e.g., a cellular or a Wi-Fi network infrastructure. The data path supported by the operator's network may include a base station (BS) and multiple gateways.

Some wireless communication systems may support sidelink communications, in which devices (e.g., UEs) that are relatively close to each other may communicate with one another directly via a sidelink, rather than being linked through the BS. The term “sidelink” may refer to a radio link established for communicating among devices (e.g., UEs), as opposed to communicating via the cellular infrastructure (e.g., uplink and downlink). Sidelink transmissions may be performed on a licensed spectrum and an unlicensed spectrum.

There is a need for handling sidelink transmissions on an unlicensed spectrum.

### SUMMARY

Some embodiments of the present disclosure provide a first user equipment (UE). The first UE may include a transceiver, and a processor coupled to the transceiver. The processor may be configured to: transmit sidelink control information (SCI) for scheduling at least one physical sidelink shared channel (PSSCH) on at least one slot, wherein the SCI comprises a first indicator indicating at least one time domain resource for the at least one PSSCH in the at least one slot, and each of the at least one time domain resource corresponds to one of the at least one PSSCH; and transmit the at least one PSSCH on the at least one time domain resource.

In some embodiments of the present disclosure, the first indicator may include: a first field indicating a first starting symbol of a first scheduled PSSCH of the at least one PSSCH and a first ending symbol of a last scheduled PSSCH of the at least one PSSCH, or indicating a second starting symbol of a first scheduled slot of the at least one slot and a second ending symbol of a last scheduled slot of the at least one slot. The first indicator may further include a second field indicating a number of the at least one PSSCH, a number of the at least one slot, the number of the at least one PSSCH minus two, or the number of the at least one slot minus two.

In some embodiments of the present disclosure, the first field indicates a start and length indication value (SLIV) indicating a starting symbol index and a number of symbols. The starting symbol index corresponds to the first starting symbol or the second starting symbol, and the first ending symbol or the second ending symbol is determined based on the starting symbol index and the number of symbols.

In some embodiments of the present disclosure, the size of the second field is based on a maximum number of PSSCHs schedulable by the SCI or a maximum number of slots schedulable by the SCI.

In some embodiments of the present disclosure, the first indicator may include: a first field indicating a first starting symbol of a first scheduled PSSCH of the at least one PSSCH and a first number of symbols of a last scheduled PSSCH of the at least one PSSCH, or indicating a second starting symbol of a first scheduled slot of the at least one slot and a second number of symbols of a last scheduled slot of the at least one slot. The first indicator may further include a second field indicating a number of the at least one PSSCH, a number of the at least one slot, the number of the at least one PSSCH minus two, or the number of the at least one slot minus two.

In some embodiments of the present disclosure, the first field indicates a start and length indication value (SLIV) indicating a starting symbol index and a number of symbols. The starting symbol index corresponds to the first starting symbol or the second starting symbol, and the number of symbols corresponds to the first number of symbols or the second number of symbols.

In some embodiments of the present disclosure, the size of the second field is based on a maximum number of PSSCHs schedulable by the SCI or a maximum number of slots schedulable by the SCI.

In some embodiments of the present disclosure, the first indicator may include: a first field indicating a first ending symbol of a last scheduled PSSCH of the at least one PSSCH, a second ending symbol of a last scheduled slot of the at least one slot, a first number of symbols of the last scheduled PSSCH of the at least one PSSCH, or a second number of symbols of the last scheduled slot of the at least one slot. The first indicator may further include: a second field indicating a number of the at least one PSSCH, a number of the at least one slot, the number of the at least one PSSCH minus two, or the number of the at least one slot minus two. The starting symbol of a first scheduled PSSCH of the at least one PSSCH is based on a physical sidelink control channel (PSCCH) carrying the SCI.

In some embodiments of the present disclosure, in the case that the PSCCH and the first scheduled PSSCH of the at least one PSSCH are purely time division multiplexed (TDMed), the starting symbol of the first scheduled PSSCH immediately follows the last symbol of the PSCCH. In some embodiments of the present disclosure, in the case that the PSCCH and the first scheduled PSSCH of the at least one PSSCH are frequency division multiplexed (FDMed) and TDMed, the starting symbol of the first scheduled PSSCH is the same as that of the PSCCH.

In some embodiments of the present disclosure, the size of the second field is based on a maximum number of PSSCHs schedulable by the SCI or a maximum number of slots schedulable by the SCI.

In some embodiments of the present disclosure, the first indicator may include a first field indicating a total number of symbols for the at least one PSSCH. A starting symbol of a first scheduled PSSCH of the at least one PSSCH is based on a physical sidelink control channel (PSCCH) carrying the SCI.

In some embodiments of the present disclosure, an ending symbol of a last scheduled PSSCH of the at least one PSSCH is based on the starting symbol of the first scheduled PSSCH and the indicated total number of symbols for the at least one PSSCH.

In some embodiments of the present disclosure, the size of the first field is based on a maximum number of slots schedulable by the SCI. In some embodiments of the present disclosure, the first field indicates a total number of symbols for the at least one PSSCH from a set of total number of symbols, and the size of the first field is based on a size of the set of total number of symbols.

In some embodiments of the present disclosure, in the case that the PSCCH and the first scheduled PSSCH of the at least one PSSCH are purely time division multiplexed (TDMed), the starting symbol of the first scheduled PSSCH immediately follows the last symbol of the PSCCH. In some embodiments of the present disclosure, in the case that the PSCCH and the first scheduled PSSCH of the at least one PSSCH are frequency division multiplexed (FDMed) and TDMed, the starting symbol of the first scheduled PSSCH is the same as that of the PSCCH.

In some embodiments of the present disclosure, the first indicator may include: a first field indicating a first starting symbol of a first scheduled PSSCH of the at least one PSSCH or a second starting symbol of a first scheduled slot of the at least one slot; a second field indicating a number of the at least one PSSCH, a number of the at least one slot, the number of the at least one PSSCH minus two, or the number of the at least one slot minus two; and a third field indicating a first ending symbol of a last scheduled PSSCH of the at least one PSSCH, or a second ending symbol of a last scheduled slot of the at least one slot.

In some embodiments of the present disclosure, the size of the second field is based on a maximum number of PSSCHs schedulable by the SCI or a maximum number of slots schedulable by the SCI.

In some embodiments of the present disclosure, the first, second and third fields are jointly coded in the SCI.

In some embodiments of the present disclosure, the first indicator may include: a first field indicating a total number of symbols for the at least one PSSCH, or a total number of symbols for the at least one PSSCH excluding the number of symbols of a first scheduled PSSCH of the at least one PSSCH or a first scheduled slot of the at least one slot; and a second field indicating a first starting symbol of the first scheduled PSSCH of the at least one PSSCH or a second starting symbol of the first scheduled slot of the at least one slot.

In some embodiments of the present disclosure, an ending symbol of a last scheduled PSSCH of the at least one PSSCH is based on the starting symbol of the first scheduled PSSCH and the indicated total number of symbols for the at least one PSSCH.

In some embodiments of the present disclosure, the size of the first field is based on a maximum number of slots schedulable by the SCI. In some embodiments of the present disclosure, the first field indicates a total number of symbols for the at least one PSSCH from a set of total number of symbols, and the size of the first field is based on a size of the set of total number of symbols.

In some embodiments of the present disclosure, all symbols of the second slot to the last but one slot of the at least one slot are used for carrying the at least one PSSCH.

In some embodiments of the present disclosure, the SCI is a first-stage SCI carried on a physical sidelink control channel (PSCCH) in a first scheduled slot of the at least one slot, and the starting symbol of the PSCCH is the same as that of the first scheduled slot, or the SCI is a second-stage SCI carried on a first scheduled PSSCH of the at least one PSSCH, each of the at least one PSSCH, or a subset of PSSCHs of the at least one PSSCH. In the case that the PSCCH and a first scheduled PSSCH of the in at least one PSSCH are purely time division multiplexed (TDMed), the starting symbol of the first scheduled PSSCH immediately follows an ending symbol of the PSCCH. In the case that the PSCCH and the first scheduled PSSCH of the at least one PSSCH are frequency division multiplexed (FDMed) and TDMed, the starting symbol of the first scheduled PSSCH is the same as that of the PSCCH.

In some embodiments of the present disclosure, the first indicator indicates a time domain resource allocation (TDRA) pattern for the at least time domain resource, and a first scheduled PSSCH of the at least one PSSCH is scheduled in a slot where the SCI is transmitted.

In some embodiments of the present disclosure, the TDRA pattern indicates at least one of the following: a start and length indication value (SLIV) for a single PSSCH; a slot level offset between a slot where the SCI is transmitted and a slot where the first scheduled PSSCH is scheduled, respective slot level offset between the slot where the SCI is transmitted and a slot where each of the remaining PSSCH(s) of the at least one PSSCH is scheduled, respective SLIV for each of the at least one PSSCH, or any combination thereof; respective SLIV for each of the at least one PSSCH, wherein the at least one slot is a single slot or contiguous slots; a SLIV for the first scheduled PSSCH and a number of the at least one PSSCH, wherein each PSSCH of the at least one PSSCH has the same length and is contiguous in a time domain; a SLIV for the first scheduled PSSCH, a total length of the at least one PSSCH except the first scheduled PSSCH, and a number of the at least one PSSCH, wherein the at least one PSSCH is contiguous in a time domain and each PSSCH of the at least one PSSCH except the first scheduled PSSCH has the same length; respective starting symbol for each of the at least one PSSCH and a single length for each of the at least one PSSCH, wherein the at least one slot is a single slot or contiguous slots; respective starting symbol for each of the at least one PSSCH and a length for a last scheduled PSSCH of the at least one PSSCH, wherein the at least one PSSCH is contiguous in a time domain; respective starting symbol for each of the at least one PSSCH, wherein the at least one PSSCH is contiguous in a time domain and a last scheduled PSSCH of the at least one PSSCH does not cross a slot boundary; a slot level offset between a slot where the SCI is transmitted and a slot where the first scheduled PSSCH is scheduled, respective slot level offset between the slot where the SCI is transmitted and a slot where each of the remaining PSSCH(s) of the at least one PSSCH is scheduled, a single SLIV for each of the at least one PSSCH, or any combination thereof; a slot level offset between a slot where the SCI is transmitted and a slot where the first scheduled PSSCH is scheduled, respective slot level offset between the slot where the SCI is transmitted and a slot where each of the remaining PSSCH(s) of the at least one PSSCH is scheduled, a SLIV indicating a starting symbol index associated with a first scheduled PSSCH of the plurality of PSSCHs and a number of symbols associated with a last scheduled PSSCH of the plurality of PSSCHs, or any combination thereof, wherein the at least one PSSCH is contiguous in a time domain; a SLIV indicating a starting symbol index associated with the first scheduled PSSCH and a number of symbols associated with a last scheduled PSSCH of the at least one PSSCH and a number of the at least one PSSCH, wherein the at least one PSSCH is contiguous in a time domain; an ending symbol of a last scheduled PSSCH of the at least one PSSCH and a number of the at least one PSSCH, wherein the at least one PSSCH is contiguous in a time domain and a starting symbol of the first scheduled PSSCH is based on a physical sidelink control channel (PSCCH) carrying the SCI; a starting symbol of the first scheduled PSSCH, an ending symbol of a last scheduled PSSCH of the at least one PSSCH, and a number of the at least one PSSCH, wherein the at least one PSSCH is contiguous in a time domain; or respective starting symbol of each of the at least one PSSCH, respective ending symbol of each of the at least one PSSCH, wherein the at least one slot is contiguous in a time domain.

In some embodiments of the present disclosure, the TDRA pattern is from a list of TDRA patterns, which satisfies at least one of the following: the list of TDRA patterns supports different numbers of PSSCHs scheduled by a SCI; the list of TDRA patterns supports a plurality of scheduled PSSCHs with different starting symbols, different lengths, or both; the list of TDRA patterns supports a plurality of starting positions for a first scheduled PSSCH; the list of TDRA patterns supports a plurality of ending positions of a last scheduled PSSCH; the list of TDRA patterns supports a plurality of PSSCHs scheduled in the same slot; the list of TDRA patterns supports a plurality of contiguous or non-contiguous PSSCHs scheduled in a plurality of slots or the same slot; the list of TDRA patterns supports a plurality of PSSCHs scheduled in different slots; the list of TDRA patterns explicitly or implicitly indicate the number of scheduled PSSCHs; or the list of TDRA patterns indicates a TDRA pattern for a single scheduled PSSCH and a TDRA pattern for a plurality of scheduled PSSCHs.

In some embodiments of the present disclosure, one or more PSSCHs of the at least one PSSCH are transmitted in a single slot of the at least one slot.

In some embodiments of the present disclosure, the processor may be further configured to receive downlink control information (DCI) for scheduling a plurality of PSSCHs on a plurality of slots. The DCI may include a second indicator indicating a plurality of time domain resources in the plurality of slots, and each of the plurality of time domain resource corresponds to one of the plurality of PSSCHs. The plurality of PSSCHs may include the at least one PSSCH, the plurality of slots may include the at least one slot, and the first indicator is based on the second indicator.

In some embodiments of the present disclosure, the SCI schedules the plurality of PSSCHs and is transmitted in a first scheduled slot of the plurality of slots. In some embodiments of the present disclosure, the SCI schedules a single PSSCH of the plurality of PSSCHs and is transmitted in the same slot as the single PSSCH.

In some embodiments of the present disclosure, the second indicator may include: a first field indicating a first starting symbol of a first scheduled PSSCH of the plurality of PSSCHs and a first ending symbol of a last scheduled PSSCH of the plurality of PSSCHs, or indicating a second starting symbol of a first scheduled slot of the plurality of slots and a second ending symbol of a last scheduled slot of the plurality of slots, and a second field indicating a number of the plurality of PSSCHs, a number of the plurality of slots, the number of the plurality of PSSCHs minus two, or the number of the plurality of slots minus two.

In some embodiments of the present disclosure, the first field indicates a start and length indication value (SLIV) indicating a starting symbol index and a number of symbols. The starting symbol index corresponds to the first starting symbol or the second starting symbol, and the first ending symbol or the second ending symbol is determined based on the starting symbol index and the number of symbols.

In some embodiments of the present disclosure, the size of the second field is based on a maximum number of PSSCHs schedulable by the DCI or a maximum number of slots schedulable by the DCI.

In some embodiments of the present disclosure, the second indicator may include: a first field indicating a first starting symbol of a first scheduled PSSCH of the plurality of PSSCHs and a first number of symbols of a last scheduled PSSCH of the plurality of PSSCHs, or indicating a second starting symbol of a first scheduled slot of the plurality of slots and a second number of symbols of a last scheduled slot of the plurality of slots; and a second field indicating a number of the plurality of PSSCHs, a number of the plurality of slots, the number of the plurality of PSSCHs minus two, or the number of the plurality of slots minus two.

In some embodiments of the present disclosure, the first field indicates a start and length indication value (SLIV) indicating a starting symbol index and a number of symbols. The starting symbol index corresponds to the first starting symbol or the second starting symbol, and the number of symbols corresponds to the first number of symbols or the second number of symbols.

In some embodiments of the present disclosure, the size of the second field is based on a maximum number of PSSCHs schedulable by the DCI or a maximum number of slots schedulable by the DCI.

In some embodiments of the present disclosure, the second indicator may include: a first field indicating a first ending symbol of a last scheduled PSSCH of the plurality of PSSCHs, a second ending symbol of a last scheduled slot of the plurality of slots, a first number of symbols of the last scheduled PSSCH of the plurality of PSSCHs, or a second number of symbols of the last scheduled slot of the plurality of slots; and a second field indicating a number of the plurality of PSSCHs, a number of the plurality of slots, the number of the plurality of PSSCHs minus two, or the number of the plurality of slots minus two. The starting symbol of a first scheduled PSSCH of the plurality of PSSCHs is based on a physical sidelink control channel (PSCCH) carrying the SCI.

In some embodiments of the present disclosure, in the case that the PSCCH and the first scheduled PSSCH of the plurality of PSSCHs are purely time division multiplexed (TDMed), the starting symbol of the first scheduled PSSCH immediately follows the last symbol of the PSCCH. In some embodiments of the present disclosure, wherein in the case that the PSCCH and the first scheduled PSSCH of the plurality of PSSCHs are frequency division multiplexed (FDMed) and TDMed, the starting symbol of the first scheduled PSSCH is the same as that of the PSCCH.

In some embodiments of the present disclosure, the size of the second field is based on a maximum number of PSSCHs schedulable by the DCI or a maximum number of slots schedulable by the DCI.

In some embodiments of the present disclosure, the second indicator may include: a first field indicating a total number of symbols for the plurality of PSSCHs. A starting symbol of a first scheduled PSSCH of the plurality of PSSCHs is based on a physical sidelink control channel (PSCCH) carrying the SCI.

In some embodiments of the present disclosure, in the case that the PSCCH and the first scheduled PSSCH of the plurality of PSSCHs are purely time division multiplexed (TDMed), the starting symbol of the first scheduled PSSCH immediately follows the last symbol of the PSCCH. In some embodiments of the present disclosure, wherein in the case that the PSCCH and the first scheduled PSSCH of the plurality of PSSCHs are frequency division multiplexed (FDMed) and TDMed, the starting symbol of the first scheduled PSSCH is the same as that of the PSCCH.

In some embodiments of the present disclosure, an ending symbol of a last scheduled PSSCH of the plurality of PSSCHs is based on the starting symbol of the first scheduled PSSCH and the indicated total number of symbols for the plurality of PSSCHs.

In some embodiments of the present disclosure, the size of the first field is based on a maximum number of slots schedulable by the DCI. In some embodiments of the present disclosure, the first field indicates a total number of symbols for the plurality of PSSCHs from a set of total number of symbols, and the size of the first field is based on a size of the set of total number of symbols.

In some embodiments of the present disclosure, the second indicator may include: the second indicator may include: a first field indicating a first starting symbol of a first scheduled PSSCH of the plurality of PSSCHs or a second starting symbol of a first scheduled slot of the plurality of slot; a second field indicating a number of the plurality of PSSCHs, a number of the plurality of slots, the number of the plurality of PSSCHs minus two, or the number of the plurality of slots minus two; and a third field indicating a first ending symbol of a last scheduled PSSCH of the plurality of PSSCHs, or a second ending symbol of a last scheduled slot of the plurality of slots.

In some embodiments of the present disclosure, the size of the second field is based on a maximum number of PSSCHs schedulable by the DCI or a maximum number of slots schedulable by the DCI.

In some embodiments of the present disclosure, the first, second and third fields are jointly coded in the DCI.

In some embodiments of the present disclosure, the second indicator may include: a first field indicating a total number of symbols for the plurality of PSSCHs; and a second field indicating a first starting symbol of a first scheduled PSSCH of the plurality of PSSCHs or a second starting symbol of a first scheduled slot of the plurality of slots.

In some embodiments of the present disclosure, an ending symbol of a last scheduled PSSCH of the plurality of PSSCHs is based on the starting symbol of the first scheduled PSSCH and the indicated total number of symbols for the plurality of PSSCHs.

In some embodiments of the present disclosure, the size of the first field is based on a maximum number of slots schedulable by the DCI. In some embodiments of the present disclosure, the first field indicates a total number of symbols for the plurality of PSSCHs from a set of total number of symbols, and the size of the first field is based on a size of the set of total number of symbols.

In some embodiments of the present disclosure, all symbols of the second slot to the last but one slot of the plurality of slots are used for transmitting the plurality of PSSCHs.

In some embodiments of the present disclosure, the second indicator indicates a time domain resource allocation (TDRA) pattern for the plurality of time domain resources.

In some embodiments of the present disclosure, the TDRA pattern indicates at least one of the following: respective slot level offset between a slot where the DCI is received and a slot where each of the plurality of PSSCHs is scheduled, respective SLIV for each of the plurality of PSSCHs, or any combination thereof; a slot level offset between a slot where the DCI is received and a slot where a first scheduled PSSCH of the plurality of PSSCHs is scheduled, respective SLIV for each of the plurality of PSSCHs, or any combination thereof, wherein the plurality of slots is contiguous slots; a slot level offset between a slot where the DCI is received and a slot where a first scheduled PSSCH of the plurality of PSSCHs is scheduled, a SLIV for the first scheduled PSSCH, a number of the plurality of PSSCHs, or any combination thereof, wherein each PSSCH of the plurality of PSSCHs has the same length and is contiguous in a time domain; a slot level offset between a slot where the DCI is received and a slot where a first scheduled PSSCH of the plurality of PSSCHs is scheduled, a SLIV for the first scheduled PSSCH, a total length of the plurality of PSSCHs except the first scheduled PSSCH, a number of the plurality of PSSCHs, or any combination thereof, wherein the plurality of PSSCHs is contiguous in a time domain and each PSSCH of the plurality of PSSCHs except the first scheduled PSSCH has the same length; a slot level offset between a slot where the DCI is received and a slot where a first scheduled PSSCH of the plurality of PSSCHs is scheduled, respective starting symbol for each of the plurality of PSSCHs, a single length for each of the plurality of PSSCHs, or any combination thereof, wherein the plurality of slots is contiguous slots; a slot level offset between a slot where the DCI is received and a slot where a first scheduled PSSCH of the plurality of PSSCHs is scheduled, respective starting symbol for each of the plurality of PSSCHs, a length for a last scheduled PSSCH of the plurality of PSSCHs, or any combination thereof, wherein the plurality of PSSCHs is contiguous in a time domain; a slot level offset between a slot where the DCI is received and a slot where a first scheduled PSSCH of the plurality of PSSCHs is scheduled, respective starting symbol for each of the plurality of PSSCHs, or any combination thereof, wherein the plurality of PSSCHs is contiguous in a time domain and a last scheduled PSSCH of the plurality of PSSCHs does not cross a slot boundary; respective slot level offset between a slot where the DCI is received and a slot where each of the plurality of PSSCHs is scheduled, a single SLIV for each of the plurality of PSSCHs, or any combination thereof; respective slot level offset between a slot where the DCI is received and a slot where each of the plurality of PSSCHs is scheduled, a SLIV indicating a starting symbol index associated with a first scheduled PSSCH of the plurality of PSSCHs and a number of symbols associated with a last scheduled PSSCH of the plurality of PSSCHs, or any combination thereof, wherein the plurality of PSSCHs is contiguous in a time domain; a slot level offset between a slot where the DCI is received and a slot where a first scheduled PSSCH of the plurality of PSSCHs is scheduled, a SLIV indicating a starting symbol index associated with the first scheduled PSSCH and a number of symbols associated with a last scheduled PSSCH of the plurality of PSSCHs, a number of the plurality of PSSCHs, or any combination thereof, wherein the plurality of PSSCHs is contiguous in a time domain; a slot level offset between a slot where the DCI is received and a slot where a first scheduled PSSCH of the plurality of PSSCHs is scheduled, an ending symbol of a last scheduled PSSCH of the plurality of PSSCHs, a number of the plurality of PSSCHs, or any combination thereof, wherein the plurality of PSSCHs is contiguous in a time domain and a starting symbol of the first scheduled PSSCH is based on a physical sidelink control channel (PSCCH) carrying the SCI; a slot level offset between a slot where the DCI is received and a slot where a first scheduled PSSCH of the plurality of PSSCHs is scheduled, a starting symbol of the first scheduled PSSCH, an ending symbol of a last scheduled PSSCH of the plurality of PSSCHs, a number of the plurality of PSSCHs, or any combination thereof, wherein the plurality of PSSCHs is contiguous in a time domain; or a slot level offset between a slot where the DCI is received and a slot where a first scheduled PSSCH of the plurality of PSSCHs is scheduled, respective starting symbol of each of the plurality of PSSCHs, respective ending symbol of each of the plurality of PSSCHs, or any combination thereof, wherein the plurality of slots is contiguous in a time domain.

In some embodiments of the present disclosure, the TDRA pattern is from a list of TDRA patterns, which satisfies at least one of the following: the list of TDRA patterns supports different numbers of PSSCHs scheduled by a DCI; the list of TDRA patterns supports a plurality of scheduled PSSCHs with different starting symbols, different lengths, or both; the list of TDRA patterns supports a plurality of starting positions for a first scheduled PSSCH; the list of TDRA patterns supports a plurality of ending positions of a last scheduled PSSCH; the list of TDRA patterns supports a plurality of PSSCHs scheduled in the same slot; the list of TDRA patterns supports a plurality of contiguous or non-contiguous PSSCHs scheduled in a plurality of slots or the same slot; the list of TDRA patterns supports a plurality of PSSCHs scheduled in different slots; the list of TDRA patterns explicitly or implicitly indicate the number of scheduled PSSCHs; or the list of TDRA patterns indicates a TDRA pattern for a single scheduled PSSCH and a TDRA pattern for a plurality of scheduled PSSCHs.

In some embodiments of the present disclosure, one or more PSSCHs of the plurality of PSSCHs are transmitted in a single slot of the plurality of slots.

Some embodiments of the present disclosure provide a second user equipment (UE). The second UE may include a transceiver, and a processor coupled to the transceiver. The processor may be configured to: receive sidelink control information (SCI) for scheduling at least one physical sidelink shared channel (PSSCH) on at least one slot, wherein the SCI comprises a first indicator indicating at least one time domain resource for the at least one PSSCH in the at least one slot, and each of the at least one time domain resource corresponds to one of the at least one PSSCH; and receive the at least one PSSCH on the at least one time domain resource.

In some embodiments of the present disclosure, the first indicator may include: a first field indicating a first starting symbol of a first scheduled PSSCH of the at least one PSSCH and a first ending symbol of a last scheduled PSSCH of the at least one PSSCH, or indicating a second starting symbol of a first scheduled slot of the at least one slot and a second ending symbol of a last scheduled slot of the at least one slot. The first indicator may further include a second field indicating a number of the at least one PSSCH, a number of the at least one slot, the number of the at least one PSSCH minus two, or the number of the at least one slot minus two.

In some embodiments of the present disclosure, the size of the second field is based on a maximum number of PSSCHs schedulable by the SCI or a maximum number of slots schedulable by the SCI.

In some embodiments of the present disclosure, the first field indicates a start and length indication value (SLIV) indicating a starting symbol index and a number of symbols. The starting symbol index corresponds to the first starting symbol or the second starting symbol, and the first ending symbol or the second ending symbol is determined based on the starting symbol index and the number of symbols.

In some embodiments of the present disclosure, the first indicator may include: a first field indicating a first starting symbol of a first scheduled PSSCH of the at least one PSSCH and a first number of symbols of a last scheduled PSSCH of the at least one PSSCH, or indicating a second starting symbol of a first scheduled slot of the at least one slot and a second number of symbols of a last scheduled slot of the at least one slot. The first indicator may further include a second field indicating a number of the at least one PSSCH, a number of the at least one slot, the number of the at least one PSSCH minus two, or the number of the at least one slot minus two.

In some embodiments of the present disclosure, the size of the second field is based on a maximum number of PSSCHs schedulable by the SCI or a maximum number of slots schedulable by the SCI.

In some embodiments of the present disclosure, the first field indicates a start and length indication value (SLIV) indicating a starting symbol index and a number of symbols. The starting symbol index corresponds to the first starting symbol or the second starting symbol, and the number of symbols corresponds to the first number of symbols or the second number of symbols.

In some embodiments of the present disclosure, the first indicator may include: a first field indicating a first ending symbol of a last scheduled PSSCH of the at least one PSSCH, a second ending symbol of a last scheduled slot of the at least one slot, a first number of symbols of the last scheduled PSSCH of the at least one PSSCH, or a second number of symbols of the last scheduled slot of the at least one slot; and a second field indicating a number of the at least one PSSCH, a number of the at least one slot, the number of the at least one PSSCH minus two, or the number of the at least one slot minus two. The starting symbol of a first scheduled PSSCH of the at least one PSSCH is based on a physical sidelink control channel (PSCCH) carrying the SCI.

In some embodiments of the present disclosure, in the case that the PSCCH and the first scheduled PSSCH of the at least one PSSCH are purely time division multiplexed (TDMed), the starting symbol of the first scheduled PSSCH immediately follows the last symbol of the PSCCH. In some embodiments of the present disclosure, in the case that the PSCCH and the first scheduled PSSCH of the at least one PSSCH are frequency division multiplexed (FDMed) and TDMed, the starting symbol of the first scheduled PSSCH is the same as that of the PSCCH.

In some embodiments of the present disclosure, the size of the second field is based on a maximum number of PSSCHs schedulable by the SCI or a maximum number of slots schedulable by the SCI.

In some embodiments of the present disclosure, the first indicator may include a first field indicating a total number of symbols for the at least one PSSCH. A starting symbol of a first scheduled PSSCH of the at least one PSSCH is based on a physical sidelink control channel (PSCCH) carrying the SCI.

In some embodiments of the present disclosure, in the case that the PSCCH and the first scheduled PSSCH of the at least one PSSCH are purely time division multiplexed (TDMed), the starting symbol of the first scheduled PSSCH immediately follows the last symbol of the PSCCH. In some embodiments of the present disclosure, in the case that the PSCCH and the first scheduled PSSCH of the at least one PSSCH are frequency division multiplexed (FDMed) and TDMed, the starting symbol of the first scheduled PSSCH is the same as that of the PSCCH.

In some embodiments of the present disclosure, an ending symbol of a last scheduled PSSCH of the at least one PSSCH is based on the starting symbol of the first scheduled PSSCH and the indicated total number of symbols for the at least one PSSCH.

In some embodiments of the present disclosure, the size of the first field is based on a maximum number of slots schedulable by the SCI. In some embodiments of the present disclosure, the first field indicates a total number of symbols for the at least one PSSCH from a set of total number of symbols, and the size of the first field is based on a size of the set of total number of symbols.

In some embodiments of the present disclosure, the first indicator may include: a first field indicating a first starting symbol of a first scheduled PSSCH of the at least one PSSCH or a second starting symbol of a first scheduled slot of the at least one slot; a second field indicating a number of the at least one PSSCH, a number of the at least one slot, the number of the at least one PSSCH minus two, or the number of the at least one slot minus two; and a third field indicating a first ending symbol of a last scheduled PSSCH of the at least one PSSCH, or a second ending symbol of a last scheduled slot of the at least one slot.

In some embodiments of the present disclosure, the first, second and third fields are jointly coded in the SCI.

In some embodiments of the present disclosure, the size of the second field is based on a maximum number of PSSCHs schedulable by the SCI or a maximum number of slots schedulable by the SCI.

In some embodiments of the present disclosure, the first indicator may include: a first field indicating a total number of symbols for the at least one PSSCH, or a total number of symbols for the plurality of PSSCHs excluding the number of symbols of a first scheduled PSSCH of the plurality of PSSCHs or a first scheduled slot of the plurality of slots; and a second field indicating a first starting symbol of the first scheduled PSSCH of the at least one PSSCH or a second starting symbol of the first scheduled slot of the at least one slot.

In some embodiments of the present disclosure, an ending symbol of a last scheduled PSSCH of the at least one PSSCH is based on the starting symbol of the first scheduled PSSCH and the indicated total number of symbols for the at least one PSSCH.

In some embodiments of the present disclosure, the size of the first field is based on a maximum number of slots schedulable by the SCI. In some embodiments of the present disclosure, the first field indicates a total number of symbols for the at least one PSSCH from a set of total number of symbols, and the size of the first field is based on a size of the set of total number of symbols.

In some embodiments of the present disclosure, all symbols of the second slot to the last but one slot of the at least one slot are used for carrying the at least one PSSCH.

In some embodiments of the present disclosure, the SCI is a first-stage SCI carried on a physical sidelink control channel (PSCCH) in a first scheduled slot of the at least one slot, and the starting symbol of the PSCCH is the same as that of the first scheduled slot, or the SCI is a second-stage SCI carried on a first scheduled PSSCH of the at least one PSSCH, each of the at least one PSSCH, or a subset of PSSCHs of the at least one PSSCH. In the case that the PSCCH and a first scheduled PSSCH of the at least one PSSCH are purely time division multiplexed (TDMed), the starting symbol of the first scheduled PSSCH immediately follows an ending symbol of the PSCCH. In the case that the PSCCH and the first scheduled PSSCH of the at least one PSSCH are frequency division multiplexed (FDMed) and TDMed, the starting symbol of the first scheduled PSSCH is the same as that of the PSCCH.

In some embodiments of the present disclosure, the first indicator indicates a time domain resource allocation (TDRA) pattern for the at least time domain resource, and a first scheduled PSSCH of the at least one PSSCH is scheduled in a slot where the SCI is received.

In some embodiments of the present disclosure, the TDRA pattern indicates at least one of the following: a start and length indication value (SLIV) for a single PSSCH; a slot level offset between a slot where the SCI is received and a slot where the first scheduled PSSCH is scheduled, respective slot level offset between the slot where the SCI is received and a slot where each of the remaining PSSCH(s) of the at least one PSSCH is scheduled, respective SLIV for each of the at least one PSSCH, or any combination thereof; respective SLIV for each of the at least one PSSCH, wherein the at least one slot is a single slot or contiguous slots; a SLIV for the first scheduled PSSCH and a number of the at least one PSSCH, wherein each PSSCH of the at least one PSSCH has the same length and is contiguous in a time domain; a SLIV for the first scheduled PSSCH, a total length of the at least one PSSCH except the first scheduled PSSCH, and a number of the at least one PSSCH, wherein the at least one PSSCH is contiguous in a time domain and each PSSCH of the at least one PSSCH except the first scheduled PSSCH has the same length; respective starting symbol for each of the at least one PSSCH and a single length for each of the at least one PSSCH, wherein the at least one slot is a single slot or contiguous slots; respective starting symbol for each of the at least one PSSCH and a length for a last scheduled PSSCH of the at least one PSSCH, wherein the at least one PSSCH is contiguous in a time domain; respective starting symbol for each of the at least one PSSCH, wherein the at least one PSSCH is contiguous in a time domain and a last scheduled PSSCH of the at least one PSSCH does not cross a slot boundary; a slot level offset between a slot where the SCI is received and a slot where the first scheduled PSSCH is scheduled, respective slot level offset between the slot where the SCI is received and a slot where each of the remaining PSSCH(s) of the at least one PSSCH is scheduled, a single SLIV for each of the at least one PSSCH, or any combination thereof; a slot level offset between a slot where the SCI is received and a slot where the first scheduled PSSCH is scheduled, respective slot level offset between the slot where the SCI is received and a slot where each of the remaining PSSCH(s) of the at least one PSSCH is scheduled, a SLIV indicating a starting symbol index associated with a first scheduled PSSCH of the plurality of PSSCHs and a number of symbols associated with a last scheduled PSSCH of the plurality of PSSCHs, or any combination thereof, wherein the at least one PSSCH is contiguous in a time domain; a SLIV indicating a starting symbol index associated with the first scheduled PSSCH and a number of symbols associated with a last scheduled PSSCH of the at least one PSSCH and a number of the at least one PSSCH, wherein the at least one PSSCH is contiguous in a time domain; an ending symbol of a last scheduled PSSCH of the at least one PSSCH and a number of the at least one PSSCH, wherein the at least one PSSCH is contiguous in a time domain and a starting symbol of the first scheduled PSSCH is based on a physical sidelink control channel (PSCCH) carrying the SCI; a starting symbol of the first scheduled PSSCH, an ending symbol of a last scheduled PSSCH of the at least one PSSCH, and a number of the at least one PSSCH, wherein the at least one PSSCH is contiguous in a time domain; or respective starting symbol of each of the at least one PSSCH, respective ending symbol of each of the at least one PSSCH, wherein the at least one slot is contiguous in a time domain.

In some embodiments of the present disclosure, the TDRA pattern is from a list of TDRA patterns, which satisfies at least one of the following: the list of TDRA patterns supports different numbers of PSSCHs scheduled by a SCI; the list of TDRA patterns supports a plurality of scheduled PSSCHs with different starting symbols, different lengths, or both; the list of TDRA patterns supports a plurality of starting positions for a first scheduled PSSCH; the list of TDRA patterns supports a plurality of ending positions of a last scheduled PSSCH; the list of TDRA patterns supports a plurality of PSSCHs scheduled in the same slot; the list of TDRA patterns supports a plurality of contiguous or non-contiguous PSSCHs scheduled in a plurality of slots or the same slot; the list of TDRA patterns supports a plurality of PSSCHs scheduled in different slots; the list of TDRA patterns explicitly or implicitly indicate the number of scheduled PSSCHs; or the list of TDRA patterns indicates a TDRA pattern for a single scheduled PSSCH and a TDRA pattern for a plurality of scheduled PSSCHs.

In some embodiments of the present disclosure, one or more PSSCHs of the at least one PSSCH are received in a single slot of the at least one slot.

Some embodiments of the present disclosure provide a method performed by a first UE. The method may include: transmitting sidelink control information (SCI) for scheduling at least one physical sidelink shared channel (PSSCH) on at least one slot, wherein the SCI comprises a first indicator indicating at least one time domain resource for the at least one PSSCH in the at least one slot, and each of the at least one time domain resource corresponds to one of the at least one PSSCH; and transmitting the at least one PSSCH on the at least one time domain resource.

Some embodiments of the present disclosure provide a method performed by a second UE. The method may include: receiving sidelink control information (SCI) for scheduling at least one physical sidelink shared channel (PSSCH) on at least one slot, wherein the SCI comprises a first indicator (e.g., indicator #1) indicating at least one time domain resource for the at least one PSSCH in the at least one slot, and each of the at least one time domain resource corresponds to one of the at least one PSSCH; and receiving the at least one PSSCH on the at least one time domain resource.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates an exemplary sidelink transmission in accordance with some embodiments of the present disclosure;

FIGS. 3-5 illustrate an exemplary time domain resource allocation for single or multiple PSSCH scheduling in accordance with some embodiments of the present disclosure;

FIGS. 6 and 7 illustrate flow charts of exemplary procedures of sidelink communication in accordance with some embodiments of the present disclosure; and

FIG. 8 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

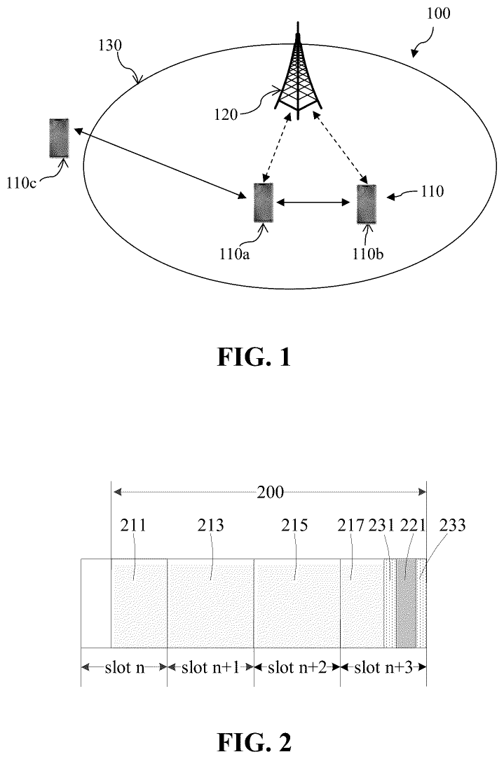

FIG. 1 illustrates a schematic diagram of a wireless communication system 100 in accordance with some embodiments of the present disclosure.

As shown in FIG. 1, wireless communication system 100 may include a base station (e.g., BS 120) and some UEs 110 (e.g., UE 110a, UE 110b, and UE 110c). Although a specific number of UEs 110 and one BS 120 are depicted in FIG. 1, it is contemplated that any number of BSs and UEs in and outside of the coverage of the BSs may be included in the wireless communication system 100.

In some embodiments of the present disclosure, BS 120 may be referred to as an access point, an access terminal, a base, a base unit, a macro cell, a Node-B, an evolved Node B (eNB), a gNB, a Home Node-B, a relay node, or a device, or described using other terminology used in the art. BS 120 is generally a part of a radio access network that may include one or more controllers communicably coupled to one or more corresponding BSs. BS 120 may communicate with UE(s) 110 via downlink (DL) communication signals.

UE(s) 110 (e.g., UE 110a, UE 110b, or UE 110c) may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, UE(s) 110 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, UE(s) 110 includes wearable devices, such as smart watches, fitness bands, optical head-mounted displays, or the like. Moreover, UE(s) 110 may be referred to as a subscriber unit, a mobile, a mobile station, a user, a terminal, a mobile terminal, a wireless terminal, a fixed terminal, a subscriber station, a user terminal, an IoT device, a vehicle, or a device, or described using other terminology used in the art. UE(s) 110 may communicate with BS 120 via uplink (UL) communication signals.

Wireless communication system 100 may be compatible with any type of network that is capable of sending and receiving wireless communication signals. For example, wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, wireless communication system 100 is compatible with 5G NR of the 3GPP protocol. For example, BS 120 may transmit data using an orthogonal frequency division multiple (OFDM) modulation scheme on the DL and UE(s) 110 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, BS 120 and UE(s) 110 may communicate using other communication protocols, such as the IEEE 802.11 family of wireless communication protocols. Further, in some embodiments of the present disclosure, BS 120 and UE(s) 110 may communicate over licensed spectrums, whereas in some other embodiments, BS 120 and UE(s) 110 may communicate over unlicensed spectrums. The present disclosure is not intended to be limited to the implementation of any particular wireless communication system architecture or protocol.

BS 120 may define one or more cells, and each cell may have a coverage area 130. In the exemplary wireless communication system 100, some UEs (e.g., UE 110a and UE 110b) are within the coverage of BS 120, which may not be the specific BS 120 as shown in FIG. 1 and can be any one of the BSs 120 in a wireless communication system, and some UEs (e.g., UE 110c) are outside of the coverage of BS 120. For example, in the case that the wireless communication system includes two BSs 120 with UE 110a being within the coverage of any one of the two BSs means that UE 110a is within the coverage of a BS 120 (i.e., in-coverage) in the wireless communication system; and UE 110a being outside of the coverage of both BSs 120 means that UE 110a is outside the coverage of a BS 120 (i.e., out-of-coverage) in the wireless communication system.

Still referring to FIG. 1, UE 110a and UE 110b may communicate with BS 120 via, for example, a Uu link (denoted by dotted arrow in FIG. 1). UE 110a, UE 110b, and UE 110c may communicate with each other via a sidelink (denoted by solid arrow in FIG. 1). In some embodiments, UE 110a, UE 110b, and UE 110c may form a UE group.

Sidelink transmissions may involve a physical sidelink control channel (PSCCH) and an associated physical sidelink shared channel (PSSCH), which is scheduled by the sidelink control information (SCI) carried on the PSCCH. In some embodiments, the SCI may be transmitted in two stages, wherein the 1^{st}-stage SCI may be carried on the PSCCH and the 2^{nd}-stage SCI may be carried (or multiplexed) on the scheduled PSSCH. The specific definitions of the 1^{st}-stage SCI and 2^{nd}-stage SCI can be referred to in 3GPP specifications.

The SCI and associated PSSCH may be transmitted from a transmitting UE (hereinafter referred to as “Tx UE”) to a receiving UE (hereinafter referred to as “Rx UE”) in a unicast manner, to a group of Rx UEs in a groupcast manner, or to Rx UEs within a range in a broadcast manner. For example, referring to FIG. 1, UE 110a (acting as a Tx UE) may transmit data to UE 110b or UE 110c (acting as an Rx UE). The PSSCH may carry data which may require corresponding HARQ-ACK feedback from the Rx UE(s) to the Tx UE. The HARQ-ACK feedback for the PSSCH may be carried on a physical sidelink feedback channel (PSFCH).

At least two resource allocation modes (e.g., resource allocation mode 1 and resource allocation mode 2) are employed for a sidelink transmission. Resource allocation mode 1 is based on the scheduling of a BS. Resource allocation mode 2 is based on the autonomous selection of a UE. The specific definitions of the two modes are described in 3GPP specifications.

For example, in resource allocation mode 1, resources may be assigned by a BS via dynamic scheduling or a configured grant. For example, a BS may transmit a physical downlink control channel (PDCCH) (e.g., downlink control information (DCI), such as DCI 3_0) to a UE (e.g., Tx UE) to schedule a sidelink resource(s) for the UE. The UE may then inform another UE(s) (e.g., Rx UE(s)) about the resource(s) it will use to transmit a PSSCH.

For example, in resource allocation mode 2, a UE may need to perform resource sensing by monitoring and decoding all SCI transmitted in an SCI resource pool to obtain resource reservation information. By doing so, the UE may identify candidate resources that are available for communication. The UE may then, for example, randomly select required resources from the identified candidate resources.

In some embodiments of the present disclosure, sidelink transmissions may be performed on an unlicensed spectrum. This is advantageous because a sidelink transmission over an unlicensed spectrum can achieve, for example, an increased data rate(s). In order to achieve fair coexistence between various systems, for example, NR systems (e.g., NR-U systems) and other wireless systems, a channel access procedure, also known as a listen-before-talk (LBT) test, may be performed before communicating on the unlicensed spectrum.

Various types of channel access procedures including, but not limited to, channel access Type 1 and channel access Type 2 may be supported. In some embodiments, by performing channel access Type 1, a UE can initiate channel occupancy (CO) and occupy the channel until the maximum channel occupancy time (MCOT). In some embodiments, the MCOT can be 2 ms, 3 ms, 4 ms, 6 ms, 8 ms or 10 ms, dependent on, for example, a channel access priority class (CAPC) value of the traffic priority and the presence of other technologies sharing the same spectrum.

To avoid the risk of losing the channel, similar to a DL burst and UL burst, a sidelink burst can be defined as a set of contiguous transmissions from a UE without any gaps greater than 16 us. FIG. 2 shows an exemplary sidelink transmission in accordance with some embodiments of the present disclosure.

Referring to FIG. 2, a UE may initiate UE-initiated COT 200 by performing a channel access procedure (e.g., channel access Type 1) using, for example, a CAPC value 2. The UE then can contiguously transmit 4 PSSCHs in four consecutive slots (e.g., slot n to slot n+3 as shown in FIG. 2) without sensing. For example, for each of slot n to slot n+3, the UE may transmit an SCI in the corresponding slot to schedule a PSSCH (e.g., one of PSSCHs 211-217) in the corresponding slot. For example, for a PSSCH (e.g., one of PSSCHs 211-217) scheduled by an SCI, the SCI may indicate a time resource indicator value (TRIV) for determining the time domain resource for the scheduled PSSCH. Time domain resource 221 may correspond to a PSFCH transmission occasion, and gap 231 and gap 233 may be arranged before and after time domain resource 221.

It should be understood that the COT structure in FIG. 2 is only for illustrative purposes, and should not be construed as limiting the embodiments of the present disclosure. For example, in some other embodiments of the present disclosure, a COT structure may not include a time domain resource for the PSFCH transmission.

In some embodiments of the present disclosure, multi-slot or multi-PSSCH scheduling may be supported on a sidelink. Using a single SCI to schedule a plurality of slots or a plurality of PSSCHs would be advantageous because this can greatly reduce signaling overhead. Embodiments of the present disclosure provide solutions to improve the multi-slot or multi-PSSCH scheduling when it is applied to sidelink transmissions over, for example, an unlicensed spectrum.

For example, considering that the starting symbol of the first scheduled slot of the plurality of slots scheduled by an SCI may not be the initial symbol (e.g., symbol 0) of a slot and the ending symbol of the last scheduled slot of the plurality of scheduled slots may not be the last symbol (e.g., symbol 13) of the slot due to, for example, the presence of a PSFCH and a gap symbol(s), different PSSCHs of the plurality of PSSCHs scheduled by the SCI may have different starting symbol indices and ending symbol indices. Separate TRIVs for each of the plurality of scheduled PSSCHs may lead to high signaling overhead. Embodiments of the present disclosure provide solutions for indicating the time domain resources for the plurality of scheduled PSSCHs in the SCI which can reduce signaling overhead while ensuring scheduling flexibility.

For example, as mentioned above, in resource allocation mode 1, a DCI may be used to schedule sidelink resources to a Tx UE. In some examples, a maximum of 2 or 3 reserved PSCCH/PSSCH resources within 32 slots may be assigned using 5 or 9 bits in the DCI for indicating the slot offset of the 2nd or 3rd transmissions with reference to the slot where the 1st transmission is scheduled. Embodiments of the present disclosure provide solutions for enhancing the DCI when multi-PSSCH scheduling is employed (e.g., the DCI can schedule a plurality of PSSCHs), which can use less overhead to indicate the plurality of scheduled PSSCHs.

More details on the embodiments of the present disclosure will be illustrated in the following text in combination with the appended drawings.

In some embodiments of the present disclosure, a single SCI may schedule at least one PSSCH in at least one slot. For example, a Tx UE may transmit the SCI to an Rx UE, and then transmit the at least one PSSCH to the Rx UE according to a time domain resource indication in the SCI. The details regarding the indication will be described in the following text. These embodiments may be applied to either resource allocation mode 1 or resource allocation mode 2. For example, as will be described in detail later, in resource allocation mode 1, a DCI may schedule a plurality of PSSCHs including the at least one PSSCH.

In some embodiments of the present disclosure, the SCI may include a time domain resource allocation (TDRA) indicator (denoted as indicator #1) indicating at least one time domain resource for the at least one PSSCH in the at least one slot, and each of the at least one time domain resource may correspond to one of the at least one PSSCH.

In some embodiments of the present disclosure, the SCI may be a 1^{st}-stage SCI carried on a PSCCH in the first scheduled slot of the at least one slot. The starting symbol of the PSCCH may be the same as that of the first scheduled slot. In some embodiments of the present disclosure, the SCI may be a 2^{nd}-stage SCI carried on the first scheduled PSSCH of the at least one PSSCH, each of the at least one PSSCH, or a subset of PSSCHs of the at least one PSSCH.

In some embodiments of the present disclosure, indicator #1 may include two fields (denoted as field #1A and field #2A).

In some embodiments of the present disclosure, field #1A may indicate the starting symbol (denoted as s_symbol #1) of the first scheduled PSSCH of the at least one PSSCH and the ending symbol (denoted as e_symbol #1) of the last scheduled PSSCH of the at least one PSSCH. In some embodiments, field #1A may indicate the starting symbol (denoted as s_symbol #2) of the first scheduled slot of the at least one slot and the ending symbol (denoted as e_symbol #2) of the last scheduled slot of the at least one slot. In some embodiments, field #1A may indicate the starting symbol (e.g., s_symbol #1) of the first scheduled PSSCH of the at least one PSSCH and the ending symbol (e.g., e_symbol #2) of the last scheduled slot of the at least one slot. In some embodiments, field #1A may indicate the starting symbol (e.g., s_symbol #2) of the first scheduled slot of the at least one slot and the ending symbol (e.g., e_symbol #1) of the last scheduled PSSCH of the at least one PSSCH.

In some embodiments, field #2A may indicate the number of the at least one PSSCH, the number of the at least one slot, the number of the at least one PSSCH minus two (e.g., the number of the middle PSSCH(s)), or the number of the at least one slot minus two (e.g., the number of the middle slot(s)).

In the above embodiments, all symbols of the second slot to the last but one slot of the at least one slot may be used for PSSCH transmission. Put another way, although the first scheduled PSSCH or the first scheduled slot may not be started from the initial symbol of a slot (e.g., symbol 0), or the last scheduled PSSCH or the last scheduled slot may not be ended at the last symbol of a slot (e.g., symbol 13), a full slot is assigned for the middle slot(s) of the at least one slot.

In some embodiments, field #1A may indicate a start and length indication value (SLIV) indicating a starting symbol index (denoted as x) and a number of symbols (denoted as L). The starting symbol index may correspond to s_symbol #1 or s_symbol #2. The e_symbol #1 or e_symbol #2 may be determined based on s_symbol #1 or s_symbol #2 and L.

For example, assuming that a slot includes 14 symbols indexed from 0 to 13, for a SLIV jointly indicating a starting symbol index (e.g., x) and a number of symbols (e.g., L), the starting symbol index x may be reinterpreted as the index of s_symbol #1 or s_symbol #2, and the index of e_symbol #1 or e_symbol #2 (denoted as index y) may be determined by y=x+L−1.

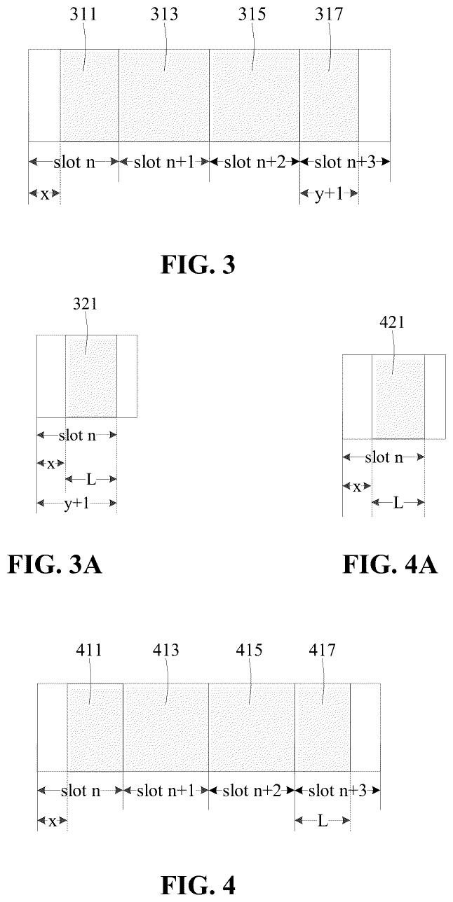

For example, referring to FIG. 3, an SCI may schedule four PSSCHs (e.g., PSSCHs 311-317) in four slots (e.g., slots n to n+3). In some examples, the first scheduled slot or the first scheduled PSSCH may not start from the initial symbol (e.g., symbol 0) and may start from symbol x. Field #1A of the SCI may indicate the values of x and L. The index of e_symbol #1 or e_symbol #2 can be determined according to y=x+L−1.

In some embodiments, field #1A may indicate the SLIV from a set of SLIVs. The set of SLIVs may be configured by radio resource control (RRC) signaling, predefined in a standard(s), or preconfigured during the UE implementation.

As stated above, in some embodiments, the SCI (or the 1^{st}-stage SCI) may be carried on a PSCCH in the first scheduled slot of the at least one slot. In the case that the PSCCH and the first scheduled PSSCH of the at least one PSSCH are purely TDMed, the starting symbol of the first scheduled PSSCH may immediately follow an ending symbol of the PSCCH; otherwise, for example, in the case that the PSCCH and the first scheduled PSSCH of the at least one PSSCH are FDMed and TDMed, the starting symbol of the first scheduled PSSCH may be the same as that of the PSCCH.

In some embodiments, one or more PSSCHs of the at least one PSSCH may be transmitted in a single slot of the at least one slot. For example, a single slot may be used for transmitting at most one PSSCH, and then the number of scheduled PSSCHs is equal to the number of scheduled slots. For example, a single slot may be used for transmitting two or more PSSCHs, and then the number of scheduled PSSCHs may be larger than the number of scheduled slots.

In some embodiments, the number of required bits for indicating field #2A may be dependent on the maximum number of PSSCHs or the maximum number of slots schedulable by a single SCI, which can be, for example, configured by RRC signaling or predefined in a standard(s).

In some examples, assuming that a maximum of N PSSCHs or slots can be scheduled by a single SCI, then at least ┌log₂ N┐ bits may be required for field #2A for indicating the number of actually scheduled number of PSSCHs or slots (e.g., the number of the at least one PSSCH or the number of the at least one slot as described above). For example, assuming that a maximum of 4 PSSCHs or slots can be scheduled by a single SCI, then at least 2 bits in an SCI are required to indicate that 1, 2, 3, or 4 PSSCHs or slots are scheduled.

In some examples, at least ┌log₂ (N−2)┐ bits may be required for field #2A for indicating the number of the middle PSSCH(s) or slot(s) of the actually scheduled PSSCHs or slots.

Then, the number of actually scheduled PSSCH(s) or slot(s) is equal to the number of middle PSSCH(s) or slot(s) plus the applicable starting PSSCH or slot (if any) plus the applicable ending PSSCH or slot (if any). This is achievable because the first and the last scheduled PSSCHs or slots are indicated by field #1A. The middle slot(s) indicated by field #2A is a full slot(s) and the first or the last scheduled slot (if any) may be fully or partially scheduled in these examples.

For example, assuming that a maximum of 4 PSSCHs or slots can be scheduled by a single SCI, then at least 1 bit in an SCI is required to indicate that 1, 2, 3, or 4 PSSCHs or slots are scheduled. For instance, it is assumed that field #2A indicates the number of the middle slot(s) of the actually scheduled slots and a slot includes 14 symbols indexed from 0 to 13. For example, in the case that field #2A indicates 1 slot, and field #1A indicates that the index of s_symbol #1 or s_symbol #2 is inapplicable for transmitting a PSSCH starting from s_symbol #1 or s_symbol #2 in one slot (e.g., 12, 13, 14 or other inapplicable symbol indices) and the index of e_symbol #1 or e_symbol #2 is inapplicable for transmitting a PSSCH ending at e_symbol #1 or e_symbol #2 in one slot (e.g., 0, 1, 14, or other inapplicable symbol indices), it suggests that one slot is scheduled.

For instance, in the case that field #2A indicates 1 slot, and field #1A indicates that the index of s_symbol #1 or s_symbol #2 is applicable for transmitting a PSSCH starting from s_symbol #1 or s_symbol #2 in one slot (e.g., symbol 0) and the index of e_symbol #1 or e_symbol #2 is inapplicable for transmitting a PSSCH ending at e_symbol #1 or e_symbol #2 in one slot (e.g., symbol 0), it suggests that two slots are scheduled. For example, the first PSSCH or the first slot is scheduled from s_symbol #1 or s_symbol #2 to symbol 13 and followed by a full slot scheduled from symbol 0 to symbol 13.

For instance, in the case that field #2A indicates 1 slot, and field #1A indicates that the index of s_symbol #1 or s_symbol #2 is inapplicable for transmitting a PSSCH starting from s_symbol #1 or s_symbol #2 in one slot (e.g., symbol 14) and the index of e_symbol #1 or e_symbol #2 is applicable for transmitting a PSSCH ending at e_symbol #1 or e_symbol #2 in one slot (e.g., symbol 9), it suggests that two slots are scheduled. For example, the first slot is a full slot scheduled from symbol 0 to symbol 13 and followed by another slot scheduled from symbol 0 to symbol 9.

For instance, in the case that field #2A indicates 1 slot, and field #1A indicates that the index of s_symbol #1 or s_symbol #2 is applicable for transmitting a PSSCH starting from s_symbol #1 or s_symbol #2 in one slot (e.g., symbol 7) and the index of e_symbol #1 or e_symbol #2 is applicable for transmitting a PSSCH ending at e_symbol #1 or e_symbol #2 in one slot (e.g., symbol 9), it suggests that three slots are scheduled, i.e., the first slot is scheduled from symbol 7 to symbol 13, the second slot is a full slot scheduled from symbol 0 to symbol 13, and followed by a third slot scheduled from symbol 0 to symbol 9.

It should be noted that indicator #1 as described in the above embodiments can be applied to either the case where a single SCI schedules a single slot or a single PSSCH or the case where a single SCI schedules a plurality of slots or PSSCHs. For example, in the case that an SCI schedules a single PSSCH or a single slot, field #2A may indicate that a single PSSCH or slot is scheduled and the SLIV indicated by field #1A may be reinterpreted as the starting symbol index and the duration of the single scheduled PSSCH or the single scheduled slot.

For example, referring to FIG. 3A, an SCI may schedule a single PSSCH (e.g., PSSCH 321) in a single slot (e.g., slot n). Field #1A of the SCI may indicate the starting symbol index (e.g., x) and the number of symbols (e.g., L) of the single PSSCH. The index y of the ending symbol of the single PSSCH can be determined according to y=x+L−1.

In some embodiments of the present disclosure, field #1A may indicate the starting symbol (e.g., s_symbol #1) of the first scheduled PSSCH of the at least one PSSCH and the number of symbols (denoted as N_{symbol #}1) of the last scheduled PSSCH of the at least one PSSCH. In some embodiments, field #1A may indicate the starting symbol (e.g., s_symbol #2) of the first scheduled slot of the at least one slot and the number of symbols (denoted as N_{symbol #}2) of the last scheduled slot of the at least one slot. In some embodiments, field #1A may indicate the starting symbol (e.g., s_symbol #1) of the first scheduled PSSCH of the at least one PSSCH and the number of symbols (e.g., N_{symbol #}2) of the last scheduled slot of the at least one slot. In some embodiments, field #1A may indicate the starting symbol (e.g., s_symbol #2) of the first scheduled slot of the at least one slot and the number of symbols (e.g., N_{symbol #}1) of the last scheduled PSSCH of the at least one PSSCH.

In some embodiments, field #2A may indicate the number of the at least one PSSCH, the number of the at least one slot, the number of the at least one PSSCH minus two (e.g., the number of the middle PSSCH(s)), or the number of the at least one slot minus two (e.g., the number of the middle slot(s)).

In the above embodiments, all symbols of the second slot to the last but one slot of the at least one slot may be used for PSSCH transmission. Put another way, although the first scheduled PSSCH or the first scheduled slot may not be started from the initial symbol of a slot (e.g., symbol 0), or the last scheduled PSSCH or the last scheduled slot may not be ended at the last symbol of a slot (e.g., symbol 13), a full slot is assigned for the middle slot(s) of the at least one slot.

In some embodiments, field #1A may indicate a SLIV indicating a starting symbol index (e.g., x) and a number of symbols (e.g., L). The starting symbol index may correspond to s_symbol #1 or s_symbol #2. The number of symbols may correspond to N_{symbol #}1 or N_{symbol #}2.

For example, assuming that a slot includes 14 symbols indexed from 0 to 13, for a SLIV jointly indicating a starting symbol index (e.g., x) and a number of symbols (e.g., L), the starting symbol index x may be reinterpreted as the index of s_symbol #1 or s_symbol #2, and the index of e_symbol #1 or e_symbol #2 (e.g., y) may be determined by y=L−1.

For example, referring to FIG. 4, an SCI may schedule four PSSCHs (e.g., PSSCHs 411-417) in four slots (e.g., slots n to n+3). In some examples, the first scheduled slot or the first scheduled PSSCH may not start from the initial symbol (e.g., symbol 0) and may start from symbol x. Field #1A of the SCI may indicate the values of x and L as shown in FIG. 4. The index y of the ending symbol of the last scheduled slot or last scheduled PSSCH can be determined according to y=L−1.

In some embodiments, field #1A may indicate the SLIV from a set of SLIVs. The set of SLIVs may be configured by radio resource control (RRC) signaling, predefined in a standard(s), or preconfigured during the UE implementation.

As stated above, in some embodiments, the SCI (or the 1^{st}-stage SCI) may be carried on a PSCCH in the first scheduled slot of the at least one slot. In the case that the PSCCH and the first scheduled PSSCH of the at least one PSSCH are purely TDMed, the starting symbol of the first scheduled PSSCH may immediately follow an ending symbol of the PSCCH; otherwise, for example, in the case that the PSCCH and the first scheduled PSSCH of the at least one PSSCH are FDMed and TDMed, the starting symbol of the first scheduled PSSCH may be the same as that of the PSCCH.

In some embodiments, one or more PSSCHs of the at least one PSSCH may be transmitted in a single slot of the at least one slot. For example, a single slot may be used for transmitting at most one PSSCH, and then the number of scheduled PSSCHs is equal to the number of scheduled slots. For example, a single slot may be used for transmitting two or more PSSCHs, and then the number of scheduled PSSCHs may be larger than the number of scheduled slots.

In some embodiments, the number of required bits for indicating field #2A may be dependent on the maximum number of PSSCHs or the maximum number of slots schedulable by a single SCI, which can be, for example, configured by RRC signaling or predefined in a standard(s).

In some examples, assuming that a maximum of N PSSCHs or slots can be scheduled by a single SCI, then at least ┌log₂ N┐ bits may be required for field #2A for indicating the number of actually scheduled number of PSSCHs or slots (e.g., the number of the at least one PSSCH or the number of the at least one slot as described above). For example, assuming that a maximum of 4 PSSCHs or slots can be scheduled by a single SCI, then at least 2 bits in an SCI may be required to indicate that 1, 2, 3, or 4 PSSCHs or slots are scheduled.

In some examples, at least ┌log₂ (N−2)┐ bits may be required for field #2A for indicating the number of the middle PSSCH(s) or slot(s) of the actually scheduled PSSCHs or slots. Then, the number of actually scheduled PSSCH(s) or slot(s) is equal to the number of middle PSSCH(s) or slot(s) plus the applicable starting PSSCH or slot (if any) plus the applicable ending PSSCH or slot (if any). The middle slot(s) indicated by field #2A is a full slot(s) and the first or the last scheduled slot (if any) may be fully or partially scheduled in these examples. This is achievable because the first and the last scheduled PSSCHs or slots are indicated by field #1A. For example, assuming that a maximum of 4 PSSCHs or slots can be scheduled by a single SCI, then at least 1 bit in an SCI may be required to indicate that 1, 2, 3, or 4 PSSCHs or slots are scheduled.

It should be noted that indicator #1 as described in the above embodiments can be applied to either the case where a single SCI schedules a single slot or a single PSSCH or the case where a single SCI schedules a plurality of slots or PSSCHs. For example, in the case that an SCI schedules a single PSSCH or a single slot, field #2A may indicate that a single PSSCH or slot is scheduled and the SLIV indicated by field #1A may be reinterpreted as the starting symbol index and the duration of the single scheduled PSSCH or the single scheduled slot.

For example, referring to FIG. 4A, an SCI may schedule a single PSSCH (e.g., PSSCH 421) in a single slot (e.g., slot n). Field #1A of the SCI may indicate the starting symbol index (e.g., x) and the number of symbols (e.g., L) of the single PSSCH. The index y of the ending symbol of the single PSSCH can be determined according to y=x+L−1.

In some embodiments of the present disclosure, field #1A may indicate the ending symbol (e.g., e_symbol #1) of the last scheduled PSSCH of the at least one PSSCH, the ending symbol (e.g., e_symbol #2) of the last scheduled slot of the at least one slot, the number of symbols (e.g., N_{symbol #}1) of the last scheduled PSSCH of the at least one PSSCH, or the number of symbols (e.g., N_{symbol #}2) of the last scheduled slot of the at least one slot.

In these embodiments, the starting symbol of the first scheduled PSSCH of the at least one PSSCH may be determined based on the PSCCH carrying the scheduling SCI (or the 1^{st}-stage SCI). The PSCCH may be transmitted in the first scheduled slot of the at least one slot. For example, in the case that the PSCCH and the first scheduled PSSCH of the at least one PSSCH are purely TDMed, the starting symbol of the first scheduled PSSCH may immediately follow an ending symbol of the PSCCH; otherwise, for example, in the case that the PSCCH and the first scheduled PSSCH of the at least one PSSCH are FDMed and TDMed, the starting symbol of the first scheduled PSSCH may be the same as that of the PSCCH.

In some embodiments, field #2A may indicate the number of the at least one PSSCH, the number of the at least one slot, the number of the at least one PSSCH minus two (e.g., the number of the middle PSSCH(s)), or the number of the at least one slot minus two (e.g., the number of the middle slot(s)).

In the above embodiments, all symbols of the second slot to the last but one slot of the at least one slot may be used for PSSCH transmission. Put another way, although the first scheduled PSSCH or the first scheduled slot may not be started from the initial symbol of a slot (e.g., symbol 0), or the last scheduled PSSCH or the last scheduled slot may not be ended at the last symbol of a slot (e.g., symbol 13), a full slot is assigned for the middle slot(s) of the at least one slot.

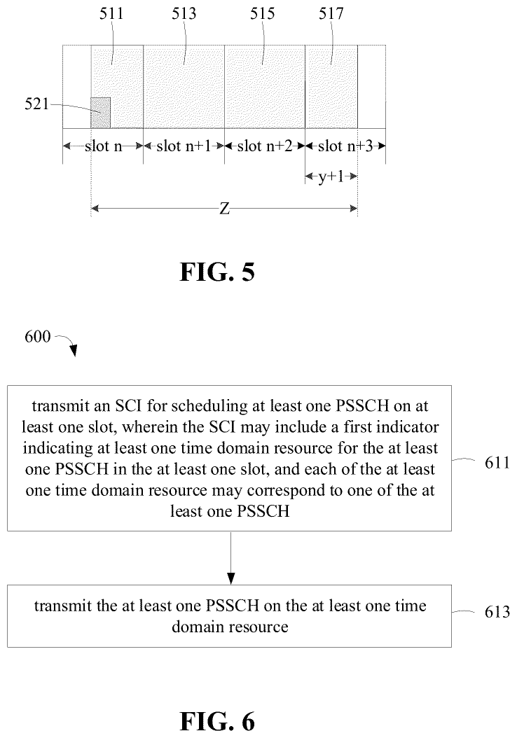

For example, referring to FIG. 5, an SCI may schedule four PSSCHs (e.g., PSSCHs 511-517) in four slots (e.g., slots n to n+3). In some examples, the first scheduled slot or the first scheduled PSSCH may not start from the initial symbol (e.g., symbol 0). In some examples, as shown in FIG. 5, PSCCH 521, which is FDMed and TDMed with the first scheduled PSSCH (e.g., PSSCH 511), may carry the SCI (or a 1^{st}-stage SCI). The s_symbol #1 or s_symbol #2 can be determined based on the location of PSCCH 521. In some examples, e_symbol #1 or e_symbol #2 can be determined based on field #1A of the SCI. For example, in the case that field #1A of the SCI indicates N_{symbol #}2, the index y of the ending symbol can be determined according to y=N_{symbol #}2-1.

In some embodiments, field #1A may indicate e_symbol #1 or e_symbol #2 from a set of ending positions (e.g., ending symbol indexes), which may be configured by radio resource control (RRC) signaling, predefined in a standard(s), or preconfigured during the UE implementation. In some embodiments, field #1A may indicate N_{symbol #}1 or N_{symbol #}2 from a set of symbol numbers, which may be configured by radio resource control (RRC) signaling, predefined in a standard(s), or preconfigured during the UE implementation. The size of field #1A (e.g., the bits required for field #1A in the SCI) may be based on a size of the set of ending positions or a size of the set of symbol numbers (e.g., the number of values in the set).

For example, it is assumed that a slot includes 14 symbols indexed from 0 to 13. A set of ending symbol indexes may include symbol 13, symbol 12, symbol 9, symbol 6, etc. When symbol 13 is indicated, it may imply that the last PSSCH is transmitted till the end of the last scheduled slot. When symbol 12 is indicated, it may imply that the last PSSCH is transmitted till symbol 12 of the last scheduled slot. Symbol 13 of the last scheduled slot may be reserved as one symbol gap. When symbol 9 is indicated, it may imply that the last PSSCH is transmitted till symbol 9 of the last scheduled slot. One PSFCH transmission occasion may be reserved in the last scheduled slot, where symbol 10 and symbol 13 may be two gap symbols surrounding the PSFCH transmission occasion. When symbol 6 is indicated, it may imply that the last PSSCH is transmitted till symbol 6 of the last scheduled slot. Two PSFCH transmission occasions may be reserved in the last scheduled slot, where symbol 7, symbol 10 and symbol 13 may be three gap symbols surrounding the two PSFCH transmission occasions.

In some embodiments, one or more PSSCHs of the at least one PSSCH may be transmitted in a single slot of the at least one slot. For example, a single slot may be used for transmitting at most one PSSCH, and then the number of scheduled PSSCHs is equal to the number of scheduled slots. For example, a single slot may be used for transmitting two or more PSSCHs, and then the number of scheduled PSSCHs may be larger than the number of scheduled slots.

In some embodiments, the number of required bits for indicating field #2A may be dependent on the maximum number of PSSCHs or the maximum number of slots schedulable by a single SCI, which can be, for example, configured by RRC signaling or predefined in a standard(s).

In some examples, assuming that a maximum of N PSSCHs or slots can be scheduled by a single SCI, then at least ┌log₂ N┐ bits may be required for field #2A for indicating the number of actually scheduled number of PSSCHs or slots (e.g., the number of the at least one PSSCH or the number of the at least one slot as described above). For example, assuming that a maximum of 4 PSSCHs or slots can be scheduled by a single SCI, then at least 2 bits in an SCI are required to indicate that 1, 2, 3, or 4 PSSCHs or slots are scheduled.

In some examples, at least ┌log₂ (N−2)┐ bits may be required for field #2A for indicating the number of the middle PSSCH(s) or slot(s) of the actually scheduled PSSCHs or slots. Then, the number of actually scheduled PSSCH(s) or slot(s) is equal to the number of middle PSSCH(s) or slot(s) plus the applicable starting PSSCH or slot (if any) plus the applicable ending PSSCH or slot (if any). The middle slot(s) indicated by field #2A is a full slot(s) and the first or the last scheduled slot (if any) may be fully or partially scheduled in these examples. This is achievable because the first and the last scheduled PSSCHs or slots are indicated by field #1A. For example, assuming that a maximum of 4 PSSCHs or slots can be scheduled by a single SCI, then at least 1 bit in an SCI is required to indicate that 1, 2, 3, or 4 PSSCHs or slots are scheduled.

It should be noted that indicator #1 as described in the above embodiments can be applied to either the case where a single SCI schedules a single slot or a single PSSCH or the case where a single SCI schedules a plurality of slots or PSSCHs. For example, in the case that an SCI schedules a single PSSCH or a single slot, field #2A may indicate that a single PSSCH or slot is scheduled and field #1A may indicate the ending symbol of the single scheduled PSSCH or slot.

In some embodiments of the present disclosure, field #1A may indicate the starting symbol (e.g., s_symbol #1) of the first scheduled PSSCH of the at least one PSSCH or the starting symbol (e.g., s_symbol #2) of the first scheduled slot of the at least one slot. In some embodiments, field #2A may indicate the total number (denoted as Z) of symbols for the at least one PSSCH. Alternatively, field #2A may indicate the total number of symbols for the at least one PSSCH excluding the number of symbols of the first scheduled PSSCH or the first scheduled slot of the at least one PSSCH.

For example, referring again to FIG. 5, the SCI scheduling the four PSSCHs (e.g., PSSCHs 511-517) may include field #1A indicating the starting symbol of PSSCH 511 and field #2A indicating the value of Z.

As stated above, in some embodiments, the SCI (or the 1^{st}-stage SCI) may be carried on a PSCCH in the first scheduled slot of the at least one slot. In the case that the PSCCH and the first scheduled PSSCH of the at least one PSSCH are purely TDMed, the starting symbol of the first scheduled PSSCH may immediately follow an ending symbol of the PSCCH; otherwise, for example, in the case that the PSCCH and the first scheduled PSSCH of the at least one PSSCH are FDMed and TDMed, the starting symbol of the first scheduled PSSCH may be the same as that of the PSCCH.

In the above embodiments, all symbols of the second slot to the last but one slot of the at least one slot may be used for PSSCH transmission. Put another way, although the first scheduled PSSCH or the first scheduled slot may not be started from the initial symbol of a slot (e.g., symbol 0), or the last scheduled PSSCH or the last scheduled slot may not be ended at the last symbol of a slot (e.g., symbol 13), a full slot is assigned for the middle slot(s) of the at least one slot.

In the above embodiments, the ending symbol (e.g., e_symbol #1) of the last scheduled PSSCH of the at least one PSSCH or the ending symbol (e.g., e_symbol #2) of the last scheduled slot of the at least one slot may be determined based on field #1A and field #2A (e.g., s_symbol #1 or s_symbol #2 and Z).

For example, it is assumed that a slot includes 14 symbols indexed from 0 to 13. Assuming that field #2A indicates that a total of 45 symbols for the at least one scheduled PSSCH and field #1A indicates that the starting symbol of the first scheduled PSSCH or slot is symbol 7, then the first scheduled PSSCH occupies 7 symbols from symbol 7 to symbol 13 in the first scheduled slot; the second scheduled PSSCH occupies 14 symbols from symbol 0 to symbol 13 in the second scheduled slot; the third scheduled PSSCH occupies 14 symbols from symbol 0 to symbol 13 in the third scheduled slot; and the last scheduled PSSCH occupies 10 symbols from symbol 0 to symbol 9 in the last scheduled slot.

In some embodiments, field #1A may indicate s_symbol #1 or s_symbol #2 from a set of starting positions (e.g., starting symbol indexes), which may be configured by radio resource control (RRC) signaling, predefined in a standard(s), or preconfigured during the UE implementation. For example, a set of starting symbol indexes may include symbol 0, symbol 1, symbol 7, symbol 8, etc. The size of field #1A (e.g., the bits required for field #1A in the SCI) may be based on a size of the set of starting positions (e.g., the number of values in the set).

In some embodiments, the size of field #2A may be based on the maximum number of slots schedulable by the SCI. For example, assuming that the maximum number of slots which can be scheduled by a single SCI is N and a slot includes 14 symbols, the maximum number of symbols schedulable by a single SCI is equal to 14*N. To achieve full flexibility of the multi-PSSCH scheduling by a single SCI, field #2A may require at least ┌log₂ 14*N┐ bits for indicating the maximum number of symbols. For example, assuming that a maximum of 4 slots can be scheduled by a single SCI, the maximum number of symbols is 4*14 and thus at least 6 bits are required for field #2A.

In some embodiments, field #2A may indicate the value of Z from a set of total number of symbols, which may be configured by radio resource control (RRC) signaling, predefined in a standard(s), or preconfigured during the UE implementation. The size of field #2A may be based on a size of the set of total number of symbols (e.g., the number of values in the set). In these embodiments, the number of bits for indicator #1 (e.g., field #2A) can be reduced.

In some embodiments, one or more PSSCHs of the at least one PSSCH may be transmitted in a single slot of the at least one slot. For example, a single slot may be used for transmitting at most one PSSCH, and then the number of scheduled PSSCHs is equal to the number of scheduled slots. For example, a single slot may be used for transmitting two or more PSSCHs, and then the number of scheduled PSSCHs may be larger than the number of scheduled slots.

It should be noted that indicator #1 as described in the above embodiments can be applied to either the case where a single SCI schedules a single slot or a single PSSCH or the case where a single SCI schedules a plurality of slots or PSSCHs.

In some embodiments of the present disclosure, indicator #1 may include a single field (denoted as field #1B). Field #1B may indicate the total number (e.g., Z) of symbols for the at least one PSSCH.

In the above embodiments, all symbols of the second slot to the last but one slot of the at least one slot may be used for PSSCH transmission. Put another way, although the first scheduled PSSCH or the first scheduled slot may not be started from the initial symbol of a slot (e.g., symbol 0), or the last scheduled PSSCH or the last scheduled slot may not be ended at the last symbol of a slot (e.g., symbol 13), a full slot is assigned for the middle slot(s) of the at least one slot.

In some embodiments, the size of field #1B may be based on the maximum number of slots schedulable by the SCI. For example, assuming that the maximum number of slots which can be scheduled by a single SCI is N and a slot includes 14 symbols, the maximum number of symbols schedulable by a single SCI is equal to 14*N. To achieve full flexibility of the multi-PSSCH scheduling by a single SCI, field #1B may require at least ┌log₂ 14*N┐ bits for indicating the maximum number of symbols. For example, assuming that a maximum of 4 slots can be scheduled by a single SCI, the maximum number of symbols is 4*14 and thus at least 6 bits are required for field #1B, i.e., indicator #1.

In some embodiments, field #1B may indicate the value of Z from a set of total number of symbols, which may be configured by radio resource control (RRC) signaling, predefined in a standard(s), or preconfigured during the UE implementation. The size of field #1B (i.e., indicator #1) may be based on a size of the set of total number of symbols (e.g., the number of values in the set). In these embodiments, the number of bits for indicator #1 (i.e., field #1B) can be reduced.

In the above embodiments, the starting symbol of the first scheduled PSSCH of the at least one PSSCH may be determined based on the PSCCH carrying the scheduling SCI (or the 1^{st}-stage SCI). The PSCCH may be transmitted in the first scheduled slot of the at least one slot. For example, in the case that the PSCCH and the first scheduled PSSCH of the at least one PSSCH are purely TDMed, the starting symbol of the first scheduled PSSCH may immediately follow an ending symbol of the PSCCH; otherwise, for example, in the case that the PSCCH and the first scheduled PSSCH of the at least one PSSCH are FDMed and TDMed, the starting symbol of the first scheduled PSSCH may be the same as that of the PSCCH.

In the above embodiments, the ending symbol (e.g., e_symbol #1) of the last scheduled PSSCH of the at least one PSSCH or the ending symbol (e.g., e_symbol #2) of the last scheduled slot of the at least one slot may be determined based on field #1B (e.g., Z) and the starting symbol of the first scheduled PSSCH.

For example, it is assumed that a slot includes 14 symbols indexed from 0 to 13. Assuming that field #1B indicates that a total of 45 symbols for the at least one scheduled PSSCH and the starting symbol of the first scheduled PSSCH determined based on the associated PSCCH is symbol 7, then the first scheduled PSSCH occupies 7 symbols from symbol 7 to symbol 13 in the first scheduled slot; the second scheduled PSSCH occupies 14 symbols from symbol 0 to symbol 13 in the second scheduled slot; the third scheduled PSSCH occupies 14 symbols from symbol 0 to symbol 13 in the third scheduled slot; and the last scheduled PSSCH occupies 10 symbols from symbol 0 to symbol 9 in the last scheduled slot.

In some embodiments, one or more PSSCHs of the at least one PSSCH may be transmitted in a single slot of the at least one slot. For example, a single slot may be used for transmitting at most one PSSCH, and then the number of scheduled PSSCHs is equal to the number of scheduled slots. For example, a single slot may be used for transmitting two or more PSSCHs, and then the number of scheduled PSSCHs may be larger than the number of scheduled slots.

It should be noted that indicator #1 as described in the above embodiments can be applied to either the case where a single SCI schedules a single slot or a single PSSCH or the case where a single SCI schedules a plurality of slots or PSSCHs.

In some embodiments of the present disclosure, indicator #1 may include three fields (denoted as field #1C, field #2C and field #3C).

In some embodiments of the present disclosure, field #1C may indicate the starting symbol (e.g., s_symbol #1) of the first scheduled PSSCH of the at least one PSSCH or the starting symbol (e.g., s_symbol #2) of the first scheduled slot of the at least one slot. Field #2C may indicate the ending symbol (e.g., e_symbol #1) of the last scheduled PSSCH of the at least one PSSCH or the ending symbol (denoted as e_symbol #2) of the last scheduled slot of the at least one slot.

In some embodiments, field #3C may indicate the number of the at least one PSSCH, the number of the at least one slot, the number of the at least one PSSCH minus two (e.g., the number of the middle PSSCH(s)), or the number of the at least one slot minus two (e.g., the number of the middle slot(s)).

In the above embodiments, all symbols of the second slot to the last but one slot of the at least one slot may be used for PSSCH transmission. Put another way, although the first scheduled PSSCH or the first scheduled slot may not be started from the initial symbol of a slot (e.g., symbol 0), or the last scheduled PSSCH or the last scheduled slot may not be ended at the last symbol of a slot (e.g., symbol 13), a full slot is assigned for the middle slot(s) of the at least one slot.

In some embodiments, field #1C may indicate s_symbol #1 or s_symbol #2 from a set of starting positions (e.g., starting symbol indexes), which may be configured by radio resource control (RRC) signaling, predefined in a standard(s), or preconfigured during the UE implementation. For example, a set of starting symbol indexes may include symbol 0, symbol 1, symbol 7, symbol 8, etc. The size of field #1C (e.g., the bits required for field #1C in the SCI) may be based on a size of the set of starting positions (e.g., the number of values in the set).

In some embodiments, field #2C may indicate e_symbol #1 or e_symbol #2 from a set of ending positions (e.g., ending symbol indexes), which may be configured by radio resource control (RRC) signaling, predefined in a standard(s), or preconfigured during the UE implementation. The size of field #2C (e.g., the bits required for field #2C in the SCI) may be based on a size of the set of ending positions (e.g., the number of values in the set).

For example, it is assumed that a slot includes 14 symbols indexed from 0 to 13. A set of ending symbol indexes may include symbol 13, symbol 12, symbol 9, symbol 6, etc. When symbol 13 is indicated, it may imply that the last PSSCH is transmitted till the end of the last scheduled slot. When symbol 12 is indicated, it may imply that the last PSSCH is transmitted till symbol 12 of the last scheduled slot. Symbol 13 of the last scheduled slot may be reserved as one symbol gap. When symbol 9 is indicated, it may imply that the last PSSCH is transmitted till symbol 9 of the last scheduled slot. One PSFCH transmission occasion may be reserved in the last scheduled slot, where symbol 10 and symbol 13 may be two gap symbols surrounding the PSFCH transmission occasion. When symbol 6 is indicated, it may imply that the last PSSCH is transmitted till symbol 6 of the last scheduled slot. Two PSFCH transmission occasions may be reserved in the last scheduled slot, where symbol 7, symbol 10 and symbol 13 may be three gap symbols surrounding the two PSFCH transmission occasions.

In some embodiments, field #2C may indicate N_{symbol #}1 or N_{symbol #}2 as described above. In some embodiments, field #2C may indicate N_{symbol #}1 or N_{symbol #}2 from a set of symbol numbers, which may be configured by RRC signaling, predefined in a standard(s), or preconfigured during the UE implementation. The size of field #2C may be based on a size of the set of symbol numbers (e.g., the number of values in the set).

As stated above, in some embodiments, the SCI (or the 1^{st}-stage SCI) may be carried on a PSCCH in the first scheduled slot of the at least one slot. In the case that the PSCCH and the first scheduled PSSCH of the at least one PSSCH are purely TDMed, the starting symbol of the first scheduled PSSCH may immediately follow an ending symbol of the PSCCH; otherwise, for example, in the case that the PSCCH and the first scheduled PSSCH of the at least one PSSCH are FDMed and TDMed, the starting symbol of the first scheduled PSSCH may be the same as that of the PSCCH.

In some embodiments, one or more PSSCHs of the at least one PSSCH may be transmitted in a single slot of the at least one slot. For example, a single slot may be used for transmitting at most one PSSCH, and then the number of scheduled PSSCHs is equal to the number of scheduled slots. For example, a single slot may be used for transmitting two or more PSSCHs, and then the number of scheduled PSSCHs may be larger than the number of scheduled slots.

In some embodiments, the number of required bits for indicating field #3C may be dependent on the maximum number of PSSCHs or the maximum number of slots schedulable by a single SCI, which can be, for example, configured by RRC signaling or predefined in a standard(s).

In some examples, assuming that a maximum of N PSSCHs or slots can be scheduled by a single SCI, then at least ┌log₂ N┐ bits may be required for field #3C for indicating the number of actually scheduled number of PSSCHs or slots (e.g., the number of the at least one PSSCH or the number of the at least one slot as described above). For example, assuming that a maximum of 4 PSSCHs or slots can be scheduled by a single SCI, then at least 2 bits in an SCI are required to indicate that 1, 2, 3, or 4 PSSCHs or slots are scheduled.

In some examples, at least ┌log₂ (N−2)┐ bits may be required for field #3C for indicating the number of the middle PSSCH(s) or slot(s) of the actually scheduled PSSCHs or slots. Then, the number of actually scheduled PSSCH(s) or slot(s) is equal to the number of middle PSSCH(s) or slot(s) plus the applicable starting PSSCH or slot (if any) plus the applicable ending PSSCH or slot (if any). The middle slot(s) indicated by field #3C is a full slot(s) and the first or the last scheduled slot may be fully or partially scheduled in these examples. This is achievable because the first and the last scheduled PSSCHs or slots are indicated by fields #1C and #2C. For example, assuming that a maximum of 4 PSSCHs or slots can be scheduled by a single SCI, then at least 1 bit in an SCI is required to indicate that 1, 2, 3, or 4 PSSCHs or slots are scheduled.

In some embodiments, the above three fields may be jointly coded in the SCI. The field size may be dependent on the number of possible combinations.

It should be noted that indicator #1 as described in the above embodiments can be applied to either the case where a single SCI schedules a single slot or a single PSSCH or the case where a single SCI schedules a plurality of slots or PSSCHs.

In some embodiments of the present disclosure, indicator #1 may indicate a TDRA pattern for the at least one time domain resource for the at least one PSSCH.

In some embodiments, the indicated TDRA pattern may be from a list of TDRA patterns. The list of TDRA patterns may be configured by RRC signaling, predefined in a standard(s), or preconfigured. In some examples, each TDRA pattern in the list may include one or more SLIVs. One code point of indicator #1 in the SCI may indicate one TDRA pattern from the list. Dependent on the mapping relationship between the code point and the corresponding TDRA pattern, a single SCI can schedule a single PSSCH or more than one PSSCH in one slot, or schedule a plurality of PSSCHs in a plurality of contiguous or non-contiguous slots. A size of indicator #1 may be dependent on the size of the TDRA pattern list (e.g., the number of TDRA patterns in the list).

The design principles for a TDRA pattern may include:
The list of TDRA patterns can support a different number of PSSCHs scheduled by an SCI.
The list of TDRA patterns can support multiple PSSCHs with different starting symbols, different lengths, or both.
The list of TDRA patterns can support multiple starting positions of the first scheduled PSSCH.
The list of TDRA patterns can support multiple ending positions of the last scheduled PSSCH.
The list of TDRA patterns can support multiple PSSCHs scheduled in the same slot.
The list of TDRA patterns can support multiple contiguous or non-contiguous PSSCHs in multiple slots or the same slot.
The list of TDRA patterns can support multiple PSSCHs in different slots.
The list of TDRA patterns can explicitly or implicitly indicate the number of scheduled PSSCHs.
The list of TDRA patterns can include a TDRA pattern for a single PSSCH and a TDRA pattern for multiple PSSCHs.

The list of TDRA patterns can be defined using the following pseudo-code:
PSSCH-TimeDomainResourceAllocationList::=SEQUENCE
(SIZE (1 . . . maxNrofSL-Allocations)) OF PSSCH-TimeDomainResourceAllocation

The examples of a TDRA pattern are described in detail in the following text.

For example, in some embodiments, an SCI may schedule a single PSSCH and indicate a TDRA pattern which indicates a SLIV for the single PSSCH. For example, the above-mentioned at least one PSSCH may only include a single PSSCH. The single PSSCH is scheduled in a slot where the SCI is transmitted. For example, the TDRA pattern for single PSSCH scheduling may be defined as follows:

```
PSSCH-TimeDomainResourceAllocation::= SEQUENCE
{
  startSymbolAndLength INTEGER (0..127)
  {
```

In some embodiments, an SCI may schedule a plurality of PSSCHs and indicate a TDRA pattern which indicates time domain resources for the plurality of PSSCHs. For example, the above-mentioned at least one PSSCH may include a plurality of PSSCHs. The first scheduled PSSCH of the at least one PSSCH may be scheduled in a slot where the SCI (e.g., the PSCCH or the 1^{st} stage SCI) is transmitted.

Examples of a TDRA pattern for multiple PSSCH scheduling will be described in detail later. The meanings of some parameters used in these examples are explained below:
For a TDRA pattern supporting M PSSCHs scheduled by one SCI, the value of k3_x indicates the slot level offset between the slot where the SCI (e.g., the PSCCH or the 1^{st} stage SCI) is transmitted and the slot where the x^{th} PSSCH is scheduled.
The element of k3_x may not be necessarily in the following examples in some cases including, for example, when the slot level offset between the slot where the SCI is transmitted and the slot where the first PSSCH or the x^{th} PSSCH is scheduled is indicated by the SCI (e.g., indicated by a dedicated field in the SCI or implicitly indicated) or only contiguous transmission is supported for the multiple scheduled PSSCHs.
The startSymbolAndLength_x indicates the starting symbol index and duration of the x^{th} scheduled PSSCH, which can be set to appropriate values so as to support contiguous PSSCHs. For example, the starting symbol of the x^{th} scheduled PSSCH can immediately follow the ending symbol of the (x−1)^{th} scheduled PSSCH so as to ensure time contiguous scheduling.
The startSymbolAndLength_x, which indicates the starting symbol index and duration of the x^{th} scheduled PSSCH, can be set to appropriate values so as to support non-contiguous PSSCHs. For example, the starting symbol of the x^{th} scheduled PSSCH does not necessarily follow the ending symbol of the (x−1)^{th} scheduled PSSCH so as to achieve non-contiguous time scheduling.

The following are some example TDRA patterns which can support M PSSCHs scheduled by a single SCI.

Example 1 supports contiguous or non-contiguous PSSCHs in different slots and with different lengths:

```
PSSCH-TimeDomainResourceAllocation::= SEQUENCE
{
  k3_1 INTEGER(0..32),
  startSymbolAndLength_1 INTEGER (0..127),
  k3_2 INTEGER(0..32),
  startSymbolAndLength_2 INTEGER (0..127),
  ...
  k3_M INTEGER(0..32),
  startSymbolAndLength_M INTEGER (0..127)
    }
```

Example 1 provides full scheduling flexibility which supports a different number of scheduled PSSCHs in different contiguous or non-contiguous slots, different starting symbols and different lengths. A slot may carry one or more PSSCHs. The value of M indicates the number of scheduled PSSCHs. That is, the number of the start symbol and lengths indicates the number of scheduled PSSCHs. The k3_1 may not be necessary since the first scheduled slot may be the slot where the PSCCH is received.

Example 2 supports one starting slot (e.g., first scheduled slot) and different lengths:

```
PSSCH-TimeDomainResourceAllocation::= SEQUENCE
{
  startSymbolAndLength_1 INTEGER (0..127),
  startSymbolAndLength_2 INTEGER (0..127),
  ...
  startSymbolAndLength_M INTEGER (0..127)
    }
```

Example 2 can support a different number of PSSCHs scheduled in the same slot or in contiguous slots, different starting symbols and different lengths. The first scheduled slot is the slot where the PSCCH is received. The value of M indicates the number of scheduled PSSCHs. That is, the number of the start symbol and lengths indicates the number of scheduled PSSCHs.

Example 3 supports contiguous PSSCHs with the same length:

```
PSSCH-TimeDomainResourceAllocation::= SEQUENCE
{
    startSymbolAndLength_1 INTEGER (0..127),
    numberOfScheduledPSSCHs INTEGER (0..Maximum
  number of scheduled PSSCHs)
      }
```

The first scheduled slot is the slot where the PSCCH is received. The “startSymbolAndLength_1” indicates the starting symbol and length of the first scheduled PSSCH and “numberOfScheduledPSSCHs” indicates the number of scheduled PSSCHs with the same length as the first scheduled PSSCH. The “maximum number of scheduled PSSCHs” is the maximum number of PSSCHs scheduled by a single SCI, which can be configured by RRC signaling, predefined or preconfigured.

Example 3 can support a different number of PSSCHs scheduled in the same slot or in contiguous slots, different starting symbols and the same length.

Example 4 supports contiguous PSSCHs with at most two different lengths:

```
PSSCH-TimeDomainResourceAllocation::= SEQUENCE
{
    startSymbolAndLength INTEGER (0..127),
    numberOfTotalSymbols INTEGER (0...14*Maximum
  number of scheduled PSSCHs),
    numberOfScheduledPSSCHs INTEGER(0..Maximum
  number of scheduled PSSCHs
      }
```

The first scheduled slot is the slot where the PSCCH is received. The “startSymbolAndLength” indicates the starting symbol and length of the first scheduled PSSCH and “numberOfTotalSymbols” indicates the total length of the scheduled PSSCHs except the first scheduled PSSCH, which has the same length. The “numberOfScheduledPSSCHs” indicates the number of scheduled PSSCHs. The “Maximum number of scheduled PSSCHs” is the maximum number of PSSCHs scheduled by a single SCI, which can be configured by RRC signaling, predefined or preconfigured. The length of each of the scheduled PSSCHs except the first scheduled PSSCH can be determined by dividing the total length (indicated by “numberOfTotalSymbols”) by the number of scheduled PSSCHs minus 1.

Example 4 can support a different number of PSSCHs scheduled in the same slot or in contiguous slots with different starting symbols and at most two different lengths.

Example 5 supports contiguous or non-contiguous PSSCHs with the same length:

```
PSSCH-TimeDomainResourceAllocation::= SEQUENCE
{
    startSymbol_1 INTEGER(0..13),
    startSymbol_2 INTEGER(0..13),
    ...
    startSymbol_M INTEGER(0..13),
    length INTEGER(1...14)
  }
```

The first scheduled slot is the slot where the PSCCH is received. The “startSymbol_x” indicates the starting symbol of the x^{th} scheduled PSSCH and “length” indicates the length for each of the scheduled PSSCHs. The number of the startSymbol_x fields indicates the number of scheduled PSSCHs.

Example 5 can support a different number of PSSCHs scheduled in the same slot or in contiguous slots and with different starting symbols and the same length. The value of M indicates the number of scheduled PSSCHs, i.e., the number of start symbols indicates the number of scheduled PSSCHs.

Example 6 supports contiguous PSSCHs with the same or different lengths:

```
PSSCH-TimeDomainResourceAllocation::= SEQUENCE
{
    startSymbol_1 INTEGER(0..13),
    startSymbol_2 INTEGER(0..13),
    ...
    startSymbol_M INTEGER(0..13),
    length_M INTEGER(1...14)
  }
```

The first scheduled slot is the slot where the PSCCH is received. The “startSymbol_x” indicates the starting symbol of the x^{th} scheduled PSSCH. The offset between the startSymbol_x and the startSymbol_(x+1) determines the length of the x^{th} scheduled PSSCH. The “length_M” indicates the length for the last scheduled PSSCHs, i.e., the M^{th} PSSCH. Alternatively, the pattern may not include “length_M”, which suggests that the last scheduled PSSCH, i.e., the M^{th} PSSCH, does not cross the slot boundary.

Example 6 can support a different number of contiguous PSSCHs scheduled in the same slot and with different starting symbols and the same or different lengths. The value of M indicates the number of scheduled PSSCHs, i.e., the number of start symbols indicates the number of scheduled PSSCHs.

Example 7 supports contiguous or non-contiguous PSSCHs in contiguous or non-contiguous slots and with the same length:

```
PSSCH-TimeDomainResourceAllocation::= SEQUENCE
{
    k3_1 INTEGER(0..32),
    k3_2 INTEGER(0..32),
    ...
    k3_M INTEGER(0..32),
    startSymbolAndLength INTEGER (0..127)
  }
```

The “k3_x” indicates the slot level offset for the x^{th} scheduled PSSCH and “startSymbolAndLength” indicates the starting symbol and length for each of the scheduled PSSCHs. The k3_1 may not be necessary since the first scheduled slot may be the slot where the PSCCH is received. The value of M indicates the number of scheduled PSSCHs, i.e., the number of slot level offsets indicates the number of scheduled PSSCHs.

Example 7 can support a different number of PSSCHs scheduled in contiguous or non-contiguous slots and with the same starting symbol and the same length. Alternatively, “startSymbolAndLength” can indicate the starting symbol for the first scheduled PSSCH and length for the last scheduled PSSCH. In this scenario, the scheduled PSSCHs are contiguous in the time domain and can have the same or different starting symbols and the same or different lengths.

Example 8 supports contiguous PSSCHs with the same or different lengths:

```
PSSCH-TimeDomainResourceAllocation::= SEQUENCE
{
    startSymbolAndLength INTEGER (0..127),
    numberOfScheduledPSSCHs INTEGER(0..Maximum
  number of scheduled PSSCHs)
}
```

The first scheduled slot is the slot where the PSCCH is received. The “startSymbolAndLength” indicates both the starting symbol of the first scheduled PSSCH and the ending symbol of the last scheduled PSSCH (e.g., s_symbol #1 and e_symbol #1). “numberOfScheduledPSSCHs” indicates the number of scheduled PSSCHs. The “Maximum number of scheduled PSSCHs” is the maximum number of PSSCHs scheduled by a single SCI, which can be configured by RRC signaling, predefined, or preconfigured.

Example 9 supports contiguous PSSCHs with the same or different lengths:

```
PSSCH-TimeDomainResourceAllocation::= SEQUENCE
{
    startSymbolAndLength INTEGER (0..127),
    numberOfScheduledPSSCHs INTEGER(0..Maximum
  number of scheduled PSSCHs)
}
```

The first scheduled slot is the slot where the PSCCH is received. The “startSymbolAndLength” indicates both the starting symbol of the first scheduled PSSCH and the number of symbols of the last scheduled PSSCH (e.g., s_symbol #1 and N_{symbol #}1). The “numberOfScheduledPSSCHs” indicates the number of scheduled PSSCHs. The “Maximum number of scheduled PSSCHs” is the maximum number of PSSCHs scheduled by a single SCI, which can be configured by RRC signaling, predefined or preconfigured.

Example 10 supports contiguous PSSCHs with the same or different lengths:

```
PSSCH-TimeDomainResourceAllocation::= SEQUENCE
{
    ending symbol index of last PSSCH INTEGER (0..13),
    numberOfScheduledPSSCHs INTEGER(0..Maximum
  number of scheduled PSSCHs)
}
```

The first scheduled slot is the slot where the PSCCH is received. The “ending symbol index of last PSSCH” indicates the ending symbol of the last scheduled PSSCH (e.g., e_symbol #1). The “numberOfScheduledPSSCHs” indicates the number of scheduled PSSCHs. The “Maximum number of scheduled PSSCHs” is the maximum number of PSSCHs scheduled by a single SCI, which can be configured by RRC signaling, predefined or preconfigured.

Example 11 supports contiguous PSSCHs with the same or different lengths:

```
PSSCH-TimeDomainResourceAllocation::= SEQUENCE
{
  starting symbol index of first PSSCH INTEGER
(0...13),
  ending symbol index of last PSSCH INTEGER (0..13),
  numberOfScheduledPSSCHs INTEGER(0..Maximum
number of scheduled PSSCHs)
}
```

The first scheduled slot is the slot where the PSCCH is received. The “starting symbol index of first PSSCH” indicates the starting symbol of the first scheduled PSSCH (e.g., s_symbol #1), and “ending symbol index of last PSSCH” indicates the ending symbol of the last scheduled PSSCH (e.g., e_symbol #1). The “numberOfScheduledPSSCHs” indicates the number of scheduled PSSCHs. The “Maximum number of scheduled PSSCHs” is the maximum number of PSSCHs scheduled by a single SCI, which can be configured by RRC signaling, predefined or preconfigured.

Example 12 supports contiguous or non-contiguous PSSCHs in contiguous slots and with the same or different lengths:

```
PSSCH-TimeDomainResourceAllocation::= SEQUENCE
{
  startingSymbol_1 INTEGER (0...13),
  endingSymbol_1 INTEGER (0..13),
  startingSymbol_2 INTEGER (0...13),
  endingSymbol_2 INTEGER (0..13),
...
  startingSymbol_M INTEGER (0...13),
  endingSymbol_M INTEGER (0..13),
}
```

The first scheduled slot is the slot where the PSCCH is received. The “startingSymbol_x” indicates the starting symbol of the x^{th} scheduled PSSCH, and “endingSymbol_x” indicates the ending symbol of the x^{th} scheduled PSSCH. The value of M indicates the number of scheduled PSSCHs, i.e., the number of starting symbol indices or ending symbol indices indicates the number of scheduled PSSCHs.

It should be noted that the above examples are only for illustrative purpose. Persons skilled in the art can easily conceive various TDRA patterns based on the disclosure of the present disclosure including, for example, the design principle for a TDRA pattern.

In some embodiments of the present disclosure, an information element (IE) of PSSCH-TimeDomainResourceAllocationList can include one or multiple PSSCH-TimeDomainResourceAllocations. Assuming that a maximum of 16 PSSCH-TimeDomainResourceAllocations can be included in the list of PSSCH-TimeDomainResourceAllocations, then indicator #1 in an SCI can be defined in below table as one example:

TABLE 1
Mapping table for TDRA indication

| Code point | |
|---|---|
| value | Indicated TDRA pattern of the list |
| 0 | The first PSSCH-TimeDomainResourceAllocation |
| 1 | The second PSSCH-TimeDomainResourceAllocation |
| 2 | The third PSSCH-TimeDomainResourceAllocation |
| 3 | The fourth PSSCH-TimeDomainResourceAllocation |
| 4 | The fifth PSSCH-TimeDomainResourceAllocation |
| 5 | The sixth PSSCH-TimeDomainResourceAllocation |
| 6 | The seventh PSSCH-TimeDomainResourceAllocation |
| 7 | The eighth PSSCH-TimeDomainResourceAllocation |
| 8 | The ninth PSSCH-TimeDomainResourceAllocation |
| 9 | The tenth PSSCH-TimeDomainResourceAllocation |
| 10 | The eleventh PSSCH-TimeDomainResourceAllocation |
| 11 | The twelfth PSSCH-TimeDomainResourceAllocation |
| 12 | The thirteenth PSSCH-TimeDomainResourceAllocation |
| 13 | The fourteenth PSSCH-TimeDomainResourceAllocation |
| 14 | The fifteenth PSSCH-TimeDomainResourceAllocation |
| 15 | The sixteenth PSSCH-TimeDomainResourceAllocation |

It should be understood that Table 1 is only for illustrative purposes, and should not be construed as limiting the embodiments of the present disclosure. By the predefined PSSCH-TimeDomainResourceAllocation in the list, a BS or a UE can dynamically and flexibly indicate the number of scheduled PSSCHs, and the time domain resource allocation for each scheduled PSSCH by means of pointing the field of the time domain resource assignment (e.g., indicator #1) to the corresponding code point.

From the perspective a Tx UE, it may transmit an SCI for scheduling at least one PSSCH on at least one slot. As described above, the SCI may include indicator #1 indicating at least one time domain resource for the at least one PSSCH in the at least one slot. The Tx UE may then transmit the at least one PSSCH on the at least one time domain resource.

From the perspective an Rx UE, it may receive the SCI for scheduling at least one PSSCH on at least one slot. The Rx UE may determine the at least one time domain resource for the at least one PSSCH based on indicator #1 in the SCI, and may receive the at least one PSSCH on the at least one time domain resource.

In some embodiments of the present disclosure, the at least one PSSCH scheduled by the SCI may be from a plurality of PSSCHs scheduled by a DCI. For example, the Tx UE may receive the DCI for scheduling the plurality of PSSCHs on a plurality of slots. The DCI may include a TDRA indicator (denoted as indicator #2) indicating a plurality of time domain resources in the plurality of slots, and each of the plurality of time domain resources corresponds to one of the plurality of PSSCHs. The plurality of slots may include the at least one slot. The plurality of time domain resources may include the at least one time domain resource. The Tx UE may determine indicator #1 as described above based on indicator #2.

In some embodiments, after receiving the DCI, the plurality of PSSCHs may be scheduled by a single SCI. For example, the at least one PSSCH scheduled by the SCI as described above may include the plurality of PSSCHs. The scheduling SCI (e.g., the PSCCH or the 1^{st} stage SCI) may be transmitted in the first scheduled slot of the plurality of slots.

In some embodiments, after receiving the DCI, the plurality of PSSCHs may be scheduled a plurality of SCIs. For example, each PSSCH of the plurality of PSSCHs may be scheduled by a separate SCI, wherein the scheduling SCI and the scheduled PSSCH may be transmitted in the same slot. For example, the at least one PSSCH scheduled by the SCI as described above may include only a single PSSCH.

In some embodiments of the present disclosure, indicator #2 may include two fields (denoted as field #1A′ and field #2A′).

In some embodiments of the present disclosure, field #1A′ may indicate the starting symbol (denoted as s_symbol #1′) of the first scheduled PSSCH of the plurality of PSSCHs and the ending symbol (denoted as e_symbol #1′) of the last scheduled PSSCH of the plurality of PSSCHs. In some embodiments, field #1A′ may indicate the starting symbol (denoted as s_symbol #2′) of the first scheduled slot of the plurality of slots and the ending symbol (denoted as e_symbol #2′) of the last scheduled slot of the plurality of slots. In some embodiments, field #1A′ may indicate the starting symbol (e.g., s_symbol #1′) of the first scheduled PSSCH of the plurality of PSSCHs and the ending symbol (e.g., e_symbol #2′) of the last scheduled slot of the plurality of slots. In some embodiments, field #1A′ may indicate the starting symbol (e.g., s_symbol #2′) of the first scheduled slot of the plurality of slots and the ending symbol (e.g., e_symbol #1′) of the last scheduled PSSCH of the plurality of PSSCHs.

In some embodiments, field #2A′ may indicate the number of the plurality of PSSCHs, the number of the plurality of slots, the number of the plurality of PSSCHs minus two (e.g., the number of the middle PSSCH(s)), or the number of the plurality of slots minus two (e.g., the number of the middle slot(s)).

In the above embodiments, all symbols of the second slot to the last but one slot of the plurality of slots may be used for PSSCH transmission. Put another way, although the first scheduled PSSCH or the first scheduled slot may not be started from the initial symbol of a slot (e.g., symbol 0), or the last scheduled PSSCH or the last scheduled slot may not be ended at the last symbol of a slot (e.g., symbol 13), a full slot is assigned for the middle slot(s) of the plurality of slots.

In some embodiments, field #1A′ may indicate a SLIV indicating a starting symbol index (denoted as x) and a number of symbols (denoted as L). The starting symbol index may correspond to s_symbol #1′ or s_symbol #2′. e_symbol #1′ or e_symbol #2′ may be determined based on s_symbol #1′ or s_symbol #2′ and L.

For example, assuming that a slot includes 14 symbols indexed from 0 to 13, for a SLIV jointly indicating a starting symbol index (e.g., x) and a number of symbols (e.g., L), the starting symbol index x may be reinterpreted as the index of s_symbol #1′ or s_symbol #2′, and the index of e_symbol #1′ or e_symbol #2′ (denoted as index y) may be determined by y=x+L−1.

For example, referring back to FIG. 3, a DCI may schedule four PSSCHs (e.g., PSSCHs 311-317) in four slots (e.g., slots n to n+3). In some examples, the first scheduled slot or the first scheduled PSSCH may not start from the initial symbol (e.g., symbol 0) and may start from symbol x. Field #1A′ of the DCI may indicate the values of x and L. The index of e_symbol #1′ or e_symbol #2′ can be determined according to y=x+L−1.

In some embodiments, field #1A′ may indicate the SLIV from a set of SLIVs. The set of SLIVs may be configured by RRC signaling, predefined in a standard(s), or preconfigured during the UE implementation.

In some embodiments, in the case that the plurality of PSSCHs is scheduled by a single SCI, the SCI may be carried on a PSCCH in the first scheduled slot of the plurality of slots. In the case that the PSCCH and the first scheduled PSSCH of the plurality of PSSCHs are purely TDMed, the starting symbol of the first scheduled PSSCH may immediately follow an ending symbol of the PSCCH; otherwise, for example, in the case that the PSCCH and the first scheduled PSSCH of the plurality of PSSCHs are FDMed and TDMed, the starting symbol of the first scheduled PSSCH may be the same as that of the PSCCH.

In some embodiments, in the case that each of the plurality of PSSCHs is scheduled by a different SCI, each SCI may be carried on a PSCCH, which is transmitted in the same slot as the PSSCH scheduled by the SCI. In the case that the PSCCH and the associated PSSCH are purely TDMed, the starting symbol of the associated PSSCH may immediately follow an ending symbol of the PSCCH; otherwise, for example, in the case that the PSCCH and the associated PSSCH are FDMed and TDMed, the starting symbol of the associated PSSCH may be the same as that of the PSCCH.

In some embodiments, one or more PSSCHs of the plurality of PSSCHs may be transmitted in a single slot of the plurality of slots. For example, a single slot may be used for transmitting at most one PSSCH, and then the number of scheduled PSSCHs is equal to the number of scheduled slots. For example, a single slot may be used for transmitting two or more PSSCHs, and then the number of scheduled PSSCHs may be larger than the number of scheduled slots.

In some embodiments, the number of required bits for indicating field #2A′ may be dependent on the maximum number of PSSCHs or the maximum number of slots schedulable by a single DCI, which can be, for example, configured by RRC signaling or predefined in a standard(s).

In some examples, assuming that a maximum of N PSSCHs or slots can be scheduled by a single DCI, then at least ┌log₂ N┐ bits may be required for field #2A′ for indicating the number of actually scheduled number of PSSCHs or slots (e.g., the number of the plurality of PSSCHs or the number of the plurality of slots as described above). For example, assuming that a maximum of 4 PSSCHs or slots can be scheduled by a single DCI, then at least 2 bits in a DCI are required to indicate that 1, 2, 3, or 4 PSSCHs or slots are scheduled.

In some examples, at least ┌log₂ (N−2)┐ bits may be required for field #2A′ for indicating the number of the middle PSSCH(s) or slot(s) of the actually scheduled PSSCHs or slots. Then, the number of actually scheduled PSSCH(s) or slot(s) is equal to the number of middle PSSCH(s) or slot(s) plus the applicable starting PSSCH or slot (if any) plus the applicable ending PSSCH or slot (if any). This is achievable because the first and the last scheduled PSSCHs or slots are indicated by field #1A′. The middle slot(s) indicated by field #2A′ is a full slot(s) and the first or the last scheduled slot (if any) may be fully or partially scheduled in these examples. For example, assuming that a maximum of 4 PSSCHs or slots can be scheduled by a single DCI, then at least 1 bit in a DCI is required to indicate that 1, 2, 3, or 4 PSSCHs or slots are scheduled.

It should be noted that indicator #2 as described in the above embodiments can be applied to either the case where a single DCI schedules a single slot or a single PSSCH or the case where a single DCI schedules a plurality of slots or PSSCHs. For example, in the case that a DCI schedules a single PSSCH or a single slot, field #2A′ may indicate that a single PSSCH or slot is scheduled and the SLIV indicated by field #1A′ may be reinterpreted as the starting symbol index and the duration of the single scheduled PSSCH or the single scheduled slot.

For example, referring back to FIG. 3A, a DCI may schedule a single PSSCH (e.g., PSSCH 321) in a single slot (e.g., slot n). Field #1A′ of the DCI may indicate the starting symbol index (e.g., x) and the number of symbols (e.g., L) of the single PSSCH. The index y of the ending symbol of the single PSSCH can be determined according to y=x+L−1.

In some embodiments of the present disclosure, field #1A′ may indicate the starting symbol (e.g., s_symbol #1′) of the first scheduled PSSCH of the plurality of PSSCHs and the number of symbols (denoted as N_{symbol #}1′) of the last scheduled PSSCH of the plurality of PSSCHs. In some embodiments, field #1A′ may indicate the starting symbol (e.g., s_symbol #2′) of the first scheduled slot of the plurality of slots and the number of symbols (denoted as N_{symbol #}2′) of the last scheduled slot of the plurality of slots. In some embodiments, field #1A′ may indicate the starting symbol (e.g., s_symbol #1′) of the first scheduled PSSCH of the plurality of PSSCHs and the number of symbols (e.g., N_{symbol #}2′) of the last scheduled slot of the plurality of slots. In some embodiments, field #1A′ may indicate the starting symbol (e.g., s_symbol #2′) of the first scheduled slot of the plurality of slots and the number of symbols (e.g., N_{symbol #}1′) of the last scheduled PSSCH of the plurality of PSSCHs.

In some embodiments, field #2A′ may indicate the number of the plurality of PSSCHs, the number of the plurality of slots, the number of the plurality of PSSCHs minus two (e.g., the number of the middle PSSCH(s)), or the number of the plurality of slots minus two (e.g., the number of the middle slot(s)).

In the above embodiments, all symbols of the second slot to the last but one slot of the plurality of slots may be used for PSSCH transmission. Put another way, although the first scheduled PSSCH or the first scheduled slot may not be started from the initial symbol of a slot (e.g., symbol 0), or the last scheduled PSSCH or the last scheduled slot may not be ended at the last symbol of a slot (e.g., symbol 13), a full slot is assigned for the middle slot(s) of the plurality of slots.

In some embodiments, field #1A′ may indicate a SLIV indicating a starting symbol index (e.g., x) and a number of symbols (e.g., L). The starting symbol index may correspond to s_symbol #1′ or s_symbol #2′. The number of symbols may correspond to N_{symbol #}1′ or N_{symbol #}2′.

For example, assuming that a slot includes 14 symbols indexed from 0 to 13, for a SLIV jointly indicating a starting symbol index (e.g., x) and a number of symbols (e.g., L), the starting symbol index x may be reinterpreted as the index of s_symbol #1′ or s_symbol #2′, and the index of e_symbol #1′ or e_symbol #2′ (e.g., y) may be determined by y=L−1.

For example, referring back to FIG. 4, a DCI may schedule four PSSCHs (e.g., PSSCHs 411-417) in four slots (e.g., slots n to n+3). In some examples, the first scheduled slot or the first scheduled PSSCH may not start from the initial symbol (e.g., symbol 0) and may start from symbol x. Field #1A′ of the DCI may indicate the values of x and L as shown in FIG. 4. The index y of the ending symbol of the last scheduled slot or last scheduled PSSCH can be determined according to y=L−1.

In some embodiments, field #1A′ may indicate the SLIV from a set of SLIVs. The set of SLIVs may be configured by RRC signaling, predefined in a standard(s), or preconfigured during the UE implementation.

In some embodiments, in the case that the plurality of PSSCHs is scheduled by a single SCI, the SCI may be carried on a PSCCH in the first scheduled slot of the plurality of slots. In the case that the PSCCH and the first scheduled PSSCH of the plurality of PSSCHs are purely TDMed, the starting symbol of the first scheduled PSSCH may immediately follow an ending symbol of the PSCCH; otherwise, for example, in the case that the PSCCH and the first scheduled PSSCH of the plurality of PSSCHs are FDMed and TDMed, the starting symbol of the first scheduled PSSCH may be the same as that of the PSCCH.

In some embodiments, in the case that each of the plurality of PSSCHs is scheduled by a different SCI, each SCI may be carried on a PSCCH, which is transmitted in the same slot as the PSSCH scheduled by the SCI. In the case that the PSCCH and the associated PSSCH are purely TDMed, the starting symbol of the associated PSSCH may immediately follow an ending symbol of the PSCCH; otherwise, for example, in the case that the PSCCH and the associated PSSCH are FDMed and TDMed, the starting symbol of the associated PSSCH may be the same as that of the PSCCH.

In some embodiments, one or more PSSCHs of the plurality of PSSCHs may be transmitted in a single slot of the plurality of slots. For example, a single slot may be used for transmitting at most one PSSCH, and then the number of scheduled PSSCHs is equal to the number of scheduled slots. For example, a single slot may be used for transmitting two or more PSSCHs, and then the number of scheduled PSSCHs may be larger than the number of scheduled slots.

In some embodiments, the number of required bits for indicating field #2A′ may be dependent on the maximum number of PSSCHs or the maximum number of slots schedulable by a single DCI, which can be, for example, configured by RRC signaling or predefined in a standard(s).

In some examples, assuming that a maximum of N PSSCHs or slots can be scheduled by a single DCI, then at least ┌log₂ N┐ bits may be required for field #2A′ for indicating the number of actually scheduled number of PSSCHs or slots (e.g., the number of the plurality of PSSCHs or the number of the plurality of slots as described above). For example, assuming that a maximum of 4 PSSCHs or slots can be scheduled by a single DCI, then at least 2 bits in a DCI may be required to indicate that 1, 2, 3, or 4 PSSCHs or slots are scheduled.

In some examples, at least ┌log₂ (N−2)┐ bits may be required for field #2A′ for indicating the number of the middle PSSCH(s) or slot(s) of the actually scheduled PSSCHs or slots. Then, the number of actually scheduled PSSCH(s) or slot(s) is equal to the number of middle PSSCH(s) or slot(s) plus the applicable starting PSSCH or slot (if any) plus the applicable ending PSSCH or slot (if any). The middle slot(s) indicated by field #2A′ is a full slot(s) and the first or the last scheduled slot (if any) may be fully or partially scheduled in these examples. This is achievable because the first and the last scheduled PSSCHs or slots are indicated by field #1A′. For example, assuming that a maximum of 4 PSSCHs or slots can be scheduled by a single DCI, then at least 1 bit in a DCI may be required to indicate that 1, 2, 3, or 4 PSSCHs or slots are scheduled.

It should be noted that indicator #2 as described in the above embodiments can be applied to either the case where a single DCI schedules a single slot or a single PSSCH or the case where a single DCI schedules a plurality of slots or PSSCHs. For example, in the case that a DCI schedules a single PSSCH or a single slot, field #2A′ may indicate that a single PSSCH or slot is scheduled and the SLIV indicated by field #1A′ may be reinterpreted as the starting symbol index and the duration of the single scheduled PSSCH or the single scheduled slot.

For example, referring back to FIG. 4A, a DCI may schedule a single PSSCH (e.g., PSSCH 421) in a single slot (e.g., slot n). Field #1A′ of the DCI may indicate the starting symbol index (e.g., x) and the number of symbols (e.g., L) of the single PSSCH. The index y of the ending symbol of the single PSSCH can be determined according to y=x+L−1.

In some embodiments of the present disclosure, field #1A′ may indicate the ending symbol (e.g., e_symbol #1′) of the last scheduled PSSCH of the plurality of PSSCHs, the ending symbol (e.g., e_symbol #2′) of the last scheduled slot of the plurality of slots, the number of symbols (e.g., N_{symbol #}1′) of the last scheduled PSSCH of the plurality of PSSCHs, or the number of symbols (e.g., N_{symbol #}2′) of the last scheduled slot of the plurality of slots.

In these embodiments, in the case that the plurality of PSSCHs is scheduled by a single SCI, the starting symbol of the first scheduled PSSCH of the plurality of PSSCHs may be determined based on the PSCCH carrying the scheduling SCI. The PSCCH may be transmitted in the first scheduled slot of the plurality of slots. For example, in the case that the PSCCH and the first scheduled PSSCH of the plurality of PSSCHs are purely TDMed, the starting symbol of the first scheduled PSSCH may immediately follow an ending symbol of the PSCCH; otherwise, for example, in the case that the PSCCH and the first scheduled PSSCH of the plurality of PSSCHs are FDMed and TDMed, the starting symbol of the first scheduled PSSCH may be the same as that of the PSCCH.

In some embodiments, in the case that each of the plurality of PSSCHs is scheduled by a different SCI, the starting symbol of each scheduled PSSCH of the plurality of PSSCHs may be determined based on the corresponding PSCCH carrying the scheduling SCI. The corresponding PSCCH may be transmitted in the same slot as the PSSCH scheduled by the SCI. In the case that the PSCCH and the associated PSSCH are purely TDMed, the starting symbol of the associated PSSCH may immediately follow an ending symbol of the PSCCH; otherwise, for example, in the case that the PSCCH and the associated PSSCH are FDMed and TDMed, the starting symbol of the associated PSSCH may be the same as that of the PSCCH.

In some embodiments, field #2A′ may indicate the number of the plurality of PSSCHs, the number of the plurality of slots, the number of the plurality of PSSCHs minus two (e.g., the number of the middle PSSCH(s)), or the number of the plurality of slots minus two (e.g., the number of the middle slot(s)).

In the above embodiments, all symbols of the second slot to the last but one slot of the plurality of slots may be used for PSSCH transmission. Put another way, although the first scheduled PSSCH or the first scheduled slot may not be started from the initial symbol of a slot (e.g., symbol 0), or the last scheduled PSSCH or the last scheduled slot may not be ended at the last symbol of a slot (e.g., symbol 13), a full slot is assigned for the middle slot(s) of the plurality of slots.

For example, referring back to FIG. 5, a DCI may schedule four PSSCHs (e.g., PSSCHs 511-517) in four slots (e.g., slots n to n+3). In some examples, the first scheduled slot or the first scheduled PSSCH may not start from the initial symbol (e.g., symbol 0). In some examples, as shown in FIG. 5, after receiving the DCI, a UE may transmit, to another UE, PSCCH 521. PSCCH 521 is FDMed and TDMed with the first scheduled PSSCH (e.g., PSSCH 511), and carries an SCI (or a 1^{st}-stage SCI). s_symbol #1′ or s_symbol #2′ can be determined based on the location of PSCCH 521. In some examples, e_symbol #1′ or e_symbol #2′ can be indicated by field #1A′ of the DCI. For example, in the case that field #1A′ of the DCI indicates N_{symbol #}2′, the index y of the ending symbol can be determined according to y=N_{symbol #}2′−1.

In some embodiments, field #1A′ may indicate e_symbol #1′ or e_symbol #2′ from a set of ending positions (e.g., ending symbol indexes), which may be configured by RRC signaling, predefined in a standard(s), or preconfigured during the UE implementation. In some embodiments, field #1A′ may indicate N_{symbol #}1′ or N_{symbol #}2′ from a set of symbol numbers, which may be configured by radio resource control (RRC) signaling, predefined in a standard(s), or preconfigured during the UE implementation. The size of field #1A′ (e.g., the bits required for field #1A′ in the DCI) may be based on a size of the set of ending positions or a size of the set of symbol numbers (e.g., the number of values in the set).

For example, it is assumed that a slot includes 14 symbols indexed from 0 to 13. A set of ending symbol indexes may include symbol 13, symbol 12, symbol 9, symbol 6, etc. When symbol 13 is indicated, it may imply that the last PSSCH is transmitted till the end of the last scheduled slot. When symbol 12 is indicated, it may imply that the last PSSCH is transmitted till symbol 12 of the last scheduled slot. Symbol 13 of the last scheduled slot may be reserved as one symbol gap. When symbol 9 is indicated, it may imply that the last PSSCH is transmitted till symbol 9 of the last scheduled slot. One PSFCH transmission occasion may be reserved in the last scheduled slot, where symbol 10 and symbol 13 may be two gap symbols surrounding the PSFCH transmission occasion. When symbol 6 is indicated, it may imply that the last PSSCH is transmitted till symbol 6 of the last scheduled slot. Two PSFCH transmission occasions may be reserved in the last scheduled slot, where symbol 7, symbol 10 and symbol 13 may be three gap symbols surrounding the two PSFCH transmission occasions.

In some embodiments, one or more PSSCHs of the plurality of PSSCHs may be transmitted in a single slot of the plurality of slots. For example, a single slot may be used for transmitting at most one PSSCH, and then the number of scheduled PSSCHs is equal to the number of scheduled slots. For example, a single slot may be used for transmitting two or more PSSCHs, and then the number of scheduled PSSCHs may be larger than the number of scheduled slots.

In some embodiments, the number of required bits for indicating field #2A′ may be dependent on the maximum number of PSSCHs or the maximum number of slots schedulable by a single DCI, which can be, for example, configured by RRC signaling or predefined in a standard(s).

In some examples, assuming that a maximum of N PSSCHs or slots can be scheduled by a single DCI, then at least ┌log₂ N┐ bits may be required for field #2A′ for indicating the number of actually scheduled number of PSSCHs or slots (e.g., the number of the plurality of PSSCHs or the number of the plurality of slots as described above). For example, assuming that a maximum of 4 PSSCHs or slots can be scheduled by a single DCI, then at least 2 bits in a DCI are required to indicate that 1, 2, 3, or 4 PSSCHs or slots are scheduled.

In some examples, at least ┌log₂ (N−2)┐ bits may be required for field #2A′ for indicating the number of the middle PSSCH(s) or slot(s) of the actually scheduled PSSCHs or slots. Then, the number of actually scheduled PSSCH(s) or slot(s) is equal to the number of middle PSSCH(s) or slot(s) plus the applicable starting PSSCH or slot (if any) plus the applicable ending PSSCH or slot (if any). The middle slot(s) indicated by field #2A′ is a full slot(s) and the first or the last scheduled slot (if any) may be fully or partially scheduled in these examples. This is achievable because the first and the last scheduled PSSCHs or slots are indicated by field #1A′. For example, assuming that a maximum of 4 PSSCHs or slots can be scheduled by a single DCI, then at least 1 bit in a DCI is required to indicate that 1, 2, 3, or 4 PSSCHs or slots are scheduled.

It should be noted that indicator #2 as described in the above embodiments can be applied to either the case where a single DCI schedules a single slot or a single PSSCH or the case where a single DCI schedules a plurality of slots or PSSCHs. For example, in the case that a DCI schedules a single PSSCH or a single slot, field #2A′ may indicate that a single PSSCH or slot is scheduled and field #1A′ may indicate the ending symbol of the single scheduled PSSCH or slot.

In some embodiments of the present disclosure, field #1A′ may indicate the starting symbol (e.g., s_symbol #1′) of the first scheduled PSSCH of the plurality of PSSCHs or the starting symbol (e.g., s_symbol #2′) of the first scheduled slot of the plurality of slots. In some embodiments, field #2A′ may indicate the total number (denoted as Z′) of symbols for the plurality of PSSCHs. Alternatively, field #2A′ may indicate the total number of symbols for the plurality of PSSCHs excluding the number of symbols of the first scheduled PSSCH or the first slot of the plurality of PSSCHs.

In some embodiments, in the case that the plurality of PSSCHs is scheduled by a single SCI, the SCI may be carried on a PSCCH in the first scheduled slot of the plurality of slots. In the case that the PSCCH and the first scheduled PSSCH of the plurality of PSSCHs are purely TDMed, the starting symbol of the first scheduled PSSCH may immediately follow an ending symbol of the PSCCH; otherwise, for example, in the case that the PSCCH and the first scheduled PSSCH of the plurality of PSSCHs are FDMed and TDMed, the starting symbol of the first scheduled PSSCH may be the same as that of the PSCCH.

In some embodiments, in the case that each of the plurality of PSSCHs is scheduled by a different SCI, each SCI may be carried on a PSCCH, which is transmitted in the same slot as the PSSCH scheduled by the SCI. In the case that the PSCCH and the associated PSSCH are purely TDMed, the starting symbol of the associated PSSCH may immediately follow an ending symbol of the PSCCH; otherwise, for example, in the case that the PSCCH and the associated PSSCH are FDMed and TDMed, the starting symbol of the associated PSSCH may be the same as that of the PSCCH.

In the above embodiments, all symbols of the second slot to the last but one slot of the plurality of slots may be used for PSSCH transmission. Put another way, although the first scheduled PSSCH or the first scheduled slot may not be started from the initial symbol of a slot (e.g., symbol 0), or the last scheduled PSSCH or the last scheduled slot may not be ended at the last symbol of a slot (e.g., symbol 13), a full slot is assigned for the middle slot(s) of the plurality of slots.

In the above embodiments, the ending symbol (e.g., e_symbol #1′) of the last scheduled PSSCH of the plurality of PSSCHs or the ending symbol (e.g., e_symbol #2′) of the last scheduled slot of the plurality of slots may be determined based on field #1A′ and field #2A′ (e.g., s_symbol #1′ or s_symbol #2′ and Z′).

For example, it is assumed that a slot includes 14 symbols indexed from 0 to 13. Assuming that field #2A′ indicates that a total of 45 symbols for the at least one scheduled PSSCH and field #1A′ indicates that the starting symbol of the first scheduled PSSCH or slot is symbol 7, then the first scheduled PSSCH occupies 7 symbols from symbol 7 to symbol 13 in the first scheduled slot; the second scheduled PSSCH occupies 14 symbols from symbol 0 to symbol 13 in the second scheduled slot; the third scheduled PSSCH occupies 14 symbols from symbol 0 to symbol 13 in the third scheduled slot; and the last scheduled PSSCH occupies 10 symbols from symbol 0 to symbol 9 in the last scheduled slot.

In some embodiments, field #1A′ may indicate s_symbol #1′ or s_symbol #2′ from a set of starting positions (e.g., starting symbol indexes), which may be configured by RRC signaling, predefined in a standard(s), or preconfigured during the UE implementation. For example, a set of starting symbol indexes may include symbol 0, symbol 1, symbol 7, symbol 8, etc. The size of field #1A′ (e.g., the bits required for field #1A′ in the DCI) may be based on a size of the set of starting positions (e.g., the number of values in the set).

In some embodiments, the size of field #2A′ may be based on the maximum number of slots schedulable by the DCI. For example, assuming that the maximum number of slots which can be scheduled by a single DCI is N and a slot includes 14 symbols, the maximum number of symbols schedulable by a single DCI is equal to 14*N. To achieve full flexibility of the multi-PSSCH scheduling by a single DCI, field #2A′ may require at least ┌log₂ 14*N┐ bits for indicating the maximum number of symbols. For example, assuming that a maximum of 4 slots can be scheduled by a single DCI, the maximum number of symbols is 4*14 and thus at least 6 bits are required for field #2A′.

In some embodiments, field #2A′ may indicate the value of Z′ from a set of total number of symbols, which may be configured by RRC signaling, predefined in a standard(s), or preconfigured during the UE implementation. The size of field #2A′ may be based on a size of the set of total number of symbols (e.g., the number of values in the set). In these embodiments, the number of bits for indicator #2 (e.g., field #2A′) can be reduced.

In some embodiments, one or more PSSCHs of the plurality of PSSCHs may be transmitted in a single slot of the plurality of slots. For example, a single slot may be used for transmitting at most one PSSCH, and then the number of scheduled PSSCHs is equal to the number of scheduled slots. For example, a single slot may be used for transmitting two or more PSSCHs, and then the number of scheduled PSSCHs may be larger than the number of scheduled slots.

It should be noted that indicator #2 as described in the above embodiments can be applied to either the case where a single DCI schedules a single slot or a single PSSCH or the case where a single DCI schedules a plurality of slots or PSSCHs.

In some embodiments of the present disclosure, indicator #2 may include a single field (denoted as field #1B′). Field #1B′ may indicate the total number (e.g., Z′) of symbols for the plurality of PSSCHs.

In the above embodiments, all symbols of the second slot to the last but one slot of the plurality of slots may be used for PSSCH transmission. Put another way, although the first scheduled PSSCH or the first scheduled slot may not be started from the initial symbol of a slot (e.g., symbol 0), or the last scheduled PSSCH or the last scheduled slot may not be ended at the last symbol of a slot (e.g., symbol 13), a full slot is assigned for the middle slot(s) of the plurality of slots.

In some embodiments, the size of field #1B′ may be based on the maximum number of slots schedulable by the DCI. For example, assuming that the maximum number of slots which can be scheduled by a single DCI is N and a slot includes 14 symbols, the maximum number of symbols schedulable by a single DCI is equal to 14*N. To achieve full flexibility of the multi-PSSCH scheduling by a single DCI, field #1B′ may require at least ┌log₂ 14*N┐ bits for indicating the maximum number of symbols. For example, assuming that a maximum of 4 slots can be scheduled by a single DCI, the maximum number of symbols is 4*14 and thus at least 6 bits are required for field #1B′, i.e., indicator #2.

In some embodiments, field #1B′ may indicate the value of Z′ from a set of total number of symbols, which may be configured by radio resource control (RRC) signaling, predefined in a standard(s), or preconfigured during the UE implementation. The size of field #1B′ (i.e., indicator #2) may be based on a size of the set of total number of symbols (e.g., the number of values in the set). In these embodiments, the number of bits for indicator #2 (i.e., field #1B′) can be reduced.

In these embodiments, in the case that the plurality of PSSCHs is scheduled by a single SCI, the starting symbol of the first scheduled PSSCH of the plurality of PSSCHs may be determined based on the PSCCH carrying the scheduling SCI. The PSCCH may be transmitted in the first scheduled slot of the plurality of slots. For example, in the case that the PSCCH and the first scheduled PSSCH of the plurality of PSSCHs are purely TDMed, the starting symbol of the first scheduled PSSCH may immediately follow an ending symbol of the PSCCH; otherwise, for example, in the case that the PSCCH and the first scheduled PSSCH of the plurality of PSSCHs are FDMed and TDMed, the starting symbol of the first scheduled PSSCH may be the same as that of the PSCCH.

In some embodiments, in the case that each of the plurality of PSSCHs is scheduled by a different SCI, the starting symbol of each scheduled PSSCH of the plurality of PSSCHs may be determined based on the corresponding PSCCH carrying the scheduling SCI. The corresponding PSCCH may be transmitted in the same slot as the PSSCH scheduled by the SCI. In the case that the PSCCH and the associated PSSCH are purely TDMed, the starting symbol of the associated PSSCH may immediately follow an ending symbol of the PSCCH; otherwise, for example, in the case that the PSCCH and the associated PSSCH are FDMed and TDMed, the starting symbol of the associated PSSCH may be the same as that of the PSCCH.

In the above embodiments, the ending symbol (e.g., e_symbol #1′) of the last scheduled PSSCH of the plurality of PSSCHs or the ending symbol (e.g., e_symbol #2′) of the last scheduled slot of the plurality of slots may be determined based on field #1B′ (e.g., Z′) and the starting symbol of the first scheduled PSSCH.

For example, it is assumed that a slot includes 14 symbols indexed from 0 to 13. Assuming that field #1B′ indicates that a total of 45 symbols for the at least one scheduled PSSCH and the starting symbol of the first scheduled PSSCH determined based on the associated PSCCH is symbol 7, then the first scheduled PSSCH occupies 7 symbols from symbol 7 to symbol 13 in the first scheduled slot; the second scheduled PSSCH occupies 14 symbols from symbol 0 to symbol 13 in the second scheduled slot; the third scheduled PSSCH occupies 14 symbols from symbol 0 to symbol 13 in the third scheduled slot; and the last scheduled PSSCH occupies 10 symbols from symbol 0 to symbol 9 in the last scheduled slot.

In some embodiments, one or more PSSCHs of the plurality of PSSCHs may be transmitted in a single slot of the plurality of slots. For example, a single slot may be used for transmitting at most one PSSCH, and then the number of scheduled PSSCHs is equal to the number of scheduled slots. For example, a single slot may be used for transmitting two or more PSSCHs, and then the number of scheduled PSSCHs may be larger than the number of scheduled slots.

It should be noted that indicator #2 as described in the above embodiments can be applied to either the case where a single DCI schedules a single slot or a single PSSCH or the case where a single DCI schedules a plurality of slots or PSSCHs.

In some embodiments of the present disclosure, indicator #2 may include three fields (denoted as field #1C′, field #2C′ and field #3C′).

In some embodiments of the present disclosure, field #1C′ may indicate the starting symbol (e.g., s_symbol #1′) of the first scheduled PSSCH of the plurality of PSSCHs or the starting symbol (e.g., s_symbol #2′) of the first scheduled slot of the plurality of slots. Field #2C′ may indicate the ending symbol (e.g., e_symbol #1′) of the last scheduled PSSCH of the plurality of PSSCHs or the ending symbol (denoted as e_symbol #2′) of the last scheduled slot of the plurality of slots.

In some embodiments, field #3C′ may indicate the number of the plurality of PSSCHs, the number of the plurality of slots, the number of the plurality of PSSCHs minus two (e.g., the number of the middle PSSCH(s)), or the number of the plurality of slots minus two (e.g., the number of the middle slot(s)).

In the above embodiments, all symbols of the second slot to the last but one slot of the plurality of slots may be used for PSSCH transmission. Put another way, although the first scheduled PSSCH or the first scheduled slot may not be started from the initial symbol of a slot (e.g., symbol 0), or the last scheduled PSSCH or the last scheduled slot may not be ended at the last symbol of a slot (e.g., symbol 13), a full slot is assigned for the middle slot(s) of the plurality of slots.

In some embodiments, field #1C′ may indicate s_symbol #1′ or s_symbol #2′ from a set of starting positions (e.g., starting symbol indexes), which may be configured by radio resource control (RRC) signaling, predefined in a standard(s), or preconfigured during the UE implementation. For example, a set of starting symbol indexes may include symbol 0, symbol 1, symbol 7, symbol 8, etc. The size of field #1C′ (e.g., the bits required for field #1C′ in the DCI) may be based on a size of the set of starting positions (e.g., the number of values in the set).

In some embodiments, field #2C′ may indicate e_symbol #1′ or e_symbol #2′ from a set of ending positions (e.g., ending symbol indexes), which may be configured by radio resource control (RRC) signaling, predefined in a standard(s), or preconfigured during the UE implementation. The size of field #2C′ (e.g., the bits required for field #2C′ in the DCI) may be based on a size of the set of ending positions (e.g., the number of values in the set).

For example, it is assumed that a slot includes 14 symbols indexed from 0 to 13. A set of ending symbol indexes may include symbol 13, symbol 12, symbol 9, symbol 6, etc. When symbol 13 is indicated, it may imply that the last PSSCH is transmitted till the end of the last scheduled slot. When symbol 12 is indicated, it may imply that the last PSSCH is transmitted till symbol 12 of the last scheduled slot. Symbol 13 of the last scheduled slot may be reserved as one symbol gap. When symbol 9 is indicated, it may imply that the last PSSCH is transmitted till symbol 9 of the last scheduled slot. One PSFCH transmission occasion may be reserved in the last scheduled slot, where symbol 10 and symbol 13 may be two gap symbols surrounding the PSFCH transmission occasion. When symbol 6 is indicated, it may imply that the last PSSCH is transmitted till symbol 6 of the last scheduled slot. Two PSFCH transmission occasions may be reserved in the last scheduled slot, where symbol 7, symbol 10 and symbol 13 may be three gap symbols surrounding the two PSFCH transmission occasions.

In some embodiments, field #2C′ may indicate N_{symbol #}1′ or N_{symbol #}2′ as described above. In some embodiments, field #2C′ may indicate N_{symbol #}1′ or N_{symbol #}2′ from a set of symbol numbers, which may be configured by RRC signaling, predefined in a standard(s), or preconfigured during the UE implementation. The size of field #2C′ may be based on a size of the set of symbol numbers (e.g., the number of values in the set).

In some embodiments, in the case that the plurality of PSSCHs is scheduled by a single SCI, the SCI may be carried on a PSCCH in the first scheduled slot of the plurality of slots. In the case that the PSCCH and the first scheduled PSSCH of the plurality of PSSCHs are purely TDMed, the starting symbol of the first scheduled PSSCH may immediately follow an ending symbol of the PSCCH; otherwise, for example, in the case that the PSCCH and the first scheduled PSSCH of the plurality of PSSCHs are FDMed and TDMed, the starting symbol of the first scheduled PSSCH may be the same as that of the PSCCH.

In some embodiments, in the case that each of the plurality of PSSCHs is scheduled by a different SCI, each SCI may be carried on a PSCCH, which is transmitted in the same slot as the PSSCH scheduled by the SCI. In the case that the PSCCH and the associated PSSCH are purely TDMed, the starting symbol of the associated PSSCH may immediately follow an ending symbol of the PSCCH; otherwise, for example, in the case that the PSCCH and the associated PSSCH are FDMed and TDMed, the starting symbol of the associated PSSCH may be the same as that of the PSCCH.

In some embodiments, one or more PSSCHs of the plurality of PSSCHs may be transmitted in a single slot of the plurality of slots. For example, a single slot may be used for transmitting at most one PSSCH, and then the number of scheduled PSSCHs is equal to the number of scheduled slots. For example, a single slot may be used for transmitting two or more PSSCHs, and then the number of scheduled PSSCHs may be larger than the number of scheduled slots.

In some embodiments, the number of required bits for indicating field #3C′ may be dependent on the maximum number of PSSCHs or the maximum number of slots schedulable by a single DCI, which can be, for example, configured by RRC signaling or predefined in a standard(s).

In some examples, assuming that a maximum of N PSSCHs or slots can be scheduled by a single DCI, then at least ┌log₂ N┐ bits may be required for field #3C′ for indicating the number of actually scheduled number of PSSCHs or slots (e.g., the number of the plurality of PSSCHs or the number of the plurality of slots as described above). For example, assuming that a maximum of 4 PSSCHs or slots can be scheduled by a single DCI, then at least 2 bits in a DCI are required to indicate that 1, 2, 3, or 4 PSSCHs or slots are scheduled.

In some examples, at least ┌log₂ (N−2)┐ bits may be required for field #3C′ for indicating the number of the middle PSSCH(s) or slot(s) of the actually scheduled PSSCHs or slots. Then, the number of actually scheduled PSSCH(s) or slot(s) is equal to the number of middle PSSCH(s) or slot(s) plus the applicable starting PSSCH or slot (if any) plus the applicable ending PSSCH or slot (if any). The middle slot(s) indicated by field #3C′ is a full slot(s) and the first or the last scheduled slot may be fully or partially scheduled in these examples. This is achievable because the first and the last scheduled PSSCHs or slots are indicated by fields #1C and #2C. For example, assuming that a maximum of 4 PSSCHs or slots can be scheduled by a single DCI, then at least 1 bit in a DCI is required to indicate that 1, 2, 3, or 4 PSSCHs or slots are scheduled.

In some embodiments, the above three fields may be jointly coded in the DCI. The field size may be dependent on the number of possible combinations.

It should be noted that indicator #2 as described in the above embodiments can be applied to either the case where a single DCI schedules a single slot or a single PSSCH or the case where a single DCI schedules a plurality of slots or PSSCHs.

In some embodiments of the present disclosure, indicator #2 may indicate a TDRA pattern for the at least one time domain resource for the plurality of PSSCHs.

In some embodiments, the indicated TDRA pattern may be from a list of TDRA patterns. The list of TDRA patterns may be configured by RRC signaling, predefined in a standard(s), or preconfigured. In some examples, each TDRA pattern in the list may include one or more SLIVs. One code point of indicator #2 in the DCI may indicate one TDRA pattern from the list. Dependent on the mapping relationship between the code point and the corresponding TDRA pattern, a single DCI can schedule a single PSSCH or more than one PSSCH in one slot, or schedule a plurality of PSSCHs in a plurality of contiguous or non-contiguous slots. A size of indicator #2 may be dependent on the size of the TDRA pattern list (e.g., the number of TDRA patterns in the list).

The design principles for a TDRA pattern may include:
The list of TDRA patterns can support a different number of PSSCHs scheduled by a DCI.
The list of TDRA patterns can support multiple PSSCHs with different starting symbols, different lengths, or both.
The list of TDRA patterns can support multiple starting positions of the first scheduled PSSCH.
The list of TDRA patterns can support multiple ending positions of the last scheduled PSSCH.
The list of TDRA patterns can support multiple PSSCHs scheduled in the same slot.
The list of TDRA patterns can support multiple contiguous or non-contiguous PSSCHs in multiple slots or the same slot.
The list of TDRA patterns can support multiple PSSCHs in different slots.
The list of TDRA patterns can explicitly or implicitly indicate the number of scheduled PSSCHs.
The list of TDRA patterns can include a TDRA pattern for a single PSSCH and a TDRA pattern for multiple PSSCHs.

The list of TDRA patterns can be defined using the following pseudo-code:
PSSCH-TimeDomainResourceAllocationList::=SEQUENCE
(SIZE (1 . . . maxNrofSideLink-Allocations)) OF PSSCH-TimeDomainResourceAllocation

The examples of a TDRA pattern are described in detail in the following text.

For example, in some embodiments, a DCI may schedule a single PSSCH and indicate a TDRA pattern which indicates a SLIV for the single PSSCH. For example, the TDRA pattern for single PSSCH scheduling may be defined as follows, where k3′ indicates the slot level offset from the slot where the DCI is received and the slot where the single PSSCH is scheduled:

```
PSSCH-TimeDomainResourceAllocation::= SEQUENCE
{
  k3′ INTEGER(0..32),
  startSymbolAndLength INTEGER (0..127)
  }
```

In some examples, k3′ may not be included in the TDRA pattern and may be indicated by another method. For example, the DCI may include a field indicating the value of k3′.

In some embodiments, a DCI may schedule a plurality of PSSCHs and indicate a TDRA pattern which indicates time domain resources for the plurality of PSSCHs. Examples of a TDRA pattern for multiple PSSCH scheduling will be described in detail later. The meanings of some parameters used in these examples are explained below:
For a TDRA pattern supporting M PSSCHs scheduled by one DCI, the value of k3′_x indicates the slot level offset between the slot where the DCI is received and the slot where the x^{th} PSSCH is scheduled. The value of k3′ indicates the slot level offset from the slot where the DCI is received and the slot where the first scheduled PSSCH is scheduled.
The element of k3′ or k3′_x may not be necessarily in the following examples in some cases including, for example, when the slot level offset between the slot where the DCI is received and the slot where the x^{th} PSSCH is scheduled is indicated by the DCI (e.g., indicated by a dedicated field in the DCI or implicitly indicated) or only contiguous transmission is supported for the multiple scheduled PSSCHs.
The startSymbolAndLength_x indicates the starting symbol index and duration of the x^{th} scheduled PSSCH, which can be set to appropriate values so as to support contiguous PSSCHs. For example, the starting symbol of the x^{th} scheduled PSSCH can immediately follow the ending symbol of the (x−1)^{th} scheduled PSSCH so as to ensure time contiguous scheduling.
The startSymbolAndLength_x, which indicates the starting symbol index and duration of the x^{th} scheduled PSSCH, can be set to appropriate values so as to support non-contiguous PSSCHs. For example, the starting symbol of the x^{th} scheduled PSSCH does not necessarily follow the ending symbol of the (x−1)^{th} scheduled PSSCH so as to achieve non-contiguous time scheduling.

The following are some example TDRA patterns which can support M PSSCHs scheduled by a single DCI.

Example 1′ supports contiguous or non-contiguous PSSCHs in different slots and with different lengths:

```
PSSCH-TimeDomainResourceAllocation::= SEQUENCE
{
  k3′_1 INTEGER(0..32),
  startSymbolAndLength_1 INTEGER (0..127),
  k3′_2 INTEGER(0..32),
  startSymbolAndLength_2 INTEGER (0..127),
  ...
  k3′_M INTEGER(0..32),
  startSymbolAndLength_M INTEGER (0..127)
}
```

Example 1′ provides full scheduling flexibility which supports a different number of scheduled PSSCHs in different contiguous or non-contiguous slots, different starting symbols and different lengths. A slot may carry one or more PSSCHs. The value of M indicates the number of scheduled PSSCHs. That is, the number of the start symbol and lengths indicates the number of scheduled PSSCHs.

Example 2′ supports one starting slot (e.g., first scheduled slot) and different lengths:

```
PSSCH-TimeDomainResourceAllocation::= SEQUENCE
{
  k3′ INTEGER(0..32),
  startSymbolAndLength_1 INTEGER (0..127),
  startSymbolAndLength_2 INTEGER (0..127),
  ...
  startSymbolAndLength_M INTEGER (0..127)
    }
```

Example 2′ can support a different number of PSSCHs scheduled in the same slot or in contiguous slots, different starting symbols and different lengths. The single slot or the first scheduled slot of the contiguous slots may be indicated by k3′. The value of M indicates the number of scheduled PSSCHs. That is, the number of the start symbol and lengths indicates the number of scheduled PSSCHs.

Example 3′ supports contiguous PSSCHs with the same length:

```
PSSCH-TimeDomainResourceAllocation::= SEQUENCE
  {
    k3′ INTEGER(0..32),
    startSymbolAndLength_1 INTEGER (0..127),
    numberOfScheduledPSSCHs INTEGER (0..Maximum
  number of scheduled PSSCHs)
      }
```

In this example, “startSymbolAndLength_1” indicates the starting symbol and length of the first scheduled PSSCH and “numberOfScheduledPSSCHs” indicates the number of scheduled PSSCHs with the same length as the first scheduled PSSCH. The “Maximum number of scheduled PSSCHs” is the maximum number of PSSCHs scheduled by a single DCI, which can be configured by RRC signaling, predefined or preconfigured.

Example 3′ can support a different number of PSSCHs scheduled in the same slot or in contiguous slots, different starting symbols and the same length. The single slot or the first scheduled slot of the contiguous slots may be indicated by k3′.

Example 4′ supports contiguous PSSCHs with at most two different lengths:

```
PSSCH-TimeDomainResourceAllocation::= SEQUENCE
{
  k3′ INTEGER(0..32),
  startSymbolAndLength INTEGER (0..127),
  numberOfTotalSymbols INTEGER (0...14*Maximum
number of scheduled PSSCHs),
  numberOfScheduledPSSCHs INTEGER(0..Maximum
number of scheduled PSSCHs)
    }
```

In this example, “startSymbolAndLength” indicates the starting symbol and length of the first scheduled PSSCH and “numberOfTotalSymbols” indicates the total length of the scheduled PSSCHs except the first scheduled PSSCH, which has the same length. “numberOfScheduledPSSCHs” indicates the number of scheduled PSSCHs. The “Maximum number of scheduled PSSCHs” is the maximum number of PSSCHs scheduled by a single DCI, which can be configured by RRC signaling, predefined or preconfigured. The length of each of the scheduled PSSCHs except the first scheduled PSSCH can be determined by dividing the total length (indicated by “numberOfTotalSymbols”) by the number of scheduled PSSCHs minus 1.

Example 4′ can support a different number of PSSCHs scheduled in the same slot or in contiguous slots with different starting symbols and at most two different lengths. The single slot or the first scheduled slot of the contiguous slots may be indicated by k3′.

Example 5′ supports contiguous or non-contiguous PSSCHs and with the same length:

```
PSSCH-TimeDomainResourceAllocation::= SEQUENCE
{
  k3′ INTEGER(0..32),
  startSymbol_1 INTEGER(0..13),
  startSymbol_2 INTEGER(0..13),
  ...
  startSymbol_M INTEGER(0..13),
  length INTEGER(1...14)
}
```

In this example, “startSymbol_x” indicates the starting symbol of the x^{th} scheduled PSSCH and “length” indicates the length for each of the scheduled PSSCHs. The number of the startSymbol_x fields indicates the number of scheduled PSSCHs.

Example 5′ can support a different number of PSSCHs scheduled in the same slot or in contiguous slots and with different starting symbols and the same length. The single slot or the first scheduled slot of the contiguous slots may be indicated by k3′. The value of M indicates the number of scheduled PSSCHs, i.e., the number of start symbols indicates the number of scheduled PSSCHs.

Example 6′ supports contiguous PSSCHs with the same or different lengths:

```
PSSCH-TimeDomainResourceAllocation::= SEQUENCE
{
  k3′ INTEGER(0..32),
  startSymbol_1 INTEGER(0..13),
  startSymbol_2 INTEGER(0..13),
  ...
  startSymbol_M INTEGER(0..13),
  length_M INTEGER(1...14)
}
```

In this example, “startSymbol_x” indicates the starting symbol of the x^{th} scheduled PSSCH. The offset between the startSymbol_x and the startSymbol_(x+1) determines the length of the x^{th} scheduled PSSCH. “length_M” indicates the length for the last scheduled PSSCHs, i.e., the M^{th} PSSCH. Alternatively, the pattern may not include “length_M”, which suggests that the last scheduled PSSCH, i.e., the M^{th} PSSCH, does not cross the slot boundary.

Example 6′ can support a different number of contiguous PSSCHs scheduled in the same slot and with different starting symbols and the same or different lengths. The single slot may be indicated by k3′. The value of M indicates the number of scheduled PSSCHs, i.e., the number of start symbols indicates the number of scheduled PSSCHs.

Example 7′ supports contiguous or non-contiguous PSSCHs with the same length:

```
PSSCH-TimeDomainResourceAllocation::= SEQUENCE
{
  k3′_1 INTEGER(0..32),
  k3′_2 INTEGER(0..32),
  ...
  k3′_M INTEGER(0..32),
  startSymbolAndLength INTEGER (0..127)
}
```

In this example, “k3′_x” indicates the slot level offset for the x^{th} scheduled PSSCH and “startSymbolAndLength” indicates the starting symbol and length for each of the scheduled PSSCHs. The value of M indicates the number of scheduled PSSCHs, i.e., the number of slot level offsets indicates the number of scheduled PSSCHs.

Example 7′ can support a different number of PSSCHs scheduled in contiguous or non-contiguous slots and with the same starting symbol and the same length. Alternatively, “startSymbolAndLength” can indicate the starting symbol for the first scheduled PSSCH and length for the last scheduled PSSCH. In this scenario, the scheduled PSSCHs are contiguous in the time domain and can have the same or different starting symbols and the same or different lengths.

Example 8′ supports contiguous PSSCHs with the same or different lengths:

```
PSSCH-TimeDomainResourceAllocation::= SEQUENCE
{
  k3′ INTEGER(0..32),
  startSymbolAndLength INTEGER (0..127),
  numberOfScheduledPSSCHs INTEGER(0..Maximum
number of scheduled PSSCHs)
}
```

In this example, k3′ indicates the slot level offset from the slot where the DCI is received and the slot where the first scheduled PSSCH is scheduled. The “startSymbolAndLength” indicates both the starting symbol of the first scheduled PSSCH and the ending symbol of the last scheduled PSSCH (e.g., s_symbol #1′ and e_symbol #1′). The “numberOfScheduledPSSCHs” indicates the number of scheduled PSSCHs. The “Maximum number of scheduled PSSCHs” is the maximum number of PSSCHs scheduled by a single DCI, which can be configured by RRC signaling, predefined, or preconfigured.

Example 9′ supports contiguous PSSCHs with the same or different lengths:

```
PSSCH-TimeDomainResourceAllocation::= SEQUENCE
{
  k3′ INTEGER(0..32),
  startSymbolAndLength INTEGER (0..127),
  numberOfScheduledPSSCHs INTEGER(0..Maximum
number of scheduled PSSCHs)
}
```

In this example, k3′ indicates the slot level offset from the slot where the DCI is received and the slot where the first scheduled PSSCH is scheduled. The “startSymbolAndLength” indicates both the starting symbol of the first scheduled PSSCH and the number of symbols of the last scheduled PSSCH (e.g., s_symbol #1′ and N_{symbol #}1′). The “numberOfScheduledPSSCHs” indicates the number of scheduled PSSCHs. The “Maximum number of scheduled PSSCHs” is the maximum number of PSSCHs scheduled by a single DCI, which can be configured by RRC signaling, predefined or preconfigured.

Example 10′ supports contiguous PSSCHs with the same or different lengths:

```
PSSCH-TimeDomainResourceAllocation::= SEQUENCE
{
  k3′ INTEGER(0..32),
  ending symbol index of last PSSCH INTEGER (0..13),
  numberOfScheduledPSSCHs INTEGER(0..Maximum
number of scheduled PSSCHs)
}
```

In this example, k3′ indicates the slot level offset from the slot where the DCI is received and the slot where the first scheduled PSSCH is scheduled. The “symbol index of last PSSCH” indicates the ending symbol of the last scheduled PSSCH (e.g., e_symbol #1′). The “numberOfScheduledPSSCHs” indicates the number of scheduled PSSCHs. The “Maximum number of scheduled PSSCHs” is the maximum number of PSSCHs scheduled by a single DCI, which can be configured by RRC signaling, predefined or preconfigured.

Example 11′ supports contiguous PSSCHs with the same or different lengths:

```
PSSCH-TimeDomainResourceAllocation::= SEQUENCE
{
  k3′ INTEGER(0..32),
  starting symbol index of first PSSCH INTEGER
(0...13),
  ending symbol index of last PSSCH INTEGER (0..13),
  numberOfScheduledPSSCHs INTEGER(0..Maximum
number of scheduled PSSCHs)
}
```

In this example, k3′ indicates the slot level offset from the slot where the DCI is received and the slot where the first scheduled PSSCH is scheduled. The “starting symbol index of first PSSCH” indicates the starting symbol of the first scheduled PSSCH (e.g., s_symbol #1′), and the “ending symbol index of last PSSCH” indicates the ending symbol of the last scheduled PSSCH (e.g., e_symbol #1′). The “numberOfScheduledPSSCHs” indicates the number of scheduled PSSCHs. The “Maximum number of scheduled PSSCHs” is the maximum number of PSSCHs scheduled by a single DCI, which can be configured by RRC signaling, predefined or preconfigured.

Example 12′ supports contiguous or non-contiguous PSSCHs in contiguous slots and with the same or different lengths:

```
PSSCH-TimeDomainResourceAllocation::= SEQUENCE
{
  k3′ INTEGER(0..32),
  startingSymbol_1 INTEGER (0...13),
  endingSymbol_1 INTEGER (0..13),
  startingSymbol_2 INTEGER (0...13),
  endingSymbol_2 INTEGER (0..13),
...
  startingSymbol_M INTEGER (0...13),
  endingSymbol_M INTEGER (0..13),
}
```

In this example, k3′ indicates the slot level offset from the slot where the DCI is received and the slot where the first scheduled PSSCH is scheduled. The “startingSymbol_x” indicates the starting symbol of the x^{th} scheduled PSSCH, and the “endingSymbol_x” indicates the ending symbol of the x^{th} scheduled PSSCH. The value of M indicates the number of scheduled PSSCHs, i.e., the number of starting symbol indices or ending symbol indices indicates the number of scheduled PSSCHs.

It should be noted that the above examples are only for illustrative purpose. Persons skilled in the art can easily conceive various TDRA patterns based on the disclosure of the present disclosure including, for example, the design principle for a TDRA pattern.

In some embodiments of the present disclosure, an IE of PSSCH-TimeDomainResourceAllocationList can include one or multiple PSSCH-TimeDomainResourceAllocations. Assuming that a maximum of 16 PSSCH-TimeDomainResourceAllocations can be included in the list of PSSCH-TimeDomainResourceAllocations, then indicator #2 in an SCI can be defined in below table as one example:

TABLE 2
Mapping table for TDRA indication

| Code point | |
|---|---|
| value | Indicated TDRA pattern of the list |
| 0 | The first PSSCH-TimeDomainResourceAllocation |
| 1 | The second PSSCH-TimeDomainResourceAllocation |
| 2 | The third PSSCH-TimeDomainResourceAllocation |
| 3 | The fourth PSSCH-TimeDomainResourceAllocation |
| 4 | The fifth PSSCH-TimeDomainResourceAllocation |
| 5 | The sixth PSSCH-TimeDomainResourceAllocation |
| 6 | The seventh PSSCH-TimeDomainResourceAllocation |
| 7 | The eighth PSSCH-TimeDomainResourceAllocation |
| 8 | The ninth PSSCH-TimeDomainResourceAllocation |
| 9 | The tenth PSSCH-TimeDomainResourceAllocation |
| 10 | The eleventh PSSCH-TimeDomainResourceAllocation |
| 11 | The twelfth PSSCH-TimeDomainResourceAllocation |
| 12 | The thirteenth PSSCH-TimeDomainResourceAllocation |
| 13 | The fourteenth PSSCH-TimeDomainResourceAllocation |
| 14 | The fifteenth PSSCH-TimeDomainResourceAllocation |
| 15 | The sixteenth PSSCH-TimeDomainResourceAllocation |

It should be understood that Table 2 is only for illustrative purposes, and should not be construed as limiting the embodiments of the present disclosure. By predefined PSSCH-TimeDomainResourceAllocation in the list, a BS can dynamically and flexibly indicate the number of scheduled PSSCHs, and the time domain resource allocation for each scheduled PSSCH by means of pointing the field of the time domain resource assignment (e.g., indicator #2) to the corresponding code point.

FIG. 6 illustrates a flow chart of exemplary procedure 600 for wireless communications in accordance with some embodiments of the present disclosure. Details described in all of the foregoing embodiments of the present disclosure are applicable for the embodiments shown in FIG. 6. In some examples, the procedure may be performed by a UE, for example, UE 110 in FIG. 1.

Referring to FIG. 6, in operation 611, a first UE may transmit an SCI for scheduling at least one PSSCH on at least one slot, wherein the SCI may include a first indicator indicating at least one time domain resource for the at least one PSSCH in the at least one slot, and each of the at least one time domain resource may correspond to one of the at least one PSSCH. In operation 613, the first UE may transmit the at least one PSSCH on the at least one time domain resource.

In some embodiments of the present disclosure, the first indicator may include: a first field indicating a first starting symbol of a first scheduled PSSCH of the at least one PSSCH and a first ending symbol of a last scheduled PSSCH of the at least one PSSCH, or indicating a second starting symbol of a first scheduled slot of the at least one slot and a second ending symbol of a last scheduled slot of the at least one slot. The first indicator may further include a second field indicating a number of the at least one PSSCH, a number of the at least one slot, the number of the at least one PSSCH minus two, or the number of the at least one slot minus two.

In some embodiments of the present disclosure, the first field indicates a SLIV indicating a starting symbol index and a number of symbols. The starting symbol index corresponds to the first starting symbol or the second starting symbol, and the first ending symbol or the second ending symbol is determined based on the starting symbol index and the number of symbols.

In some embodiments of the present disclosure, the size of the second field is based on a maximum number of PSSCHs schedulable by the SCI or a maximum number of slots schedulable by the SCI.

In some embodiments of the present disclosure, the first indicator may include: a first field indicating a first starting symbol of a first scheduled PSSCH of the at least one PSSCH and a first number of symbols of a last scheduled PSSCH of the at least one PSSCH, or indicating a second starting symbol of a first scheduled slot of the at least one slot and a second number of symbols of a last scheduled slot of the at least one slot. The first indicator may further include a second field indicating a number of the at least one PSSCH, a number of the at least one slot, the number of the at least one PSSCH minus two, or the number of the at least one slot minus two.

In some embodiments of the present disclosure, the first field indicates a SLIV indicating a starting symbol index and a number of symbols. The starting symbol index corresponds to the first starting symbol or the second starting symbol, and the number of symbols corresponds to the first number of symbols or the second number of symbols.

In some embodiments of the present disclosure, the size of the second field is based on a maximum number of PSSCHs schedulable by the SCI or a maximum number of slots schedulable by the SCI.

In some embodiments of the present disclosure, the first indicator may include: a first field indicating a first ending symbol of a last scheduled PSSCH of the at least one PSSCH, a second ending symbol of a last scheduled slot of the at least one slot, a first number of symbols of the last scheduled PSSCH of the at least one PSSCH, or a second number of symbols of the last scheduled slot of the at least one slot. The first indicator may further include: a second field indicating a number of the at least one PSSCH, a number of the at least one slot, the number of the at least one PSSCH minus two, or the number of the at least one slot minus two. The starting symbol of a first scheduled PSSCH of the at least one PSSCH is based on a PSCCH carrying the SCI.

In some embodiments of the present disclosure, in the case that the PSCCH and the first scheduled PSSCH of the at least one PSSCH are purely TDMed, the starting symbol of the first scheduled PSSCH immediately follows the last symbol of the PSCCH. In some embodiments of the present disclosure, in the case that the PSCCH and the first scheduled PSSCH of the at least one PSSCH are FDMed and TDMed, the starting symbol of the first scheduled PSSCH is the same as that of the PSCCH.

In some embodiments of the present disclosure, the size of the second field is based on a maximum number of PSSCHs schedulable by the SCI or a maximum number of slots schedulable by the SCI.

In some embodiments of the present disclosure, the first indicator may include a first field indicating a total number of symbols for the at least one PSSCH. A starting symbol of a first scheduled PSSCH of the at least one PSSCH is based on a PSCCH carrying the SCI.

In some embodiments of the present disclosure, an ending symbol of a last scheduled PSSCH of the at least one PSSCH is based on the starting symbol of the first scheduled PSSCH and the indicated total number of symbols for the at least one PSSCH.

In some embodiments of the present disclosure, the size of the first field is based on a maximum number of slots schedulable by the SCI. In some embodiments of the present disclosure, the first field indicates a total number of symbols for the at least one PSSCH from a set of total number of symbols, and the size of the first field is based on a size of the set of total number of symbols.

In some embodiments of the present disclosure, in the case that the PSCCH and the first scheduled PSSCH of the at least one PSSCH are purely TDMed, the starting symbol of the first scheduled PSSCH immediately follows the last symbol of the PSCCH. In some embodiments of the present disclosure, in the case that the PSCCH and the first scheduled PSSCH of the at least one PSSCH are FDMed and TDMed, the starting symbol of the first scheduled PSSCH is the same as that of the PSCCH.

In some embodiments of the present disclosure, the first indicator may include: a first field indicating a first starting symbol of a first scheduled PSSCH of the at least one PSSCH or a second starting symbol of a first scheduled slot of the at least one slot; a second field indicating a number of the at least one PSSCH, a number of the at least one slot, the number of the at least one PSSCH minus two, or the number of the at least one slot minus two; and a third field indicating a first ending symbol of a last scheduled PSSCH of the at least one PSSCH, or a second ending symbol of a last scheduled slot of the at least one slot.

In some embodiments of the present disclosure, the size of the second field is based on a maximum number of PSSCHs schedulable by the SCI or a maximum number of slots schedulable by the SCI.

In some embodiments of the present disclosure, the first, second and third fields are jointly coded in the SCI.

In some embodiments of the present disclosure, the first indicator may include: a first field indicating a total number of symbols for the at least one PSSCH, or a total number of symbols for the at least one PSSCH excluding the number of symbols of a first scheduled PSSCH of the at least one PSSCH or a first scheduled slot of the at least one slot; and a second field indicating a first starting symbol of the first scheduled PSSCH of the at least one PSSCH or a second starting symbol of the first scheduled slot of the at least one slot.

In some embodiments of the present disclosure, an ending symbol of a last scheduled PSSCH of the at least one PSSCH is based on the starting symbol of the first scheduled PSSCH and the indicated total number of symbols for the at least one PSSCH.

In some embodiments of the present disclosure, the size of the first field is based on a maximum number of slots schedulable by the SCI. In some embodiments of the present disclosure, the first field indicates a total number of symbols for the at least one PSSCH from a set of total number of symbols, and the size of the first field is based on a size of the set of total number of symbols.

In some embodiments of the present disclosure, all symbols of the second slot to the last but one slot of the at least one slot are used for carrying the at least one PSSCH.

In some embodiments of the present disclosure, the SCI is a first-stage SCI carried on a PSCCH in a first scheduled slot of the at least one slot, and the starting symbol of the PSCCH is the same as that of the first scheduled slot, or the SCI is a second-stage SCI carried on a first scheduled PSSCH of the at least one PSSCH, each of the at least one PSSCH, or a subset of PSSCHs of the at least one PSSCH. In the case that the PSCCH and a first scheduled PSSCH of the at least one PSSCH are purely TDMed, the starting symbol of the first scheduled PSSCH immediately follows an ending symbol of the PSCCH. In the case that the PSCCH and the first scheduled PSSCH of the at least one PSSCH are FDMed and TDMed, the starting symbol of the first scheduled PSSCH is the same as that of the PSCCH.

In some embodiments of the present disclosure, the first indicator indicates a TDRA pattern for the at least one time domain resource, and a first scheduled PSSCH of the at least one PSSCH is scheduled in a slot where the SCI is transmitted.

In some embodiments of the present disclosure, the TDRA pattern indicates at least one of the following: a SLIV for a single PSSCH; a slot level offset between a slot where the SCI is transmitted and a slot where the first scheduled PSSCH is scheduled, respective slot level offset between the slot where the SCI is transmitted and a slot where each of the remaining PSSCH(s) of the at least one PSSCH is scheduled, respective SLIV for each of the at least one PSSCH, or any combination thereof (e.g., example 1); respective SLIV for each of the at least one PSSCH, wherein the at least one slot is a single slot or contiguous slots (e.g., example 2); a SLIV for the first scheduled PSSCH and a number of the at least one PSSCH, wherein each PSSCH of the at least one PSSCH has the same length and is contiguous in a time domain (e.g., example 3); a SLIV for the first scheduled PSSCH, a total length of the at least one PSSCH except the first scheduled PSSCH, and a number of the at least one PSSCH, wherein the at least one PSSCH is contiguous in a time domain and each PSSCH of the at least one PSSCH except the first scheduled PSSCH has the same length (e.g., example 4); respective starting symbol for each of the at least one PSSCH and a single length for each of the at least one PSSCH, wherein the at least one slot is a single slot or contiguous slots (e.g., example 5); respective starting symbol for each of the at least one PSSCH and a length for a last scheduled PSSCH of the at least one PSSCH, wherein the at least one PSSCH is contiguous in a time domain (e.g., example 6); respective starting symbol for each of the at least one PSSCH, wherein the at least one PSSCH is contiguous in a time domain and a last scheduled PSSCH of the at least one PSSCH does not cross a slot boundary (e.g., example 6); a slot level offset between a slot where the SCI is transmitted and a slot where the first scheduled PSSCH is scheduled, respective slot level offset between the slot where the SCI is transmitted and a slot where each of the remaining PSSCH(s) of the at least one PSSCH is scheduled, a single SLIV for each of the at least one PSSCH, or any combination thereof (e.g., example 7); a slot level offset between a slot where the SCI is transmitted and a slot where the first scheduled PSSCH is scheduled, respective slot level offset between the slot where the SCI is transmitted and a slot where each of the remaining PSSCH(s) of the at least one PSSCH is scheduled, a SLIV indicating a starting symbol index associated with a first scheduled PSSCH of the plurality of PSSCHs and a number of symbols associated with a last scheduled PSSCH of the plurality of PSSCHs, or any combination thereof, wherein the at least one PSSCH is contiguous in a time domain (e.g., example 7); a SLIV indicating a starting symbol index associated with the first scheduled PSSCH and a number of symbols associated with a last scheduled PSSCH of the at least one PSSCH and a number of the at least one PSSCH, wherein the at least one PSSCH is contiguous in a time domain (e.g., examples 8 and 9); an ending symbol of a last scheduled PSSCH of the at least one PSSCH and a number of the at least one PSSCH, wherein the at least one PSSCH is contiguous in a time domain and a starting symbol of the first scheduled PSSCH is based on a PSCCH carrying the SCI (e.g., example 10); a starting symbol of the first scheduled PSSCH, an ending symbol of a last scheduled PSSCH of the at least one PSSCH, and a number of the at least one PSSCH, wherein the at least one PSSCH is contiguous in a time domain (e.g., example 11); or respective starting symbol of each of the at least one PSSCH, respective ending symbol of each of the at least one PSSCH, wherein the at least one slot is contiguous in a time domain (e.g., example 12).

In some embodiments of the present disclosure, the TDRA pattern is from a list of TDRA patterns, which satisfies at least one of the following: the list of TDRA patterns supports different numbers of PSSCHs scheduled by an SCI; the list of TDRA patterns supports a plurality of scheduled PSSCHs with different starting symbols, different lengths, or both; the list of TDRA patterns supports a plurality of starting positions for a first scheduled PSSCH; the list of TDRA patterns supports a plurality of ending positions of a last scheduled PSSCH; the list of TDRA patterns supports a plurality of PSSCHs scheduled in the same slot; the list of TDRA patterns supports a plurality of contiguous or non-contiguous PSSCHs scheduled in a plurality of slots or the same slot; the list of TDRA patterns supports a plurality of PSSCHs scheduled in different slots; the list of TDRA patterns explicitly or implicitly indicate the number of scheduled PSSCHs; or the list of TDRA patterns indicates a TDRA pattern for a single scheduled PSSCH and a TDRA pattern for a plurality of scheduled PSSCHs.

In some embodiments of the present disclosure, one or more PSSCHs of the at least one PSSCH are transmitted in a single slot of the at least one slot.

In some embodiments of the present disclosure, the first UE may receive DCI for scheduling a plurality of PSSCHs on a plurality of slots. The DCI may include a second indicator (e.g., indicator #2) indicating a plurality of time domain resources in the plurality of slots, and each of the plurality of time domain resource corresponds to one of the plurality of PSSCHs. The plurality of PSSCHs may include the at least one PSSCH, the plurality of slots may include the at least one slot, and the first indicator is based on the second indicator.

In some embodiments of the present disclosure, the SCI schedules the plurality of PSSCHs and is transmitted in a first scheduled slot of the plurality of slots. In some embodiments of the present disclosure, the SCI schedules a single PSSCH of the plurality of PSSCHs and is transmitted in the same slot as the single PSSCH.

In some embodiments of the present disclosure, the second indicator may include: a first field indicating a first starting symbol of a first scheduled PSSCH of the plurality of PSSCHs and a first ending symbol of a last scheduled PSSCH of the plurality of PSSCHs, or indicating a second starting symbol of a first scheduled slot of the plurality of slots and a second ending symbol of a last scheduled slot of the plurality of slots, and a second field indicating a number of the plurality of PSSCHs, a number of the plurality of slots, the number of the plurality of PSSCHs minus two, or the number of the plurality of slots minus two.

In some embodiments of the present disclosure, the first field indicates a SLIV indicating a starting symbol index and a number of symbols. The starting symbol index corresponds to the first starting symbol or the second starting symbol, and the first ending symbol or the second ending symbol is determined based on the starting symbol index and the number of symbols.

In some embodiments of the present disclosure, the size of the second field is based on a maximum number of PSSCHs schedulable by the DCI or a maximum number of slots schedulable by the DCI.

In some embodiments of the present disclosure, the second indicator may include: a first field indicating a first starting symbol of a first scheduled PSSCH of the plurality of PSSCHs and a first number of symbols of a last scheduled PSSCH of the plurality of PSSCHs, or indicating a second starting symbol of a first scheduled slot of the plurality of slots and a second number of symbols of a last scheduled slot of the plurality of slots; and a second field indicating a number of the plurality of PSSCHs, a number of the plurality of slots, the number of the plurality of PSSCHs minus two, or the number of the plurality of slots minus two.

In some embodiments of the present disclosure, the first field indicates a SLIV indicating a starting symbol index and a number of symbols. The starting symbol index corresponds to the first starting symbol or the second starting symbol, and the number of symbols corresponds to the first number of symbols or the second number of symbols.

In some embodiments of the present disclosure, the size of the second field is based on a maximum number of PSSCHs schedulable by the DCI or a maximum number of slots schedulable by the DCI.

In some embodiments of the present disclosure, the second indicator may include: a first field indicating a first ending symbol of a last scheduled PSSCH of the plurality of PSSCHs, a second ending symbol of a last scheduled slot of the plurality of slots, a first number of symbols of the last scheduled PSSCH of the plurality of PSSCHs, or a second number of symbols of the last scheduled slot of the plurality of slots; and a second field indicating a number of the plurality of PSSCHs, a number of the plurality of slots, the number of the plurality of PSSCHs minus two, or the number of the plurality of slots minus two. The starting symbol of a first scheduled PSSCH of the plurality of PSSCHs is based on a PSCCH carrying the SCI.

In some embodiments of the present disclosure, in the case that the PSCCH and the first scheduled PSSCH of the plurality of PSSCHs are purely TDMed, the starting symbol of the first scheduled PSSCH immediately follows the last symbol of the PSCCH. In some embodiments of the present disclosure, wherein in the case that the PSCCH and the first scheduled PSSCH of the plurality of PSSCHs are FDMed and TDMed, the starting symbol of the first scheduled PSSCH is the same as that of the PSCCH.

In some embodiments of the present disclosure, the size of the second field is based on a maximum number of PSSCHs schedulable by the DCI or a maximum number of slots schedulable by the DCI.

In some embodiments of the present disclosure, the second indicator may include: a first field indicating a total number of symbols for the plurality of PSSCHs. A starting symbol of a first scheduled PSSCH of the plurality of PSSCHs is based on a PSCCH carrying the SCI.

In some embodiments of the present disclosure, in the case that the PSCCH and the first scheduled PSSCH of the plurality of PSSCHs are purely TDMed, the starting symbol of the first scheduled PSSCH immediately follows the last symbol of the PSCCH. In some embodiments of the present disclosure, wherein in the case that the PSCCH and the first scheduled PSSCH of the plurality of PSSCHs are FDMed and TDMed, the starting symbol of the first scheduled PSSCH is the same as that of the PSCCH.

In some embodiments of the present disclosure, an ending symbol of a last scheduled PSSCH of the plurality of PSSCHs is based on the starting symbol of the first scheduled PSSCH and the indicated total number of symbols for the plurality of PSSCHs.

In some embodiments of the present disclosure, the size of the first field is based on a maximum number of slots schedulable by the DCI. In some embodiments of the present disclosure, the first field indicates a total number of symbols for the plurality of PSSCHs from a set of total number of symbols, and the size of the first field is based on a size of the set of total number of symbols.

In some embodiments of the present disclosure, the second indicator may include: the second indicator may include: a first field indicating a first starting symbol of a first scheduled PSSCH of the plurality of PSSCHs or a second starting symbol of a first scheduled slot of the plurality of slot; a second field indicating a number of the plurality of PSSCHs, a number of the plurality of slots, the number of the plurality of PSSCHs minus two, or the number of the plurality of slots minus two; and a third field indicating a first ending symbol of a last scheduled PSSCH of the plurality of PSSCHs, or a second ending symbol of a last scheduled slot of the plurality of slots.

In some embodiments of the present disclosure, the size of the second field is based on a maximum number of PSSCHs schedulable by the DCI or a maximum number of slots schedulable by the DCI.

In some embodiments of the present disclosure, the first, second and third fields are jointly coded in the DCI.

In some embodiments of the present disclosure, the second indicator may include: a first field indicating a total number of symbols for the plurality of PSSCHs; and a second field indicating a first starting symbol of a first scheduled PSSCH of the plurality of PSSCHs or a second starting symbol of a first scheduled slot of the plurality of slots.

In some embodiments of the present disclosure, an ending symbol of a last scheduled PSSCH of the plurality of PSSCHs is based on the starting symbol of the first scheduled PSSCH and the indicated total number of symbols for the plurality of PSSCHs.

In some embodiments of the present disclosure, the size of the first field is based on a maximum number of slots schedulable by the DCI. In some embodiments of the present disclosure, the first field indicates a total number of symbols for the plurality of PSSCHs from a set of total number of symbols, and the size of the first field is based on a size of the set of total number of symbols.

In some embodiments of the present disclosure, all symbols of the second slot to the last but one slot of the plurality of slots are used for transmitting the plurality of PSSCHs.

In some embodiments of the present disclosure, the second indicator indicates a TDRA pattern for the plurality of time domain resources.

In some embodiments of the present disclosure, the TDRA pattern indicates at least one of the following: respective slot level offset between a slot where the DCI is received and a slot where each of the plurality of PSSCHs is scheduled, respective SLIV for each of the plurality of PSSCHs, or any combination thereof (e.g., example 1′); a slot level offset between a slot where the DCI is received and a slot where a first scheduled PSSCH of the plurality of PSSCHs is scheduled, respective SLIV for each of the plurality of PSSCHs, or any combination thereof, wherein the plurality of slots is contiguous slots (e.g., example 2′); a slot level offset between a slot where the DCI is received and a slot where a first scheduled PSSCH of the plurality of PSSCHs is scheduled, a SLIV for the first scheduled PSSCH, a number of the plurality of PSSCHs, or any combination thereof, wherein each PSSCH of the plurality of PSSCHs has the same length and is contiguous in a time domain (e.g., example 3′); a slot level offset between a slot where the DCI is received and a slot where a first scheduled PSSCH of the plurality of PSSCHs is scheduled, a SLIV for the first scheduled PSSCH, a total length of the plurality of PSSCHs except the first scheduled PSSCH, a number of the plurality of PSSCHs, or any combination thereof, wherein the plurality of PSSCHs is contiguous in a time domain and each PSSCH of the plurality of PSSCHs except the first scheduled PSSCH has the same length (e.g., example 4′); a slot level offset between a slot where the DCI is received and a slot where a first scheduled PSSCH of the plurality of PSSCHs is scheduled, respective starting symbol for each of the plurality of PSSCHs, a single length for each of the plurality of PSSCHs, or any combination thereof, wherein the plurality of slots is contiguous slots (e.g., example 5′); a slot level offset between a slot where the DCI is received and a slot where a first scheduled PSSCH of the plurality of PSSCHs is scheduled, respective starting symbol for each of the plurality of PSSCHs, a length for a last scheduled PSSCH of the plurality of PSSCHs, or any combination thereof, wherein the plurality of PSSCHs is contiguous in a time domain (e.g., example 6′); a slot level offset between a slot where the DCI is received and a slot where a first scheduled PSSCH of the plurality of PSSCHs is scheduled, respective starting symbol for each of the plurality of PSSCHs, or any combination thereof, wherein the plurality of PSSCHs is contiguous in a time domain and a last scheduled PSSCH of the plurality of PSSCHs does not cross a slot boundary (e.g., example 6′); respective slot level offset between a slot where the DCI is received and a slot where each of the plurality of PSSCHs is scheduled, a single SLIV for each of the plurality of PSSCHs, or any combination thereof (e.g., example 7′); respective slot level offset between a slot where the DCI is received and a slot where each of the plurality of PSSCHs is scheduled, a SLIV indicating a starting symbol index associated with a first scheduled PSSCH of the plurality of PSSCHs and a number of symbols associated with a last scheduled PSSCH of the plurality of PSSCHs, or any combination thereof, wherein the plurality of PSSCHs is contiguous in a time domain (e.g., example 7′); a slot level offset between a slot where the DCI is received and a slot where a first scheduled PSSCH of the plurality of PSSCHs is scheduled, a SLIV indicating a starting symbol index associated with the first scheduled PSSCH and a number of symbols associated with a last scheduled PSSCH of the plurality of PSSCHs, a number of the plurality of PSSCHs, or any combination thereof, wherein the plurality of PSSCHs is contiguous in a time domain (e.g., examples 8′ and 9′); a slot level offset between a slot where the DCI is received and a slot where a first scheduled PSSCH of the plurality of PSSCHs is scheduled, an ending symbol of a last scheduled PSSCH of the plurality of PSSCHs, a number of the plurality of PSSCHs, or any combination thereof, wherein the plurality of PSSCHs is contiguous in a time domain and a starting symbol of the first scheduled PSSCH is based on a PSCCH carrying the SCI (e.g., example 10′); a slot level offset between a slot where the DCI is received and a slot where a first scheduled PSSCH of the plurality of PSSCHs is scheduled, a starting symbol of the first scheduled PSSCH, an ending symbol of a last scheduled PSSCH of the plurality of PSSCHs, a number of the plurality of PSSCHs, or any combination thereof, wherein the plurality of PSSCHs is contiguous in a time domain (e.g., example 11′); or a slot level offset between a slot where the DCI is received and a slot where a first scheduled PSSCH of the plurality of PSSCHs is scheduled, respective starting symbol of each of the plurality of PSSCHs, respective ending symbol of each of the plurality of PSSCHs, or any combination thereof, wherein the plurality of slots is contiguous in a time domain (e.g., example 12′).

In some embodiments of the present disclosure, the TDRA pattern is from a list of TDRA patterns, which satisfies at least one of the following: the list of TDRA patterns supports different numbers of PSSCHs scheduled by a DCI; the list of TDRA patterns supports a plurality of scheduled PSSCHs with different starting symbols, different lengths, or both; the list of TDRA patterns supports a plurality of starting positions for a first scheduled PSSCH; the list of TDRA patterns supports a plurality of ending positions of a last scheduled PSSCH; the list of TDRA patterns supports a plurality of PSSCHs scheduled in the same slot; the list of TDRA patterns supports a plurality of contiguous or non-contiguous PSSCHs scheduled in a plurality of slots or the same slot; the list of TDRA patterns supports a plurality of PSSCHs scheduled in different slots; the list of TDRA patterns explicitly or implicitly indicate the number of scheduled PSSCHs; or the list of TDRA patterns indicates a TDRA pattern for a single scheduled PSSCH and a TDRA pattern for a plurality of scheduled PSSCHs.

In some embodiments of the present disclosure, one or more PSSCHs of the plurality of PSSCHs are transmitted in a single slot of the plurality of slots.

It should be appreciated by persons skilled in the art that the sequence of the operations in exemplary procedure 600 may be changed and some of the operations in exemplary procedure 600 may be eliminated or modified, without departing from the spirit and scope of the disclosure.

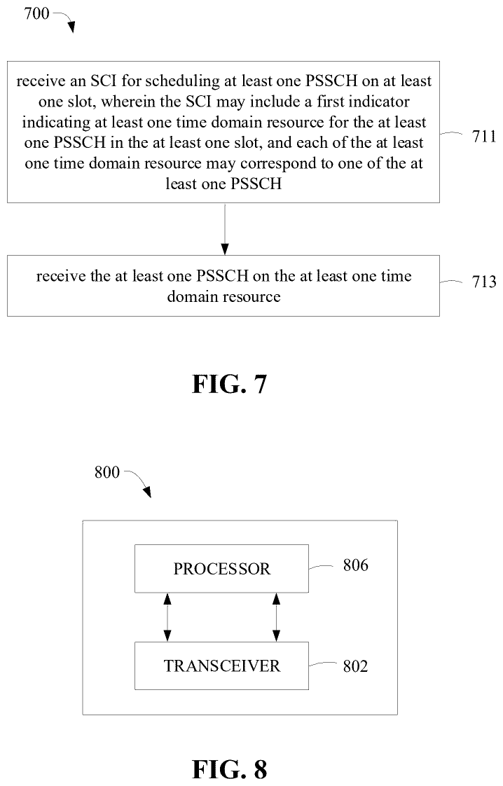

FIG. 7 illustrates a flow chart of exemplary procedure 700 for wireless communications in accordance with some embodiments of the present disclosure. Details described in all of the foregoing embodiments of the present disclosure are applicable for the embodiments shown in FIG. 7. In some examples, the procedure may be performed by a UE, for example, UE 110 in FIG. 1.

Referring to FIG. 7, in operation 711, a second UE may receive an SCI for scheduling at least one PSSCH on at least one slot, wherein the SCI may include a first indicator (e.g., indicator #1) indicating at least one time domain resource for the at least one PSSCH in the at least one slot, and each of the at least one time domain resource may correspond to one of the at least one PSSCH. In operation 713, the second UE may receive the at least one PSSCH on the at least one time domain resource.

In some embodiments of the present disclosure, the first indicator may include: a first field indicating a first starting symbol of a first scheduled PSSCH of the at least one PSSCH and a first ending symbol of a last scheduled PSSCH of the at least one PSSCH, or indicating a second starting symbol of a first scheduled slot of the at least one slot and a second ending symbol of a last scheduled slot of the at least one slot. The first indicator may further include a second field indicating a number of the at least one PSSCH, a number of the at least one slot, the number of the at least one PSSCH minus two, or the number of the at least one slot minus two.

In some embodiments of the present disclosure, the size of the second field is based on a maximum number of PSSCHs schedulable by the SCI or a maximum number of slots schedulable by the SCI.

In some embodiments of the present disclosure, the first field indicates a SLIV indicating a starting symbol index and a number of symbols. The starting symbol index corresponds to the first starting symbol or the second starting symbol, and the first ending symbol or the second ending symbol is determined based on the starting symbol index and the number of symbols.

In some embodiments of the present disclosure, the first indicator may include: a first field indicating a first starting symbol of a first scheduled PSSCH of the at least one PSSCH and a first number of symbols of a last scheduled PSSCH of the at least one PSSCH, or indicating a second starting symbol of a first scheduled slot of the at least one slot and a second number of symbols of a last scheduled slot of the at least one slot. The first indicator may further include a second field indicating a number of the at least one PSSCH, a number of the at least one slot, the number of the at least one PSSCH minus two, or the number of the at least one slot minus two.

In some embodiments of the present disclosure, the size of the second field is based on a maximum number of PSSCHs schedulable by the SCI or a maximum number of slots schedulable by the SCI.

In some embodiments of the present disclosure, the first field indicates a SLIV indicating a starting symbol index and a number of symbols. The starting symbol index corresponds to the first starting symbol or the second starting symbol, and the number of symbols corresponds to the first number of symbols or the second number of symbols.

In some embodiments of the present disclosure, the first indicator may include: a first field indicating a first ending symbol of a last scheduled PSSCH of the at least one PSSCH, a second ending symbol of a last scheduled slot of the at least one slot, a first number of symbols of the last scheduled PSSCH of the at least one PSSCH, or a second number of symbols of the last scheduled slot of the at least one slot; and a second field indicating a number of the at least one PSSCH, a number of the at least one slot, the number of the at least one PSSCH minus two, or the number of the at least one slot minus two. The starting symbol of a first scheduled PSSCH of the at least one PSSCH is based on a PSCCH carrying the SCI.

In some embodiments of the present disclosure, in the case that the PSCCH and the first scheduled PSSCH of the at least one PSSCH are purely TDMed, the starting symbol of the first scheduled PSSCH immediately follows the last symbol of the PSCCH. In some embodiments of the present disclosure, in the case that the PSCCH and the first scheduled PSSCH of the at least one PSSCH are FDMed and TDMed, the starting symbol of the first scheduled PSSCH is the same as that of the PSCCH.

In some embodiments of the present disclosure, the size of the second field is based on a maximum number of PSSCHs schedulable by the SCI or a maximum number of slots schedulable by the SCI.

In some embodiments of the present disclosure, the first indicator may include a first field indicating a total number of symbols for the at least one PSSCH. A starting symbol of a first scheduled PSSCH of the at least one PSSCH is based on a PSCCH carrying the SCI.

In some embodiments of the present disclosure, in the case that the PSCCH and the first scheduled PSSCH of the at least one PSSCH are purely TDMed, the starting symbol of the first scheduled PSSCH immediately follows the last symbol of the PSCCH. In some embodiments of the present disclosure, in the case that the PSCCH and the first scheduled PSSCH of the at least one PSSCH are FDMed and TDMed, the starting symbol of the first scheduled PSSCH is the same as that of the PSCCH.

In some embodiments of the present disclosure, an ending symbol of a last scheduled PSSCH of the at least one PSSCH is based on the starting symbol of the first scheduled PSSCH and the indicated total number of symbols for the at least one PSSCH.

In some embodiments of the present disclosure, the size of the first field is based on a maximum number of slots schedulable by the SCI. In some embodiments of the present disclosure, the first field indicates a total number of symbols for the at least one PSSCH from a set of total number of symbols, and the size of the first field is based on a size of the set of total number of symbols.

In some embodiments of the present disclosure, the first indicator may include: a first field indicating a first starting symbol of a first scheduled PSSCH of the at least one PSSCH or a second starting symbol of a first scheduled slot of the at least one slot; a second field indicating a number of the at least one PSSCH, a number of the at least one slot, the number of the at least one PSSCH minus two, or the number of the at least one slot minus two; and a third field indicating a first ending symbol of a last scheduled PSSCH of the at least one PSSCH, or a second ending symbol of a last scheduled slot of the at least one slot.

In some embodiments of the present disclosure, the first, second and third fields are jointly coded in the SCI.

In some embodiments of the present disclosure, the size of the second field is based on a maximum number of PSSCHs schedulable by the SCI or a maximum number of slots schedulable by the SCI.

In some embodiments of the present disclosure, the first indicator may include: a first field indicating a total number of symbols for the at least one PSSCH, or a total number of symbols for the plurality of PSSCHs excluding the number of symbols of a first scheduled PSSCH of the plurality of PSSCHs or a first scheduled slot of the plurality of slots; and a second field indicating a first starting symbol of the first scheduled PSSCH of the at least one PSSCH or a second starting symbol of the first scheduled slot of the at least one slot.

In some embodiments of the present disclosure, an ending symbol of a last scheduled PSSCH of the at least one PSSCH is based on the starting symbol of the first scheduled PSSCH and the indicated total number of symbols for the at least one PSSCH.

In some embodiments of the present disclosure, the size of the first field is based on a maximum number of slots schedulable by the SCI. In some embodiments of the present disclosure, the first field indicates a total number of symbols for the at least one PSSCH from a set of total number of symbols, and the size of the first field is based on a size of the set of total number of symbols.

In some embodiments of the present disclosure, all symbols of the second slot to the last but one slot of the at least one slot are used for carrying the at least one PSSCH.

In some embodiments of the present disclosure, the SCI is a first-stage SCI carried on a PSCCH in a first scheduled slot of the at least one slot, and the starting symbol of the PSCCH is the same as that of the first scheduled slot, or the SCI is a second-stage SCI carried on a first scheduled PSSCH of the at least one PSSCH, each of the at least one PSSCH, or a subset of PSSCHs of the at least one PSSCH. In the case that the PSCCH and a first scheduled PSSCH of the at least one PSSCH are purely TDMed, the starting symbol of the first scheduled PSSCH immediately follows an ending symbol of the PSCCH. In the case that the PSCCH and the first scheduled PSSCH of the at least one PSSCH are FDMed and TDMed, the starting symbol of the first scheduled PSSCH is the same as that of the PSCCH.

In some embodiments of the present disclosure, the first indicator indicates a TDRA pattern for the at least one time domain resource, and a first scheduled PSSCH of the at least one PSSCH is scheduled in a slot where the SCI is received.

In some embodiments of the present disclosure, the TDRA pattern indicates at least one of the following: a SLIV for a single PSSCH; a slot level offset between a slot where the SCI is received and a slot where the first scheduled PSSCH is scheduled, respective slot level offset between the slot where the SCI is received and a slot where each of the remaining PSSCH(s) of the at least one PSSCH is scheduled, respective SLIV for each of the at least one PSSCH, or any combination thereof (e.g., example 1); respective SLIV for each of the at least one PSSCH, wherein the at least one slot is a single slot or contiguous slots (e.g., example 2); a SLIV for the first scheduled PSSCH and a number of the at least one PSSCH, wherein each PSSCH of the at least one PSSCH has the same length and is contiguous in a time domain (e.g., example 3); a SLIV for the first scheduled PSSCH, a total length of the at least one PSSCH except the first scheduled PSSCH, and a number of the at least one PSSCH, wherein the at least one PSSCH is contiguous in a time domain and each PSSCH of the at least one PSSCH except the first scheduled PSSCH has the same length (e.g., example 4); respective starting symbol for each of the at least one PSSCH and a single length for each of the at least one PSSCH, wherein the at least one slot is a single slot or contiguous slots (e.g., example 5); respective starting symbol for each of the at least one PSSCH and a length for a last scheduled PSSCH of the at least one PSSCH, wherein the at least one PSSCH is contiguous in a time domain (e.g., example 6); respective starting symbol for each of the at least one PSSCH, wherein the at least one PSSCH is contiguous in a time domain and a last scheduled PSSCH of the at least one PSSCH does not cross a slot boundary (e.g., example 6); a slot level offset between a slot where the SCI is received and a slot where the first scheduled PSSCH is scheduled, respective slot level offset between the slot where the SCI is received and a slot where each of the remaining PSSCH(s) of the at least one PSSCH is scheduled, a single SLIV for each of the at least one PSSCH, or any combination thereof (e.g., example 7); a slot level offset between a slot where the SCI is received and a slot where the first scheduled PSSCH is scheduled, respective slot level offset between the slot where the SCI is received and a slot where each of the remaining PSSCH(s) of the at least one PSSCH is scheduled, a SLIV indicating a starting symbol index associated with a first scheduled PSSCH of the plurality of PSSCHs and a number of symbols associated with a last scheduled PSSCH of the plurality of PSSCHs, or any combination thereof, wherein the at least one PSSCH is contiguous in a time domain (e.g., example 7); a SLIV indicating a starting symbol index associated with the first scheduled PSSCH and a number of symbols associated with a last scheduled PSSCH of the at least one PSSCH and a number of the at least one PSSCH, wherein the at least one PSSCH is contiguous in a time domain (e.g., examples 8 and 9); an ending symbol of a last scheduled PSSCH of the at least one PSSCH and a number of the at least one PSSCH, wherein the at least one PSSCH is contiguous in a time domain and a starting symbol of the first scheduled PSSCH is based on a PSCCH carrying the SCI (e.g., example 10); a starting symbol of the first scheduled PSSCH, an ending symbol of a last scheduled PSSCH of the at least one PSSCH, and a number of the at least one PSSCH, wherein the at least one PSSCH is contiguous in a time domain (e.g., example 11); or respective starting symbol of each of the at least one PSSCH, respective ending symbol of each of the at least one PSSCH, wherein the at least one slot is contiguous in a time domain (e.g., example 12).

In some embodiments of the present disclosure, the TDRA pattern is from a list of TDRA patterns, which satisfies at least one of the following: the list of TDRA patterns supports different numbers of PSSCHs scheduled by an SCI; the list of TDRA patterns supports a plurality of scheduled PSSCHs with different starting symbols, different lengths, or both; the list of TDRA patterns supports a plurality of starting positions for a first scheduled PSSCH; the list of TDRA patterns supports a plurality of ending positions of a last scheduled PSSCH; the list of TDRA patterns supports a plurality of PSSCHs scheduled in the same slot; the list of TDRA patterns supports a plurality of contiguous or non-contiguous PSSCHs scheduled in a plurality of slots or the same slot; the list of TDRA patterns supports a plurality of PSSCHs scheduled in different slots; the list of TDRA patterns explicitly or implicitly indicate the number of scheduled PSSCHs; or the list of TDRA patterns indicates a TDRA pattern for a single scheduled PSSCH and a TDRA pattern for a plurality of scheduled PSSCHs.

In some embodiments of the present disclosure, one or more PSSCHs of the at least one PSSCH are received in a single slot of the at least one slot.

It should be appreciated by persons skilled in the art that the sequence of the operations in exemplary procedure 700 may be changed and some of the operations in exemplary procedure 700 may be eliminated or modified, without departing from the spirit and scope of the disclosure.

FIG. 8 illustrates a block diagram of an exemplary apparatus 800 according to some embodiments of the present disclosure. As shown in FIG. 8, the apparatus 800 may include at least one processor 808 and at least one transceiver 802 coupled to the processor 808. The apparatus 800 may be a UE.

Although in this figure, elements such as the at least one transceiver 802 and processor 808 are described in the singular, the plural is contemplated unless a limitation to the singular is explicitly stated. In some embodiments of the present application, the transceiver 802 may be divided into two devices, such as a receiving circuitry and a transmitting circuitry. In some embodiments of the present application, the apparatus 800 may further include an input device, a memory, and/or other components.

In some embodiments of the present application, the apparatus 800 may be a UE. The transceiver 802 and the processor 808 may interact with each other so as to perform the operations with respect to the UE described in FIGS. 1-7.

In some embodiments of the present application, the apparatus 800 may further include at least one non-transitory computer-readable medium. For example, in some embodiments of the present disclosure, the non-transitory computer-readable medium may have stored thereon computer-executable instructions to cause the processor 808 to implement the method with respect to the UE as described above. For example, the computer-executable instructions, when executed, cause the processor 808 interacting with transceiver 802 to perform the operations with respect to the UE described in FIGS. 1-7.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A first user equipment (UE) for wireless communication, comprising:
at least one memory; and
at least one processor coupled with the at least one memory and configured to cause the UE to:
transmit sidelink control information (SCI) for scheduling at least one physical sidelink shared channel (PSSCH) on at least one slot, wherein the SCI comprises a first indicator indicating at least one time domain resource for the at least one PSSCH in the at least one slot, and wherein each time domain resource of the at least one time domain resource corresponds to one PSSCH of the at least one PSSCH; and
transmit the at least one PSSCH on the at least one time domain resource.

2. The first UE of claim 1, wherein the first indicator comprises:
a first field indicating a first starting symbol of a first scheduled PSSCH of the at least one PSSCH and a first ending symbol of a last scheduled PSSCH of the at least one PSSCH, or indicating a second starting symbol of a first scheduled slot of the at least one slot and a second ending symbol of a last scheduled slot of the at least one slot, and
a second field indicating a number of the at least one PSSCH, a number of the at least one slot, the number of the at least one PSSCH minus two, or the number of the at least one slot minus two.

3. The first UE of claim 2, wherein the first field indicates a start and length indication value (SLIV) indicating a starting symbol index and a number of symbols; and
wherein the starting symbol index corresponds to the first starting symbol or the second starting symbol, and the first ending symbol or the second ending symbol is determined based on the starting symbol index and the number of symbols.

4. The first UE of claim 1, wherein the first indicator comprises:
a first field indicating a first starting symbol of a first scheduled PSSCH of the at least one PSSCH and a first number of symbols of a last scheduled PSSCH of the at least one PSSCH, or indicating a second starting symbol of a first scheduled slot of the at least one slot and a second number of symbols of a last scheduled slot of the at least one slot, and
a second field indicating a number of the at least one PSSCH, a number of the at least one slot, the number of the at least one PSSCH minus two, or the number of the at least one slot minus two.

5. The first UE of claim 4, wherein the first field indicates a start and length indication value (SLIV) indicating a starting symbol index and a number of symbols; and
wherein the starting symbol index corresponds to the first starting symbol or the second starting symbol, and the number of symbols corresponds to the first number of symbols or the second number of symbols.

6. The first UE of claim 1, wherein the first indicator comprises:
a first field indicating a first ending symbol of a last scheduled PSSCH of the at least one PSSCH, a second ending symbol of a last scheduled slot of the at least one slot, a first number of symbols of the last scheduled PSSCH of the at least one PSSCH, or a second number of symbols of the last scheduled slot of the at least one slot, and
a second field indicating a number of the at least one PSSCH, a number of the at least one slot, the number of the at least one PSSCH minus two, or the number of the at least one slot minus two; and
wherein the starting symbol of a first scheduled PSSCH of the at least one PSSCH is based on a physical sidelink control channel (PSCCH) carrying the SCI.

7. The first UE of claim 1, wherein the first indicator comprises a first field indicating a total number of symbols for the at least one PSSCH; and
wherein a starting symbol of a first scheduled PSSCH of the at least one PSSCH is based on a physical sidelink control channel (PSCCH) carrying the SCI.

8. The first UE of claim 1, wherein the first indicator comprises:
a first field indicating a first starting symbol of a first scheduled PSSCH of the at least one PSSCH or a second starting symbol of a first scheduled slot of the at least one slot,
a second field indicating a number of the at least one PSSCH, a number of the at least one slot, the number of the at least one PSSCH minus two, or the number of the at least one slot minus two, and
a third field indicating a first ending symbol of a last scheduled PSSCH of the at least one PSSCH, or a second ending symbol of a last scheduled slot of the at least one slot.

9. The first UE of claim 1, wherein the first indicator comprises:
a first field indicating a total number of symbols for the at least one PSSCH, or a total number of symbols for the at least one PSSCH excluding the number of symbols of a first scheduled PSSCH of the at least one PSSCH or a first scheduled slot of the at least one slot, and
a second field indicating a first starting symbol of the first scheduled PSSCH of the at least one PSSCH or a second starting symbol of the first scheduled slot of the at least one slot.

10. The first UE of claim 1, wherein the SCI is a first-stage SCI carried on a physical sidelink control channel (PSCCH) in a first scheduled slot of the at least one slot, and the starting symbol of the PSCCH is the same as that of the first scheduled slot, or the SCI is a second-stage SCI carried on a first scheduled PSSCH of the at least one PSSCH, each of the at least one PSSCH, or a subset of PSSCHs of the at least one PSSCH; and
wherein, when the PSCCH and a first scheduled PSSCH of the at least one PSSCH are purely time division multiplexed (TDMed), the starting symbol of the first scheduled PSSCH immediately follows an ending symbol of the PSCCH, or
wherein, when the PSCCH and the first scheduled PSSCH of the at least one PSSCH are frequency division multiplexed (FDMed) and TDMed, the starting symbol of the first scheduled PSSCH is the same as that of the PSCCH.

11. The first UE of claim 1, wherein the first indicator indicates a time domain resource allocation (TDRA) pattern for the at least one time domain resource, and a first scheduled PSSCH of the at least one PSSCH is scheduled in a slot where the SCI is transmitted.

12. The first UE of claim 11, wherein the TDRA pattern indicates at least one of the following:
a start and length indication value (SLIV) for a single PSSCH;
a slot level offset between a slot where the SCI is transmitted and a slot where the first scheduled PSSCH is scheduled, respective slot level offset between the slot where the SCI is transmitted and a slot where each of the remaining PSSCHs of the at least one PSSCH is scheduled, respective SLIV for each of the at least one PSSCH, or any combination thereof;
respective SLIV for each of the at least one PSSCH, wherein the at least one slot is a single slot or contiguous slots;
a SLIV for the first scheduled PSSCH and a number of the at least one PSSCH, wherein each PSSCH of the at least one PSSCH has the same length and is contiguous in a time domain;
a SLIV for the first scheduled PSSCH, a total length of the at least one PSSCH except the first scheduled PSSCH, and a number of the at least one PSSCH, wherein the at least one PSSCH is contiguous in a time domain and each PSSCH of the at least one PSSCH except the first scheduled PSSCH has the same length;
respective starting symbol for each of the at least one PSSCH and a single length for each of the at least one PSSCH, wherein the at least one slot is a single slot or contiguous slots;
respective starting symbol for each of the at least one PSSCH and a length for a last scheduled PSSCH of the at least one PSSCH, wherein the at least one PSSCH is contiguous in a time domain;
respective starting symbol for each of the at least one PSSCH, wherein the at least one PSSCH is contiguous in a time domain and a last scheduled PSSCH of the at least one PSSCH does not cross a slot boundary;
a slot level offset between a slot where the SCI is transmitted and a slot where the first scheduled PSSCH is scheduled, respective slot level offset between the slot where the SCI is transmitted and a slot where each of the remaining PSSCHs of the at least one PSSCH is scheduled, a single SLIV for each of the at least one PSSCH, or any combination thereof;
a slot level offset between a slot where the SCI is transmitted and a slot where the first scheduled PSSCH is scheduled, respective slot level offset between the slot where the SCI is transmitted and a slot where each of the remaining PSSCHs of the at least one PSSCH is scheduled, a SLIV indicating a starting symbol index associated with a first scheduled PSSCH of the plurality of PSSCHs and a number of symbols associated with a last scheduled PSSCH of the plurality of PSSCHs, or any combination thereof, wherein the at least one PSSCH is contiguous in a time domain;
a SLIV indicating a starting symbol index associated with the first scheduled PSSCH and a number of symbols associated with a last scheduled PSSCH of the at least one PSSCH and a number of the at least one PSSCH, wherein the at least one PSSCH is contiguous in a time domain;
an ending symbol of a last scheduled PSSCH of the at least one PSSCH and a number of the at least one PSSCH, wherein the at least one PSSCH is contiguous in a time domain and a starting symbol of the first scheduled PSSCH is based on a physical sidelink control channel (PSCCH) carrying the SCI;
a starting symbol of the first scheduled PSSCH, an ending symbol of a last scheduled PSSCH of the at least one PSSCH, and a number of the at least one PSSCH, wherein the at least one PSSCH is contiguous in a time domain; or
a respective starting symbol of each of the at least one PSSCH, and a respective ending symbol of each of the at least one PSSCH, wherein the at least one slot is contiguous in a time domain.

13. The first UE of claim 1, wherein the at least one processor is further configured to cause the first UE to receive downlink control information (DCI) for scheduling a plurality of PSSCHs on a plurality of slots,
wherein the DCI comprises a second indicator indicating a plurality of time domain resources in the plurality of slots, and each of the plurality of time domain resource corresponds to one of the plurality of PSSCHs, and
wherein the plurality of PSSCHs comprises the at least one PSSCH, the plurality of slots comprises the at least one slot, and the first indicator is based on the second indicator.

14. A second user equipment (UE) for wireless communication, comprising:
at least one memory; and
at least one processor coupled with the at least one memory and configured to cause the second UE to:
receive sidelink control information (SCI) for scheduling at least one physical sidelink shared channel (PSSCH) on at least one slot, wherein the SCI comprises a first indicator indicating at least one time domain resource for the at least one PSSCH in the at least one slot, and each of the at least one time domain resource corresponds to one of the at least one PSSCH; and
receive the at least one PSSCH on the at least one time domain resource.

15. A method performed by a first user equipment (UE), the method comprising:
transmitting sidelink control information (SCI) for scheduling at least one physical sidelink shared channel (PSSCH) on at least one slot, wherein the SCI comprises a first indicator indicating at least one time domain resource for the at least one PSSCH in the at least one slot, and each of the at least one time domain resource corresponds to one of the at least one PSSCH; and
transmitting the at least one PSSCH on the at least one time domain resource.

16. A processor for wireless communication, comprising:
at least one controller coupled with at least one memory and configured to cause the processor to:
transmit sidelink control information (SCI) for scheduling at least one physical sidelink shared channel (PSSCH) on at least one slot, wherein the SCI comprises a first indicator indicating at least one time domain resource for the at least one PSSCH in the at least one slot, and wherein each time domain resource of the at least one time domain resource corresponds to one PSSCH of the at least one PSSCH; and
transmit the at least one PSSCH on the at least one time domain resource.

17. The processor of claim 16, wherein the first indicator comprises:
a first field indicating a first starting symbol of a first scheduled PSSCH of the at least one PSSCH and a first ending symbol of a last scheduled PSSCH of the at least one PSSCH, or indicating a second starting symbol of a first scheduled slot of the at least one slot and a second ending symbol of a last scheduled slot of the at least one slot, and
a second field indicating a number of the at least one PSSCH, a number of the at least one slot, the number of the at least one PSSCH minus two, or the number of the at least one slot minus two.

18. The processor of claim 16, wherein the first indicator comprises:
a first field indicating a first starting symbol of a first scheduled PSSCH of the at least one PSSCH and a first number of symbols of a last scheduled PSSCH of the at least one PSSCH, or indicating a second starting symbol of a first scheduled slot of the at least one slot and a second number of symbols of a last scheduled slot of the at least one slot, and
a second field indicating a number of the at least one PSSCH, a number of the at least one slot, the number of the at least one PSSCH minus two, or the number of the at least one slot minus two.

19. The processor of claim 16, wherein the first indicator comprises a first field indicating a total number of symbols for the at least one PSSCH; and
wherein a starting symbol of a first scheduled PSSCH of the at least one PSSCH is based on a physical sidelink control channel (PSCCH) carrying the SCI.

20. The processor of claim 16, wherein the at least one controller is further configured to cause the processor to receive downlink control information (DCI) for scheduling a plurality of PSSCHs on a plurality of slots,
wherein the DCI comprises a second indicator indicating a plurality of time domain resources in the plurality of slots, and each of the plurality of time domain resource corresponds to one of the plurality of PSSCHs, and
wherein the plurality of PSSCHs comprises the at least one PSSCH, the plurality of slots comprises the at least one slot, and the first indicator is based on the second indicator.
